(19) United States
(12) Patent Application Publication
(10) Pub. No.: US 2020/0204527 A1
(43) Pub. Date: Jun. 25, 2020

(54) SECURE TELECOMMUNICATIONS AND TRANSACTIONAL PLATFORM

(71) Applicant: MINE ZERO GmbH, Berlin (DE)

(72) Inventors: Attila VASS, San Francisco, CA (US); John HARRIS, San Francisco, CA (US); Rolf HERKEN, San Francisco, CA (US); Jochen KORNITZKY, San Francisco, CA (US)

(21) Appl. No.: 16/612,357

(22) PCT Filed: May 10, 2018
(86) PCT No.: PCT/US18/32149

§ 371 Date: Nov. 8, 2019

Related U.S. Application Data
(63) Continuation-in-part of application No. PCT/US16/22232, filed on Mar. 12, 2016.
Application No. PCT/US16/22232 is a continuation-in-part of application No. 15/557,229, filed on Sep. 11, 2017.
(60) Provisional application No. 62/504,211, filed on May 10, 2017.
(60) Provisional application No. 62/132,489, filed on Mar. 12, 2015.

(51) Int. Cl. H04L 29/06; G07F 9/00; G06F 21/60; G06Q 20/12; G06Q 20/02; G06Q 10/10; G06Q 20/40

(52) U.S. Cl. CPC H04L 63/0435; H04L 63/0823; G07F 9/006; G06F 21/602; H04L 2463/101; G06Q 20/027; G06Q 10/107; G06Q 20/401; G06Q 20/12

(57) ABSTRACT

The present invention provides, among other aspects, methods, systems, devices and software products (computer program products) for creating and maintaining a private, secure, digital telecommunications and transactional platform.

### REFERENCE TO RELATED APPLICATIONS AND INCORPORATION BY REFERENCE

This patent application claims the priority benefit of commonly owned U.S. Provisional Pat. App. 62/504,211 filed May 10, 2017, entitled “Secure Telecommunications and Transactional Platform” (Atty. Dkt. MNE-116-PR): and is a continuation-in-part (CIP) of commonly owned International Pat. App. PCT/US 16/22,232 filed Mar. 12, 2016, entitled “Transactional Platform” (Attorney Dkt. MNE-112-PCT) (and corresponding U.S. National Phase application Ser. No. 15/557,229 filed Sep. 11, 2017 (Attorney Dkt. MNE-112-US)), which claim the priority benefit of U.S. Provisional App. for Patent Ser. No. 62/132,489 filed Mar. 12, 2015 (Attorney Dkt. MNE-112-PR); each of which is incorporated by reference herein as if set forth herein in its entirety.

Also incorporated by reference herein as if set forth herein in their entireties are: commonly owned International Pat. App. PCT/US 17/47,430 filed Aug. 17, 2017 (Attorney Dkt. MNE-114-PCT), which claims the priority benefit of U.S. Provisional App. for Patent Ser. No. 62/376,210 filed Aug. 17, 2016 (Attorney Dkt. MNE-114-PR), both entitled “Multi-Factor Protected Private Key Distribution”; and U.S. Provisional App. for Patent Ser. No. 62/516,593 filed Jun. 7, 2017, entitled “Improved Transactional Platform” (Attorney Dkt. MNE-117-PR)

### FIELD OF THE INVENTION

The present invention relates generally to methods, systems, devices and computer program code products (software) for creating and maintaining a secure telecommunications and transactional platform and network.

### BACKGROUND OF THE INVENTION

There exists a need for platforms and networks for facilitating secure, private telecommunications and transactions, including the offering, providing, selling and purchasing of services, content and time. The present invention, referred to herein as “ZeitPlatform” or “Z-Platform” (ZP), provides, among other aspects, methods, systems, devices and computer program code products (software) for creating, maintaining and operating a secure, private platform and network for telecommunications and for offering, providing, selling and purchasing services, content and time. In particular, aspects of the invention described herein provide secure and private telecommunications and transactional infrastructures that can be used with and for a wide range of applications, including distribution of data, live and pre-recorded audio/video/graphic communications, and online and offline text-based communications and services. Aspects, examples, embodiments and practices of the invention, whether in the form of methods, devices, systems or computer program code products (software) will be described in greater detail below, in conjunction with the attached drawing figures.

### SUMMARY OF THE INVENTION

The present invention provides methods, systems, devices, and computer software/program code products for establishing, configuring or operating a communications and transactional platform for providing, enabling or supporting secure, private communications and transactions, which may include personal and business communications, whether voice, text, video or other types of communications, and c-commerce transactions.

Methods, systems, devices, and computer software/program code products in accordance with the invention are suitable for implementation or execution in, or in conjunction with, commercially available forms of computer network structures, including servers and other digital processing resources, and devices that communicate with, through or across such structures, such as commercially available forms of cellphones, smartphones, tablets and other commercially available telecomnumications and computing devices.

In the aspects of the invention described herein and shown in the accompanying drawings, the methods described are executable by digital processors, which can include processing units such as those in known forms of computer network systems, servers, and devices that communicate with such systems and servers, such as cellphones, smartphones, tablets and other commercially available forms of telecommunications and computing devices.

In one aspect, embodiment or practice of the invention, the communications platform of the invention comprises: (A) a server comprising a digital processing resource, the digital processing resource comprising a digital processor; and (B) a content transformation module, in communication with the server and interposed between the server and a digital content resource operable to store, deliver or forward digital content. In such an embodiment or practice of the invention, the content transformation module is operable to apply selected content transformations to digital content directed to the server from the digital content resource, and the content transformation module is controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

In an exemplary aspect of the invention, the content transformation module is operable to dynamically change encryption parameters for a given endpoint, responsive to the server-based information representative of endpoint status or endpoint-associated user status.

In another aspect of the invention, the content transformation module is operable to execute selected redirection of content or content requests, on a per-endpoint basis, responsive to the server-based information representative of endpoint status or endpoint-associated user status.

In yet another aspect of the invention, the content transformation module is operable to provide selected content transformation, encryption and delivery for applications executing on the server.

In another aspect of the invention, the content transformation module is operable to provide selected content transformation, encryption and delivery for Web-based services that execute on modules of the communications platform that are in communication with the World-Wide Web.

Another aspect of the invention further comprises a communications platform environment supported by the server and the content transformation module and organized into three levels, comprising a core services level, a platform modules level, and a platform applications level, wherein: the core services level comprises core services usable by platform modules or platform applications; the platform modules level comprises platform-based functional modules operable to utilize selected ones of the core services provided by the core services level; and the platform applications level comprises platform-based application programs operable to utilize selected ones of the platform core services or platform modules.

In one aspect of the invention, the platform is operable to enable a User of the platform to create and maintain a fictional identity (referred to herein as a “Persona”) for use on selected venues served by the platform, and wherein Persona information is stored independently from User information, so as to preclude unmasking of a User identity based on corresponding Persona information.

In another aspect of the invention, the platform is operable to enable a given User to create separate, different, respective Personas for use with different, respective venues served by the platform.

In yet another aspect of the invention, platform-based logical links between a given User identity and a corresponding Persona are established, maintained and protected by a platform-based Identity Translation Service.

Another aspect of the invention relates to a method of providing a communications platform for enabling secure, private communications and/or transactions, the method comprising: (A) configuring a server comprising a digital processing resource, the digital processing resource comprising a digital processor, and (B) configuring a content transformation module, in communication with the server, and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

Another aspect of the invention relates to a computer program code product (software) for use with a digital processing system, for enabling the digital processing system to provide a communications platform for enabling secure, private communications and/or transactions, the digital processing system comprising at least one digital processor, the program product comprising digital processor-executable program instructions stored on a non-transitory digital processor-readable medium, which when executed in the digital processor cause the digital processor to: (A) configure a server comprising a digital processor; and (B) configure a content transformation module, in communication with the server, and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

Another aspect of the invention relates to methods, devices, structures and computer program code products (software) for providing, configuring and operating a communications environment or platform for providing, enabling or supporting secure, private transactions, the communications environment or platform comprising: (A) a server comprising a digital processing resource, the digital processing resource comprising a digital processor; and (B) a content transformation module, in communication with the server and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

These and other aspects, examples, embodiments and practices of the invention, whether in the form of methods, devices, systems or computer software/program code products, will be discussed in greater detail below in the following Detailed Description of the Invention and in connection with the attached drawing figures.

Those skilled in the art will appreciate that while the following detailed description provides sufficient detail to enable one skilled in the art to practice the present invention, the various examples, embodiments and practices of the present invention that are discussed and described below, in conjunction with the attached drawing figures, are provided by way of example, and not by way of limitation. Numerous variations, additions, and other modifications or different implementations of the present invention are possible, and are within the spirit and scope of the invention.

### BRIEF DESCRIPTION OF THE DRAWINGS

FIGS. 1-36 are schematic diagrams depicting exemplary practices of the invention.

FIGS. 37A, 37B and 38 are flowcharts depicting exemplary practices of the invention.

FIG. 39 is a schematic diagram depicting an exemplary embodiment of the invention.

FIG. 40 is a schematic diagram depicting a form of digital cloud configuration in connection with which the invention may be practiced.

### DETAILED DESCRIPTION OF THE INVENTION

### Roadmap:

This Detailed Description of the Invention is organized into the following parts:

Part 1: Overview

Part 2: Technical Design

Part 3: Technical Implementation

Part 4: Block Diagram of Exemplary Embodiments of Invention

Part 5: Digital Processing Environment In Which Invention Can Be Implemented

Part 6: Flowcharts of Exemplary Practices of the Invention

Part 7: Conclusion

Various aspects, embodiments and practices of the present invention are referred to herein as “ZeitPlatform” or “Z-Platform” (ZP), and will be described in detail in the following sections. Reference is also made to commonly owned International Patent Application PCT/US 16/22,232 filed Mar. 12, 2016, entitled “Transactional Platform” (Attorney Docket MNE-112-PCT), which is, along with other commonly owned patent applications listed above, incorporated herein by reference as if set forth herein in its entirety.

### PART 1: OVERVIEW

### Z-Platform Architecture:

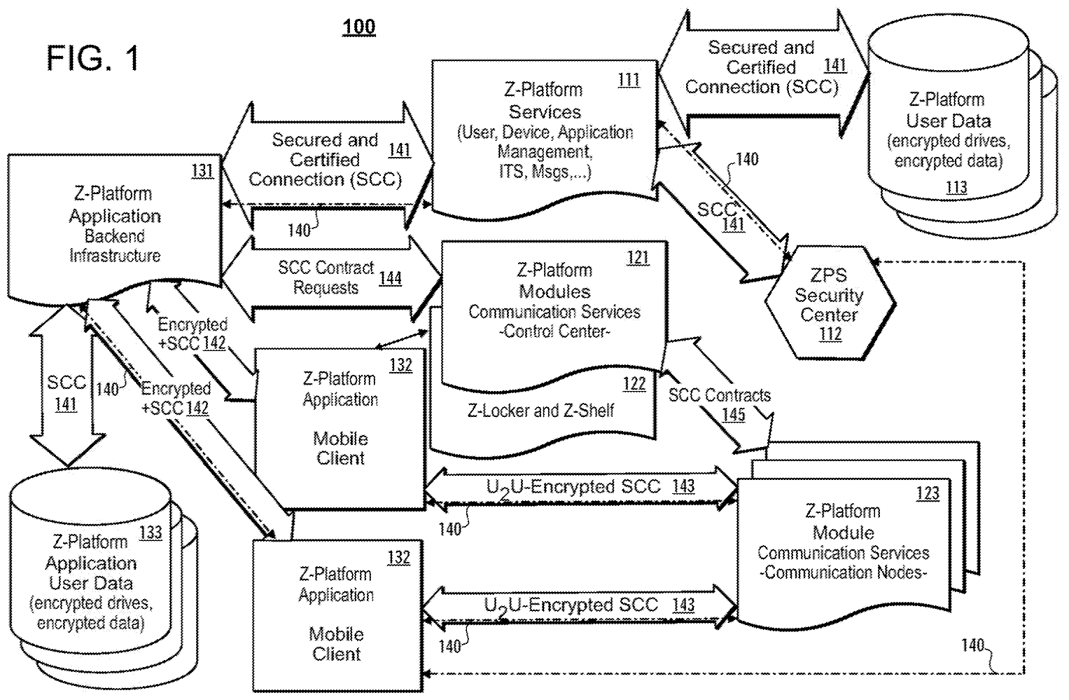

FIG. 1 is a schematic diagram depicting an overall architecture of the Z-Platform 100 in accordance with exemplary practice of the invention. As described in greater detail below, the Z-Platform architecture is designed so that secure and private applications can be constructed on top of the Z-Platform. Using the services of the Z-Platform, described in greater detail below, application developers can focus on central value aspects of their applications, while leaving more general tasks to services and functions provided by the Z-Platform.

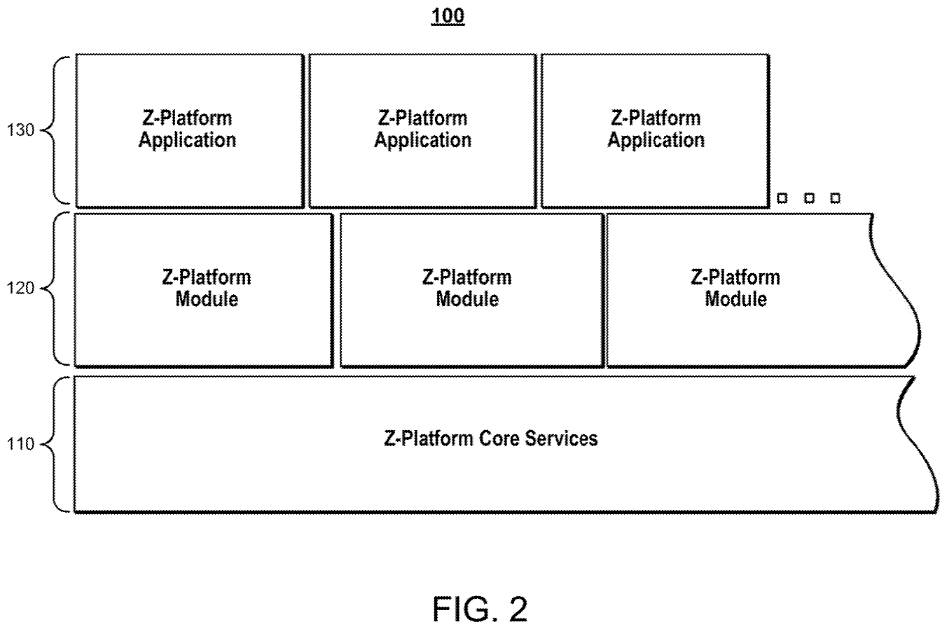

FIG. 2 is a schematic diagram showing three layers of Z-Platform architecture 100, including Z-Platform Core Services (“ZP Core Services”) layer 110, Z-Platform Modules (“ZP-Modules”) layer 120, and Z-Platform Applications (“ZP-Apps”) layer 130. In accordance with the invention, as described in greater detail below, ZP-Modules 120 can select from among various Z-Platform Core Services 110, while ZP-Apps 130 can select from both Core Services 110 and Modules 120. This approach facilitates modularization and maintaining of access control layers.

Returning to FIG. 1, according to an exemplary practice of the invention, the components of the Z-Platform include the following:

Z-Platform Core Services (“ZP Core Services”) layer 110:
Z-Platform Services 111;
ZPS Security Center 112; and
Z-Platform User Data 113;

Z-Platform Modules (“ZP-Modules”) layer 120:
Z-Platform Modules, Communication Services, Control Center 121;
Z-Locker and Z-Shelf 122; and
Z-Platform Module, Communication Services, Communication Nodes 123;

Z-Platform Applications (“ZP-Applications”) layer 130:
Z-Platform Application Backend infrastructure 131;
Z-Platform Application, Mobile Clients 132;
Z-Platform Application User Data 133.

As further show in FIG. 1, the following types of connections are used between the various system components:
traditional connections 140;
secured and certified connection (SCC) 141;
connection combining encryption and SCC 142;
U₂U-encrypted SCC 143;
SCC contract requests 144; and
SCC contracts 145.

### Z-Platform Components:

Core Services: In an exemplary practice of the invention, Z-Platform Core Services can include any of the following, described in greater detail below:
User and Device Management Services (UDMS);
Platform Security and Identity Translation Services (ITS);
Application Gateway (AGS) and Application Management Services (AMS);
Unified Message Delivery System (UMDS).

Modules: In an exemplary practice of the invention, Z-Platform Modules can include any of the following, described in greater detail below:
AudiooVisual Communication Service Module;
“Z-Locker” and “7-Shelf” Service Module;
Platform and Application Management Service Modules:
Payment Connector Service Module;
Platform Mail Delivery Services;
Additional modules can be developed in accordance with the invention.

### Z-Platform Security Design and Architecture:

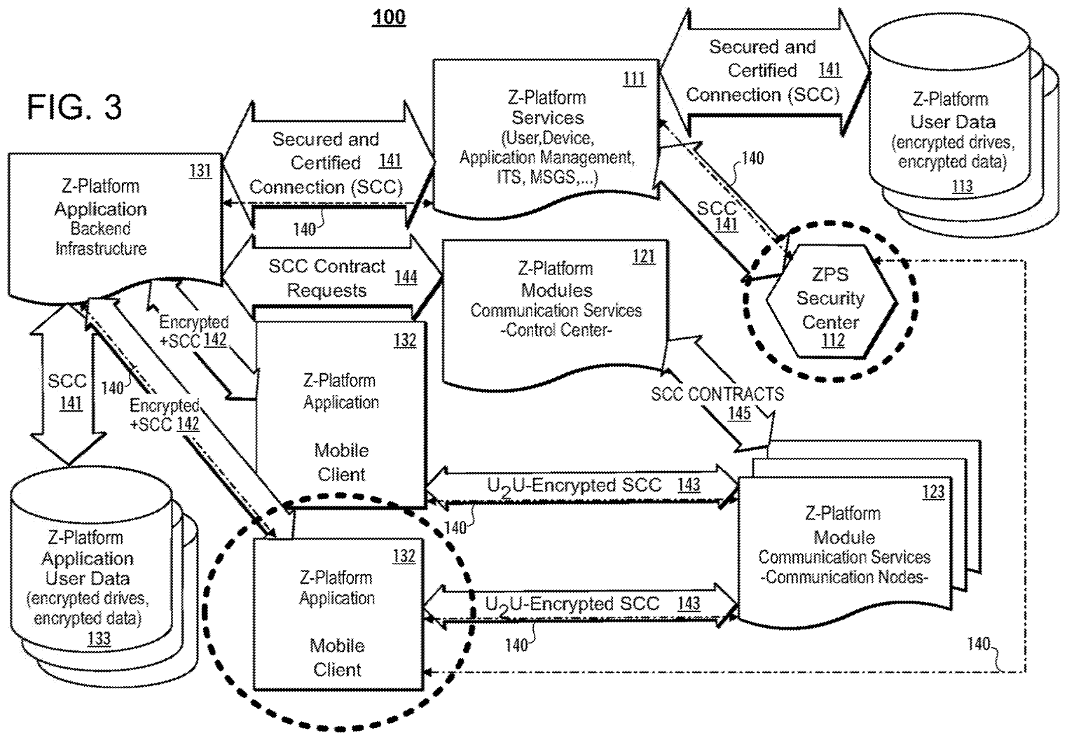

FIG. 3 is a schematic diagram depicting the security-related design and architecture of an exemplary embodiment of the Z-Platform 100. In accordance with the invention, security is an inherent design objective, and not an afterthought or add-on. Different strength security primitives are combined in order to minimize impact if a “weakest link” method is compromised. An exemplary practice of the invention has the following characteristics, described in greater detail below:
Server-Client design, no P2P elements.
Server is the Ultimate Source of Truth, and protection is focused on a known and controllable domain.
User-level encryption: central services are configured to be unable to decrypt either real-time or stored data.
NO decryption of user-to-user communications is possible, even if it is stored on the ZP server(s).
In addition to the novel aspects of the architecture and features of the invention, in practice, security will be based in part on an innovative combination of industry standards, known security algorithms and the utilization of proper security practices.
In an exemplary practice of the invention, everything in the system is protected and encrypted; and security primitives of a type known and approved by the cryptography expert community, avoiding the use of untested, unproven code. (In other words, security is enhanced by properly applying security operations, not from hiding or obscuring operations and features.)
HTTPS connectivity with client and server verification is merely one level of security, and the system applies multi-level payload encryption with short-lived rotating keys on top.
Encryption and tamper-proofing is integrated via latest authenticated encryption mechanisms of (e.g.) AES-GCM with FIPS 140-2 certification and post-encrypt message authentications.
Key sizes, life-cycles and encryption primitives are carefully selected and are selected to be ahead of current trends. (e.g., RSAiECC SHA2/3)
Data is protected on multiple physical and logical levels.
Data storage is designed with security in mind, from the hardware level up.
Sufficient gaps exist between operational data, user identities and used encryption keys.
Identity abstraction exists on internal and external representations; and user names and password derivatives are not stored at all.
Off-line messages are stored in configurable vaults (secure lockers with unique tags and keys).
   Further aspects of the Z-Platform Security Design and Architecture are discussed below.

### Core Services:

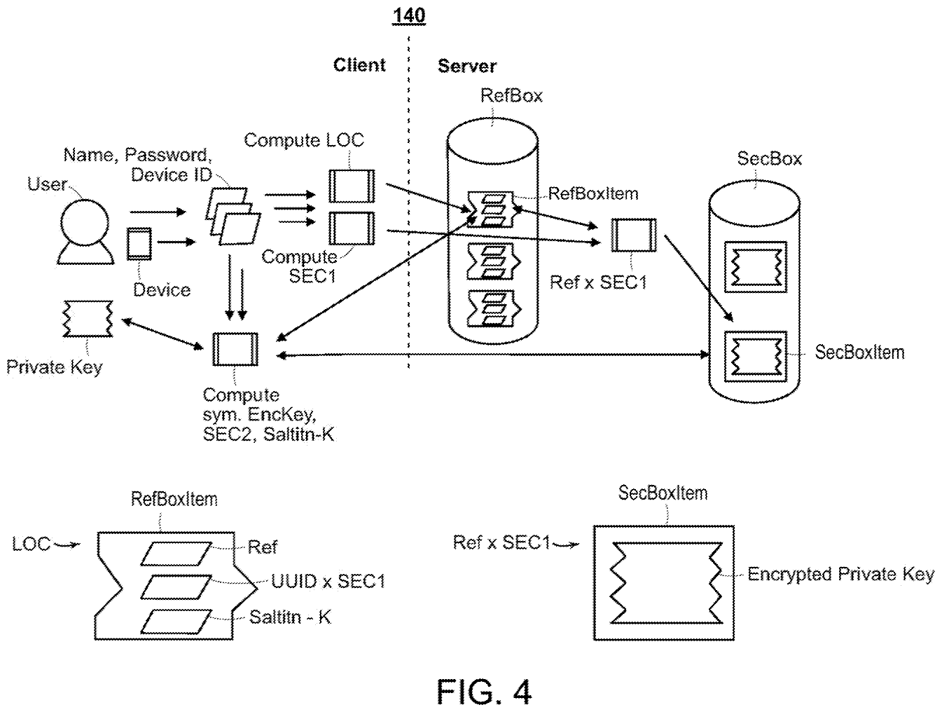

FIG. 4 is a schematic diagram 140 depicting method aspects of securely locating digital keys in accordance with an exemplary practice of the invention. Reference is also made to commonly owned U.S. Provisional Application for Patent Ser. No. 62/376,210 filed Aug. 17, 2016, entitled “Multi-Factor Protected Private Key Distribution” (Attorney Docket MNE-114-PR), which is, along with other commonly owned patent applications listed above, incorporated herein by reference as if set forth herein in its entirety, and which discusses, among other aspects, methods of using such keys.

Registration and Login: The structures depicted in FIG. 4 also relate to Z-Platform Core Services of Registration and Login, which, in exemplary practices of the invention, have the following characteristics, described in greater detail below:
All client-server communication starts with a ZDNS and a verified entropy exchange;
Devices generate their own keys and get them verified and signed with the platform;
Devices authorize other devices with proper user access to extend chain of trust;
Device tunnel is used in HTTPS;
Advanced Identity Management (AIM) is based on known PKI approaches, with focus on securing the private key with escalated access steps (Reference Boxes lead to Secure Boxes=Advanced Identity Storage);
Identity is bound to demonstrating access to the private key, which requires access to device and unlock secrets. Private keys are NOT stored on the device;
Authenticated session requires nonce verification which is generated and encrypted with public key during Secure Box retrieval;
Authenticated user sessions give access to persona information which then can be used in Platform Applications;
Persona logins are identical to User Logins;
Recovery is done via a PUK Reference Box, where half of the identification comes from a trusted source.

Access Control: Z-Platform Core Services also include Access Control, having the following characteristics, described in greater detail below:
Data is distributed across various locations, depending on access requirements. Device IDs, User and Persona Core Entries, Real-World Personal Information (RWPI), Virtual Entity Preferences (VEP), Reference and Security Boxes, Z-Lockers and Z-Shelves are all physically separated.
Identity Translation Service: Z-Platform Applications have their own identification domains. In order to tie a real person to its application domain identifier, the platform provides a one-way transformation from Platform User ID to ZP-App Domain ID.
Information Access Matrix: ZP-Applications register (submit and get evaluated) for accessing data entries. Data entry access (R/W) is stored in a per-application matrix and also at user/persona entries if application level access needs to be over-ridden.
Application Gateway Services (AGS): ZP-Applications have their own PKI certificates which they use to validate themselves with Z-Platform via a certificate chain. Individual ZP-Apps may have their own certificates rooted in the ZP-App certificate signed by the platform. AGS provides managed access (ticket-granting-type/reservation mechanism) for access controlled data manipulation.

### Z-Platform Modules:

A/V Communications Services: Z-Platform Modules can include A/V Communications Services, which can have the following characteristics, described in greater detail below:
The services can be developed “in-house”, to eliminate distribution channel dependencies and enable continued innovation and advancement (for example, in areas such as crypto, and virtual reality (VR));
Negotiated real-time communication services, including audio, video and shared spaces with cooperative manipulation;
Contract approach (requirement analysis, proposal, contractor selection, task execution, constant delivery verification with conflict resolution, evaluation, and payment execution);
End-to-end encrypted with advanced real-time key-management. C-S and C-C encryption domains are separated;
Session-level Quality of Service and bandwidth management based on individual and infrastructure demands;
Multi-channel approach within a stream with specialized characteristics (function, reliability, prioritization, packet shape);
Intelligent routing based on both geo- and bandwidth-aware information;
Client SDK for mobile operating systems including both iOS and Android.

Z-Storage: Another Z-Platform Module is referred to as Z-Storage, which can have the following characteristics, described in greater detail below:
Z-Locker and Z-Shelf services provide personal cloud storage services with enhanced security within the federated space.
Location Reference Name, Content Encryption Passphrase and PIN for Z-Locker.
Content is encrypted with AES_GCM and IV/SALT/IT/AUTH/CHALLENGE are added with TTL and access descriptions.

Message Delivery: Another Z-Platform Module is Message Delivery, which can have the following characteristics, described in greater detail below:
Unified Message Delivery Service (UMDS) is an advanced “PO-Box/Envelope” type of mailbox system to address message exchanges between personas within or across ZP-Application domains. Every envelope has a “stamp” and a delivery schedule, facilitating delivery of approved marketing material, including payed-for and to-the-recipient delivery.
Platform Mail Delivery System (PMDS) provides set up for the message “packaging.”

Payment Connector: Another Z-Platform Module is referred to as Payment Connector, which functions to turn internal accounting, such as accounts payable and accounts receivable, into real-world payment transactions, with RWPI verification.

Application Management Services: Another Z-Platform Module is Application Management Services, which can have the following characteristics, described in greater detail below:
Managing ZP-Applications (access rights, information, security perimeters) for AGS.
Communication channel for ZP-App developers and Z-Platform personnel.

Platform Management Services: Another Z-Platform Module is Platform Management Services, which can have the following characteristics, described in greater detail below:
Access is granted to Z-Platform authorized personnel only;
Z-Platform maintenance interface to verify the operating state of the platform;
Modifications to platform-accessible information;
Strict authorization and logging is enforced with real-time messaging of access events and immediate AIM override (only to limit access) in a time-and-escalation dependent fashion, wherein operators can impose only time-limited restrictions which trigger escalations.

### Z-Platform Service Classes:

In an exemplary practice of the invention, Z-Platform Service Classes include the following, described in greater detail below:

Class 1:
Platform specific Domain Name System services and integration into access routing;
Device Management (ID factory, registration, deletion);
User Management (ID/Key/Certificate factories, registration);
Security Reference and Access Box creation primitives;
Payload Cryptographic Primitives (hashes, HMACs and encryption/decryption primitives).

Class II:
Device Tunnel Setup and Verification Services;
User Security Access Box utilization (secure credential store and retrieval);
Establishing User Tunnels;
Session Management (session establishment and cryptographic environment);
Tokenization Services (utilized by Communication and other external access providing modules).

Class III:
Application Management (registration, access controls, certificates);
Public Key Management Services;
Dynamic Session and User Tunnel Management (rotating keys and related services);
Real-time Payload Cryptographic Services.
   These and other aspects will be described in greater detail in the following sections.

### PART 2: TECHNICAL DESIGN

The purpose of Part 2 is to provide a design overview and describe the building blocks of an exemplary practice of the Z-Platform, from both an infrastructure and a software federation point of view, for enabling highly secured communications among platform users and platform applications. Part 2 is organized into the follow sections:

Introduction

Overview of the Z-Platform Architecture and Components

Design: Z-Platform Core Services
Overview
Description of Security-Related Core Procedures
Identity Translation Service (ITS)
Unified Message Delivery System (UMDS)
Application Gateway Services (AGS)

Design: Z-Platform Modules
Overview
Audio/Visual Communication Service Module
The Z-Store Service Modules
Application Management Services Module
Platform Management Service Module
Payment Connector Service Module
Know-Your-Customer Connector Service Module
Platform Mail Delivery Service Module

Developing Client Applications for the Z-Platform

Addressing Secure Data Retention Compliance

### Introduction

The Applicants, during their development of the subject matter referred to herein as “Zeitmarkct” (see also the commonly owned patent application Attorney Docket MNE-112-PCT incorporated herein by reference) designed a separation of core services and application-specific elements. Instead of designing a monolithic application with its entire infrastructure (both software and hardware), the identification and separation of user management, platform security, and secure-communication functions took place. Platform-specific software modules were also identified and integration points with the platform applications were designed. The current Zeitmarket application is our first attempt at integrating the Z-Platform Services and the Z-Platform Modules for developing the first Z-Platform Application.

One of the requirements was to have the ability to move current traditional web-services into the secure Z-Platform domain by providing on-the-fly content transformation services wedged between the webserver and the content storage. The Applicants consider this design unique in its ability to manipulate the content transformation module through a separate communication channel on demand, and to customize it to request endpoints and/or users governed by a non-cohosted authority. This opened up the possibility of securing (encrypting and scrambling) content delivery specifically targeting an active and dedicated consumption endpoint. The main difference between traditionally secured channels (such as https, TLS, TOR) and the Z-Platform-provided content transformation is the ability to manipulate the content transmission at a much finer grain—change encryption parameters on the fly, redirect to unauthorized content services (including honeypots or external services if needed), etc.—all subject to the state of the consumption authority endpoint and/or user being present on the Z-Platform. With computational power evolving faster than communication speeds, the next step in customized delivery (on top of the different TLS channels) is now possible. Z-Platform provides a user-specific content transformation, encryption and delivery mechanism for both its applications and the traditional web-based services enhanced with its platform modules.

For the Applicants, a key factor in designing Z-Platform was the importance of differentiating between anonymity and privacy. Z-Platform's emphasis is on privacy and the protection of user identifiable information while maintaining total user awareness. Z-Platform is not creating a safe haven for criminals; its primary goal is to protect the communications and the storage/usage of sensitive information of its legitimate users.

While various communication platforms are available today, Z-Platform differs from other communications platforms in a number of ways, including the following:

1. All Z-Platform communications, including attachments, are strictly end-to-end encrypted with enhanced encryption methods. Instead of using a blob storage service, the platform utilizes a tertiary channel for sending attachments and sends the attachment keys through the secondary encrypted channel. For situations where this layered transport is not feasible, Z-Platform offers a secure storage called Z-Locker discussed in this document.

2. The aforementioned enhanced encryption methods include aggressive session key rotations that are synchronized on the secondary encrypted channel. Unlike other derived key-ratcheting solutions the keys are not part of the message.

3. On top of widely adopted simple techniques to manage bandwidth and QoS, the platform's video calling service utilizes packet shaping (not just packet stuffing). In certain scenarios doing so provides better utilization of the UDP channels as packets are filled to “best-fit” sizes on the given routes.

4. Z-Platform's Audio/Video services provide 1-1, 1-N, and N-N connections with built-in resource sharing (whiteboards, gestures, markers, etc.). They further provide synchronized access controls to these resources thus facilitating real-time manipulation of shared images (zoom, point, annotate) and shared resource distribution (passing the microphone).

5. Z-Platform provides Message Temporal Decoupling services during the server-based message delivery: messages sent via platform servers may have artificial random latencies introduced to reduce timing-related information leakage for sender/receiver events. It is important to note that Z-Platform's servers only relay messages and are not in possession of any decryption keys.

6. In multi-participant messaging situations, Z-Platform's design utilizes the encrypted setup session (Signal Protocol type session key distribution mechanism by Open Whisper Systems) to create a channel for setting up a Multiple Participant Diffie-Hellman session with the NCAIET-2015 proposed Key Distribution Protocol. This further strengthens the platform's security channels even in possibly-compromised key situations.

7. During encrypted sessions, Z-Platform utilizes SMP (Socialist Millionaire Protocol) to verify the integrity of the channel (against MITM attacks) and does not require a visual or audible confirmation of the used keys as most current products do.

### Overview of the Z-Platform Architecture and Z-Platform Components

As discussed above with respect to FIGS. 1 and 2, the Z-Platform architecture 100 is designed so that secure and private applications can be constructed on top of the Z-Platform. Using the services of the Z-Platform, described in greater detail below, application developers can focus on central value aspects of their applications, while leaving more general tasks to services and functions provided by the Z-Platform.

As discussed above, FIG. 2 is a schematic diagram showing the major building blocks of the Z-Platform architecture 100, comprising three layers:

Z-Platform Core Services (services) 110;

a collection of Z-Platform Modules (modules) 120; and

a collection of Z-Platform Applications (apps) 130.

Returning to FIG. 1, the Z-Platform Core Services layer 110 comprises blocks 111, 112, and 113. The Z-Platform Modules layer 120 comprises blocks 121 and 122. The Z-Platform Applications layer comprises blocks 131, 132, 133, and 134.

Modules 120 can choose to utilize any of the services 110 while apps 130 can and selectively have to utilize any or all of the core services 110 and/or module-provided functionalities 120.

The Z-Platform Core Services 110 include the following:

User and Device Management Services (UDMS);

Platform Security and Identity Translation Services (ITS);

Unified Message Delivery System (UMDS);

Application Gateway Services (AGS); and

Application Management Services (AMS).

The Z-Platform Modules 120 include the following:

Audio/Visual Communication Service Module;

Z-Locker and Z-Shelf Service Modules;

Platform and Application Management Service Modules;

Payment and Know-Your-Customer Connector Service Modules; and

Platform Mail Delivery Service Module.

The Z-Platform Applications 130 include the following:
Goal-Specific and Market-Specific Applications utilizing the platform-provided modules and services.
(Zeitmarket is currently in development and is discussed in separate documents.)
   Each of these building blocks is discussed in greater detail below.

### Z-Platform Core Services

### Overview

The Core Services of the Z-Platform offer a variety of functions to manage users, devices, and endpoints.

Z-Platform's proprietary subdomain management service (ZPDNS) culls static access attempts while performing built-in application-specific redirections and access token verification services. When an application becomes part of the Z-Platform Ecosystem, it gets registered (and certified) with the platform's core services which then provide application access authorizations for both the registered endpoints and to the general platform services as well.

The platform's Core Services also provide device management functions, including but not limited to device registration (utilizing a one-way ID transformation), authentication, assignments (both user and application), and usage restrictions. When a device first gets registered, it only has access to a limited set of services to enable the user (or the system) to execute proper assignments (certain devices may or may not have access to applications and/or users).

Core Services also provide user and persona (sub-user) management, which include but are not limited to identity transformations (application-specific, internal-external representations), device associations, and storage services. All data is segregated and distributed amongst several data stores and are assembled into coherent information at the last possible moment.

Platform security functions include but are not limited to user access verification, application access verification, key management, multi-channel encryption (utilizing both industry standard approaches and specialized content transformation services with rotating parameters), identity translation services (ITS: per-app user ID) and security primitive services such as HMAC (keyed-Hash Message Authentication Code), HASH and encryption.

The Unified Message Delivery System (UMDS) provides a guaranteed application-aware message delivery to the user/persona inboxes. When applications access platform user information services, they are sent “envelopes” which are addressed to the user within the application domain. This infrastructure is also used to accommodate inter-application communications for a given user without compromising his/her identity. The messaging system can also be configured to introduce random latency to the delivery schedule to avoid delivery time-correlated information leakage.

### Description of Security-Related Core Procedures:

### Entropy Exchange

Referring to FIG. 3, prior to any meaningful communication, a connecting client 131 exchanges sixteen entropy bytes with the Core Server's Z-Platform Security Center 11 during the Entropy Exchange stage. This ensures that clients with weak entropy get better initializations for subsequent cryptographic operations. The server filters and—if appropriate—integrates the client's bits to its own entropy.

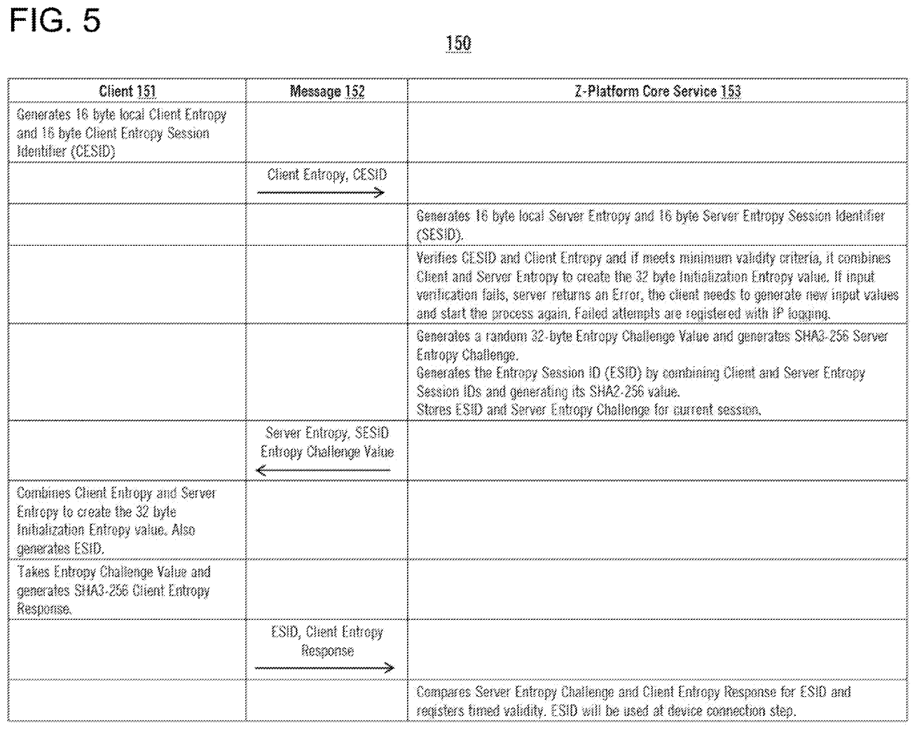

FIG. 5 is a table 150 illustrating an exemplary practice of the execution of the Entropy Exchange. The left column 151 lists the steps executed by a client, the right column 153 lists the steps executed by the Z-Platform Core Service, and the middle column 152 lists the messages sent between the client and the Z-Platform Core Service.

### Device Registration

Z-Platform requires the proper registration of user devices. Z-Platform does not depend on manufacturer/device operating platform-provided identifications for several reasons. It computes its own device IDs, which are essentially 32-byte unique IDs generated from entropy sources and their digests. Upon successful registration a Device Certificate is generated, stored, assigned and communicated back to the device for consequent communications. The registration procedure may be initiated when:
The device has never connected before.
The Device Certificate is expired.
   The Device Certificate (stored in the devices keychain) or the Device ID is missing or unattainable.
The Device Certificate does not match the Device ID.
The server rejected the connection.
The server requested a new Device Registration.

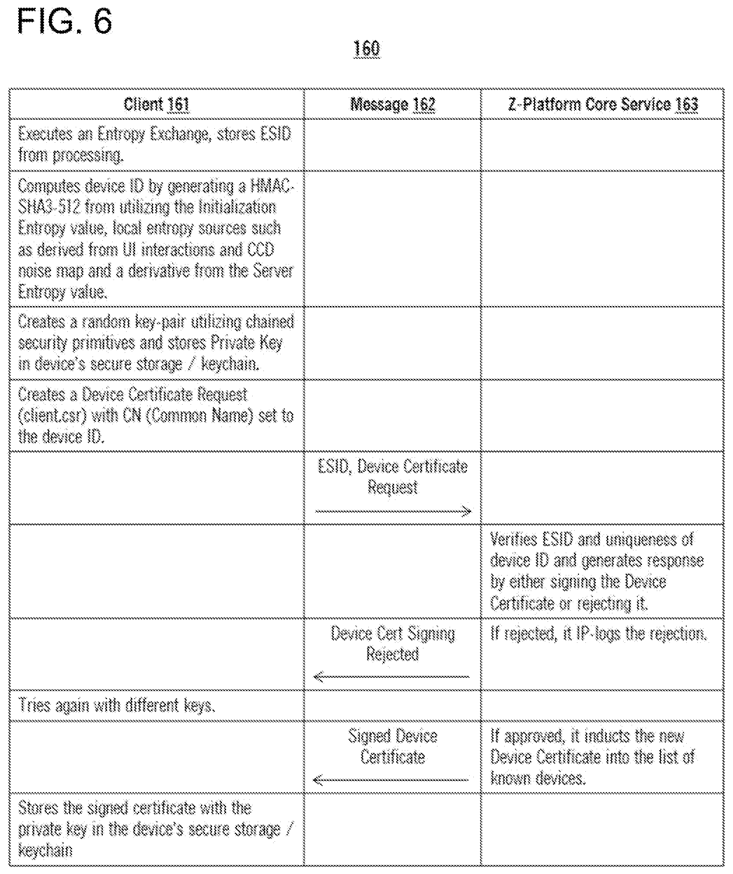

FIG. 6 is a table 160 illustrating an exemplary practice of the execution of the Device Registration procedure. The left column 161 lists the steps executed by a client, the right column 162 lists the steps executed by the Z-Platform Core Service, and the middle column 163 lists the messages sent between the client and the Z-Platform Core Service.

TLS Tunneling with Server and Client Authentication (CA)

As described, during a successful device registration a Device Certificate is created. This certificate is used as a client certificate when establishing secure connections with the Z-Platform servers. This approach ensures an industry accepted security standard baseline, which serves as the primary tunnel for all other internally encrypted communications. All Z-Platform server components are also issued their own server certificates, which results in a two-way trust system. All Z-Platform Ecosystem certificates are rooted in a single Z-Platform Root CA certificate, for which the private key is kept isolated from all other connected elements.

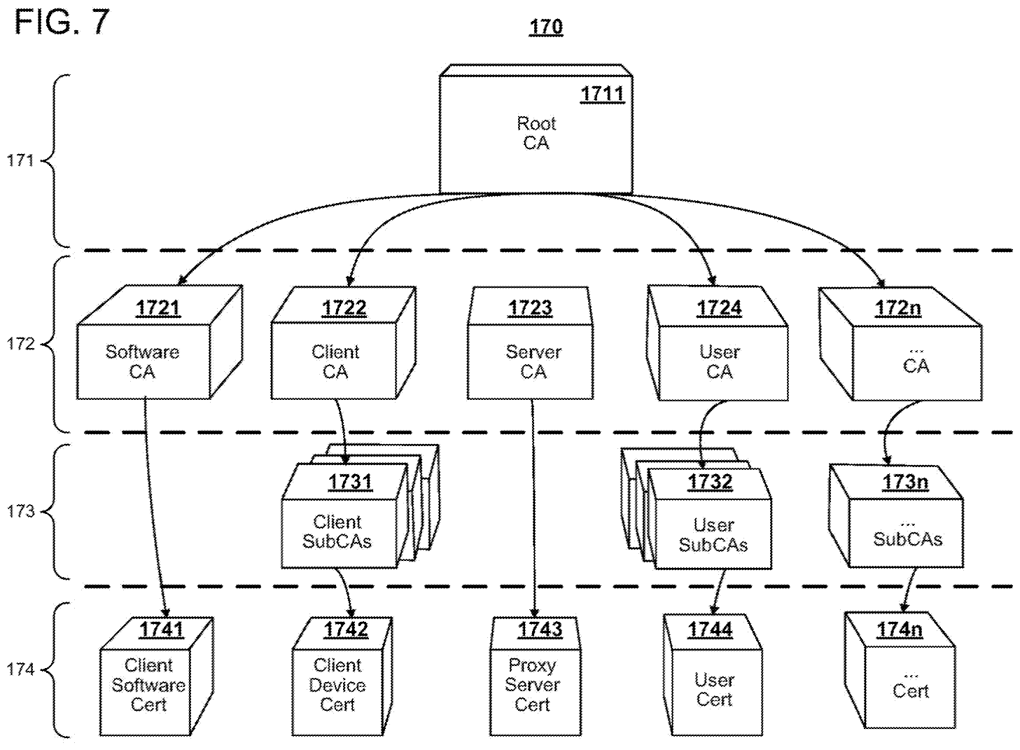

FIG. 7 is a diagram of an exemplary certificate chain 170, comprising four levels: The chain's top level 171 comprises the Root CA certificate 1711. The chain's bottom level 174 comprises, for example: client software certificates 1741, client device certificates 1742, proxy server certificates 1743, user certificates 1744, and other like certificates 174n.

The chain's second level 172 comprises intermediate certificates that are positioned in the certificate chain between the Root CA in the first level 171 and the fourth-level certificates 174. The second-level certificates comprise, for example: Software CA certificates 1721, Client CA certificates 1722, Server CA certificates 1723. User CA certificates 1724, and other like certificates 172n. Some of the second-level certificates 1721-172n have sub-certificates, which are in the chain's third level 173. These sub-certificates comprise, for example: Client SubCA certificates 1731, User SubCA certificates 1732, and other like SubCA certificates 173n.

Issuing individual certificates to every device allows perimeter exclusion of unauthorized clients lest those be malicious or access-revoked devices. When devices connect to a server, a traditional TLS connection is established, and both ends verify the validity of the presented certificates. All further communications are handled within this Device Tunnel.

It is important to note that proper ssl_verify_client setups are required on the server blocks including non-default blocks for non-SNI connections. Improper setup can result in improper redirections. All Z-Platform hosted ZP-Applications are setup this way automatically. Refer to “When the default server block has client certificate verification enabled, it allows the connected client to do requests on other server configuration blocks, while ignoring the client certificate verification options of that other server block.”

### User/Persona Accounts

User and persona accounts are at the core of the Z-Platform. User accounts have real people with real identities directly associated with them, while persona accounts are different representations of and are rooted in the user accounts. Personas can also be described as masks that a person (user) might be wearing depending on what venue he/she visits. Its purpose is to protect the original identity under different task-specific and location-specific environments. Persona information is stored independently (both logically and physically) from the User Accounts and there is no direct link going from Personas to the User. The association and logical linking is done by using Z-Platform's Identity Translation Services (ITS) discussed in a later chapter.

While the distinction between users and personas is a valuable feature of the Z-Platform, the difference between the two in regard to authentication and authorization is minor. From the security perspective, user/persona sessions introduce a secondary encryption layer, also referred to as The Inner Tunnel. Users' identities are represented by certificates and their accompanying secret keys which are stored and retrieved via Z-Platform's Advanced Identity Management (AIM) mechanism. When connecting to the Z-Platform services, the client devices establish proper client certificate-verified TLS sessions then proceed to establish user sessions for their respective identities. The transport mechanism for the latter Inner Tunnel is similar to a TLS tunnel, i.e. an ephemeral key is negotiated between the client and the server and user/personaservice certificates are exchanged and mutually verified. Different from the Device Tunnel, user sessions are not tied to a single network stream (e.g. http/tcp connection) but handled as virtual streams that can last for a longer period of time with periodic rekeying and key rotations. The current design incorporates a key-ratcheting mechanism ensuring that session messages conform to Z-Platform requirements of achieving perfect forward secrecy (PFS).

Registering user and persona accounts utilizing AIM is one of the most involved and complex procedures in the Z-Platform ecosystem from the system's point of view. The registration needs to be verified by taking into account the validity of the used software/platform, location (both physical and IP-space), an initial two-factor authentication and in most cases a valid real-world identity verification utilizing some sort of identification such as a credit card or a linked bank account information. Optionally, Z-Platform can also generate recovery methods such as Personal Unlocking Keys (PUKs). Logging in requires both valid user-entered (user/persona name, some representation of identification such as passwords, gestures, etc.) and device-retrieved information.

### Advanced Identity Management (AIM) Mechanism

Z-Platform, unlike many other online services, uses an enhanced form of the well-established and cryptographically proven PKI (Public Key Infrastructure) and certificate approach for authentication and identity binding. The crucial element in determining a user's and persona's identity is bound to the fact that the user can demonstrate full access to his/her private key that is needed for signing and encrypting messages. In a modem mobile client/server environment, the safekeeping of a private key, however, poses a significant problem for most users. Mobile devices are often not backed up and often lost, destroyed or in some cases compromised by accident or through unauthorized events. If they are backed up, the data is usually transferred to cloud storage, utilizing a simple, vendor-chosen form of encryption and storage.

In an exemplary embodiment. Z-Platform uses a system, described in commonly owned patent application Attorney Docket MNE-114-PCT incorporated herein by reference, for safekeeping its users' secret keys, which supports the following properties:
The secret key is only available unencrypted while it is used for encryption functions on a user owned and controlled device.
The secret key is never stored in clear text in any permanent storage, including the designated platform's vaults, secure storage or keychain areas.
To get access to the private key, a user has to provide an unlocking secret of sufficient complexity to be computed into a long symmetric encryption key. This unlocking secret may be composed of multiple factors, e.g. the users' name, a passphrase, a smart card or token, biometric or some form of behavioral input.
The complete unlocking secret is never stored on or transferred from the device it is used on.
To limit the impact of compromised devices, the encrypted secret is not stored permanently on the users' devices, instead they are stored in Z-Platform's Advanced Identity Storage.
For referencing the server-side stored secret, client device IDs are merged into addressing information needed for locating the stored secrets. This ensures that the possession of a user's unlocking secret is not sufficient to retrieve the stored secret; the user's device also needs to be present.
The retrieval parameters am derived from the user's unlocking secret in a way that only a subset of unlocking secret information is sent to the server. This ensures that on the server side, the actual secret key cannot be decrypted into an accessible form. Deriving the retrieval parameters from the unlocking secret is strengthened by derivation algorithms that allow the user to memorize only short pass phrases (single password access).
The unlocking secrets received from a client are only held on the server in memory while needed for ongoing computations; they are securely purged immediately after usage. This ensures that the relations between the servers' databases can only be traced while the transient secrets received from the users are present.
The physical storage of the encrypted secret keys are in an unmarked form, i.e., the key materials are not marked with any identification but are mass-stored in a blob store with random bytes filling gaps between them.
References to encrypted secret key locations (blocks and offsets) are at an independent location in obfuscated and encrypted forms.
The references to the encrypted secret key locations cannot store any information that can lead to information leakage, such as user/persona differentiations.
The encrypted keys are stored on encrypted drives to protect against off-power scenarios.

To satisfy the above listed criteria, Z-Platform uses a linked access mechanism where each look-up stage gives a pointer to the next stage with no need to validate the correctness of the target link or the content of the data stored at the addressed locations. This deliberate design was added to severely limit rejection-based access attempts. The general approach for this mechanism is rooted in the locker box access design similar to the platform's Z-Locker data storage solution discussed in a later chapter.

In order to access and retrieve the personal private keys, the user-provided and device-provided information are combined to generate an entry address and access parameters. From the entry locker (Reference Box, RefBox, addressed by the entry address), enough information is retrieved to compute the actual Security Box (SecBox) where the user's private information is stored. At this location the user's Z-Platform ID is stored along with other identifying elements, such as the length and the reference (block:offset) pointer to his/her encrypted private key. The actual encrypted private key is stored in another location from which it is retrieved by providing the block:offsct pair and the length (encrypted key length).

It is important to note that the retrieval mechanism has no notion of valid entries, it simply returns a data block defined by the block:offset:length triad from certified and verified servers. It is also important to note that all access requests return data to the requesting entities without validation. Validation of returned data is done on the client side and is heavily context dependent. This is a deliberate behavior resulting from our policies on not having platform access to private keys.

The Identity Management is split into two levels; Level Zero only addresses access control to users' Security Boxes and Session Management, while Level One validates the users' entities utilizing the RWP (Real-World-Person) and KYC (Know-Your-Customer) links. The latter is further explained in the Know-Your-Customer Connector Service Module description. Important to note, that since Z-Platform also has its own RWP identification mechanisms (such as through its Payment Connector Services and Behavior Observations), combining a third-party's KYC service further enhances the platform's identifications of its real users and may also provide a verification link back to the third party's KYC services further strengthening it.

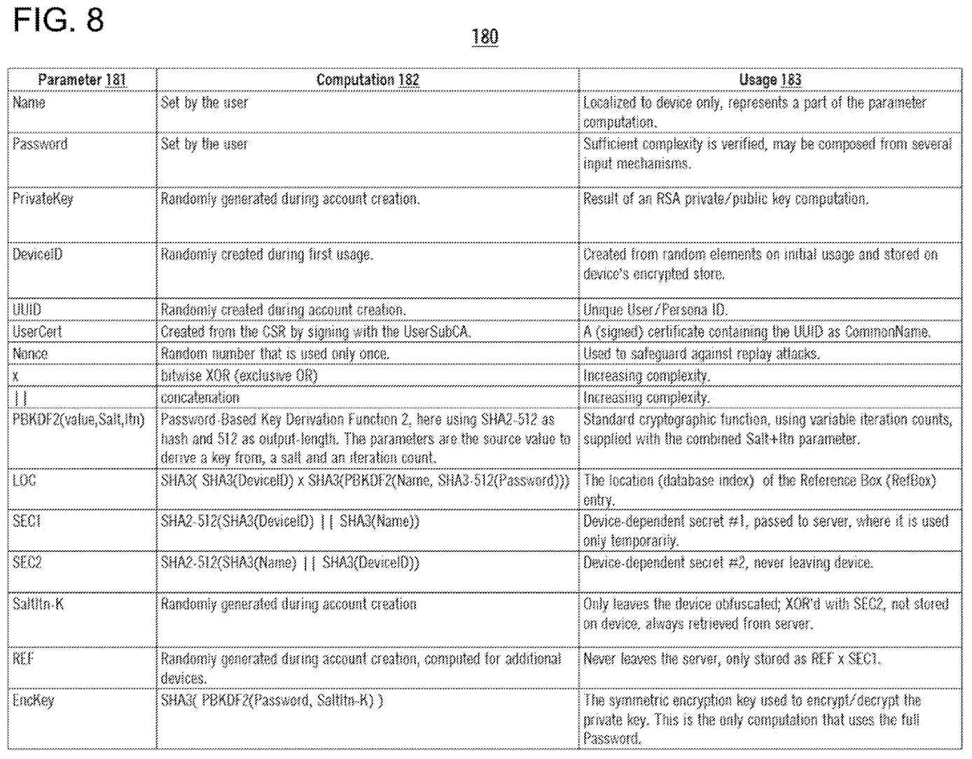

In order to fully understand the complex process of the AIM mechanism. FIG. 8 provides a table 180 setting forth a number of abbreviations and expressions (i.e., parameters) are used in the present description. Table 180 comprises the following columns: Parameter (column 1) 181; Computation (column 2) 182; and Usage (column 3) 183.

FIG. 4 is a diagram providing an overview of the components of an exemplary system 140 used by Z-Platform for safekeeping its users' secret keys. As mentioned above, system 140 is described in greater detail in a co-pending patent application.

### The Creation and Storage Process of AIM

The following steps describe the creation of a new AIM entry:
1. User enters the unlocking secrets (Name. Password).
2. Device generates a random DcviceID (or uses a previously generated and stored value from the device's secure storage).
3. Device generates a random private/public key pair.
4. Device generates a random user/persona UUID.
5. Device prepares a certificate signing request (CSR) (UUID is CN).
6. Device computes the parameters from the unlocking secrets: SEC1, SEC2, LOC, Saltitn-K, EncKey.
7. Device encrypts private key with EncKey.
8. Device sends LOC, SEC1, Saltln-K x SEC2, CSR EncryptedPrivateKey to Server, requesting a new identity to be created.
9. Server checks if UUID (from CSR) is unique.
10. Server signs CSR and stores signed certificate in public certificate table.
11. Server computes random REF value.
12. Server stores REF and Saltitn-K x SEC2 in RefBox at location LOC.
13. Server computes REF x SECL.
14. Server stores EncryptedPrivateKey in SeeBox at location REF x SEC1.
15. Server returns Saltltn-K, EncryptedPrivateKey UUID and signed certificate to client.

### The Retrieval Process for AIM

The following steps describe the retrieval of an AIM entry, effectively a login:

1. User enters the unlocking secrets (Name, Password).

2. Device retrieves the DeviceID from the device's secure storage.

3. Device computes parameters from unlocking secrets: SEC1, SEC2, LOC.

4. Device sends LOC, SEC1, to Server, requesting retrieval.

5. Server retrieves RefBox item from location LOC, reads REF, UUID and Saltln-K x SEC2.

6. Server retrieves EncryptedPrivateKey from SecBox at location REF x SEC1.

7. Server retrieves signed certificate from public certificate storage.

8. Server returns Saltltn-K x SEC2, EncryptedPrivateKey, UUID and signed certificate to client.

9. Client computes Saltltn-K and EncKey.

10. Client decrypts PrivateKey using EncKey.

### The Procedure of Authorizing a New Device in AIM

As the unlocking secrets sent to the server are dependent on the DeviceID, an account is effectively locked to the device it has been created on. To authorize a secondary device to use the same user/persona account, the following procedure is used to create a secondary RefBox entry on the server that points to the same SecBox as the initial one.

The procedure requires the user to be fully authenticated for the account. The procedure also requires that the Device ID of the new device be temporarily shared with the existing device, a functionality that is implemented using visual pictograms (like QR codes) or preferably an NF/BT (Near-Field/Bluetooth) communication. The latter necessitates physical proximity of the two devices which is construed as an added security measure.

As a special application of this procedure, a pseudo-recovery device can be created. While Device IDs are normally not accessible for the users (generated by the device from device unique properties and random data), a recovery Device ID may be shared with the user for safekeeping. Users can opt out of providing recovery devices.

The following steps describe the authorization of a new device and its inclusion in the AIM access chain:
1. Client logs in according to previous procedures, keeps Saltltn-K, SEC1-old, SEC2-old, LOC-old.
2. Client obtains the new device's DeviceID (from QR Code or NF/BT channel).
3. Device computes parameters from unlocking secrets (previously specified Name and Password): SEC-new, SEC2-new, LOC-ncw. SatItn-K and EncKcy remain the same as on to the existing device.
4. Device sends LOC-old, SEC1-old, LOC-new, SEC-new, Saltltn-K x SEC2-new to Server, requesting a new device be authorized. This request is encrypted and signed with the private key.
5. Server decrypts with public key and checks if the request signature is correct.
6. Server checks if LOC-old points to a valid RefBox and if the UUID x SEC1-old matches the UUID from the request signature and if LOC-new is unallocated.
7. Server computes REF-new x SEC1-new from REF-old (using SEC1-old).
8. Server checks if REF-new x SEC1-new points to a valid SecBox.
9. Server stores REF-new x SEC1-new and Saltitn-K x SEC2 in RefBox-new at location LOC-new.
10. Server acknowledges device authorization.

### Creating a User Account

This action can only proceed from an already active and registered device. During registration, the device non-exclusively gets associated with the user.

### User Session Setup

All User and Persona communications are encrypted (inside the device tunnel) with individually negotiated encryption keys. To allow for the encryption to be established before messages to create or use user accounts are exchanged, the session is created initially without any specific authentication in place.

Internal to the servers, a session can have several states: NEW (no keys exchanged yet), OPEN (session encryption set up, but no authentication yet), AUTHENTICATED (the client's identity has been verified), EXPIRED (session needs renewal).

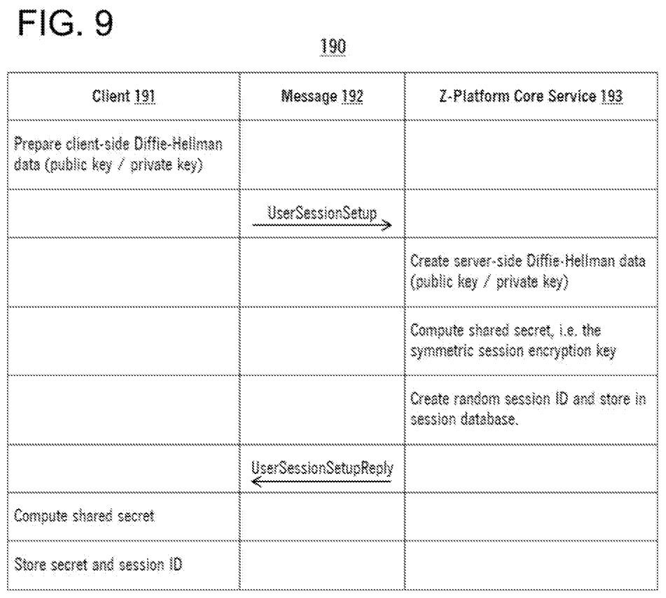

The UserSessionSetup establishes a common encryption key and primes the PKI. FIG. 9 provides a table 190 setting forth the execution of this process, comprising the following columns: Client 191. Message 192, and Z-Platform Core Service 193.

After the UserSessionSetup, client and server share a secret and a session ID. The session ID makes it easy to refer to a specific session secret which is used to encrypt the subsequent messages.

### User Account Creation Process

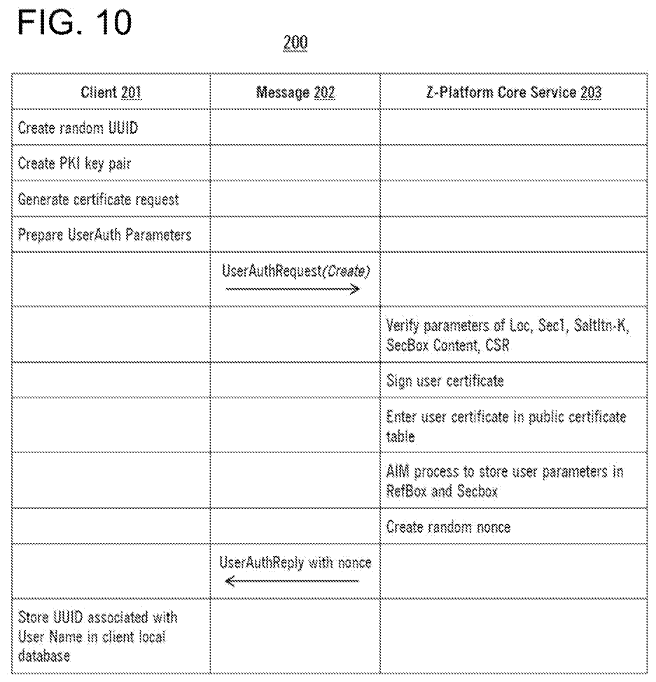

The UserAuthRequest(Create) creates a new user/persona identity. FIG. 10 provides a table 200 setting forth the execution of this process, comprising the following columns: Client 201, Message 202, and Z-Platform Core Service 203.

### Logging in to a User Account

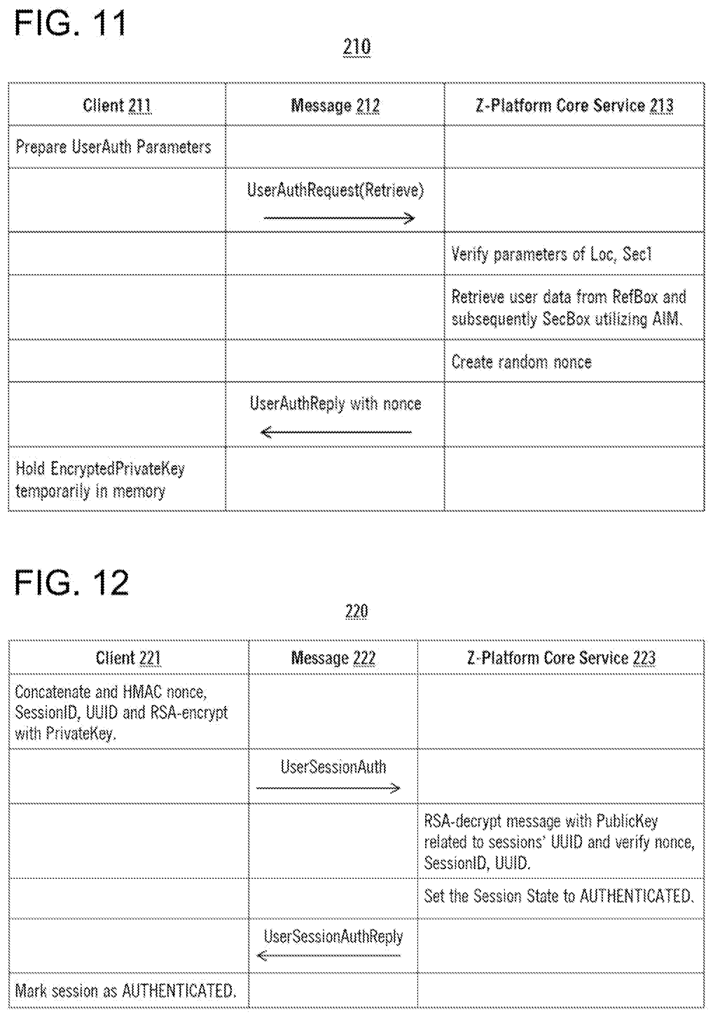

As mentioned previously, logging in to a user/persona account starts with the retrieval of the associated encrypted private key and other parameters utilizing AIM. The UserAuthRequest(Retrieve) communication retrieves the encrypted Private Key, Saltltn-K and UUID, so that the client can perform PKI operations. FIG. 11 provides a table 210 setting forth the execution of this process, comprising the following columns: Client 211, Message 212, and Z-Platform Core Service 213.

### User Session Authorization

As the client now has the Private Key in its possession, it can authenticate the existing user session, advancing its session to the “AUITHENTICATED” stage. Once this stage is reached, the Z-Platform Core Services consider a user properly logged in and can pass its requests to the ZP-Application Servicing infrastructure. FIG. 12 provides a table 220 setting forth the execution of this process, comprising the following columns: Client 221, Message 222, and Z-Platform Core Service 223.

### Creating a Persona Account

Persona accounts are very similar to user accounts from the Z-Platform's point of view. Creating and using persona accounts are tied to Z-Platform Applications (ZP-App) though. As persona accounts are ZP-App representations of Z-Platform users inside a ZP-App subsystem, they are mainly handled by the specific ZP-App-related services. Z-Platform Core Services are only responsible for storing the user/ZP-App/Persona associations for a given user. This is executed in an obfuscated fashion utilizing the platform's Identity Translation Service (ITS). When a ZP-App wishes to create a persona:

1. The client app authenticates the user via the Z-Platform Core Services.
2. It requests a Persona Creation Token (PCT) for the given user (ITS/SHA3 transformed reference) from the ZP-App Service.
3. ZP-App Service stores the PCT and associated ITS user identity.
4. Client invokes a new user creation process with Z-Platform Core Services.
5. Client registers the new UUID utilizing the PCT with the ZP-App Service.
6. Client sends a persona-user association request to Z-Platform Core Services with the UUIDs and PCT.
7. Z-Platform validates the request with the ZP-App Service and if the PCT/UUIDs match, it associates the persona UUID/ZP-App ID with the user.

### Logging in to a Persona Account

Persona account retrieval and initialization (login) are executed by specific ZP-App clients in order to validate with specific ZP-App services. All persona logins start with logging in to the Z-Platform as a user. From there, the client can request the associated persona identifiers (ITS) and can proceed to logging in the personas with the Z-Platform Core Services, similar to the user login process.

### Credential Recovery Procedures

Credential recovery is a deliberately complex procedure on the Z-Platform. This is to enhance the security of keeping the platform users' PII (Personally Identifiable Information) safe. If a user loses all his/her devices, forgets his/her passwords or user name, he/she is considered compromised from the system's point of view. In the current design, during the user creation process, a PIN Unlock Key (PUK) is generated for all accounts and an associated recovery RefBox is created. The PUK is then encrypted with a randomly created symmetric key and this key is deposited with the Payment Services. The resulting PUK is a long string and may be communicated to the user in various forms: QR codes or a textual representation during account creation time. If a user knows his/her user name, password and can identify himself/herself with the Payment Services (hosted by the platform holder or its payment provider partner) it is possible to find the SecBox by utilizing the PUK.

Opposite to current systems, if a user loses/forgets his/her password, Z-Platform does NOT have the ability to reset the password. It can however create a new user and in the possession of the PUK, it can restore references that enable the retrieval of the user's encrypted private key. With “opt-out recovery” accounts, no PUK is generated, thus recovery becomes impossible. This is clearly communicated to the users and is perceived as an enhanced security offering.

If during the setup a recovery email account was associated with the Z-Platform user account, it will aid in the recovery procedures. If a verification email was also associated with the user account, it will be utilized for 2 or 3-factor authentications. The low-level details of the correct design are currently in progress.

Finding the Reference Box based on PUK and username/password combination is as follows:

1. User acquires the PUK and decrypts it via the symmetric key provided by the Payment Services.
2. User enters the unlocking secrets (Name, Password).
3. Device computes parameters from unlocking secrets: SEC1, SEC2, LOC, but instead of using “Device” it uses the PUK.
4. From here, content retrieval from the Security Boxes follow the standard process described in The Retrieval Process for AIM.

### Stored Records and Access Mechanism

The storage of user and persona information are distributed amongst various places in the Z-Platform ecosystem, as discussed elsewhere herein. As mentioned earlier, the user accounts that Z-Platform's Core Services can provide store very limited amounts of information, mostly transformed references to other access-controlled information such as Real-World Person References (to store the user's real name, pictures, and other personally identifiable information). Payment Credentials, Platform Preferences (language, payment preferences, Do-Not-Disturb settings). Z-Platform Core Services also store with the platform user accounts an ITS transformed Persona UUID list for every authorized ZP-App and an associated access matrix which describes which ZP-App may have access to which parts of the stored information.

During the registration of new ZP-App services, the developing entity submits their proposed Information Access Matrix (IAM) for approval, which—after an evaluation process—may get granted and registered with Z-Platform Core Services. If an approved and released ZP-App attempts to gain access to a service or data outside its approved IAM (coarse-level access domain), the ZP-App immediately gets flagged, reported, and its clients are redirected to designated honeypots until the investigation is concluded with either a new client software release or an approved modified IAM. Application access to user sensitive information does not stop here however, if user fields are marked with individual IAM entries in the user database, the appropriate checks are executed again (fine-level access domain) and access either is granted or denied.

The Information Access Matrix contains access patterns for all fields inside the Core Services-handled data store in a dual fashion:

1. All fields (first name, last name, address, emails, approvals, opt-ins, etc) contain a linked access list in the form of [APPID:R/W].
2. All ZP-Apps have their registered IAMs stored in the approved application repository in the form of [R:FN,LN,ADDR, . . . ] and [W:EMAIL,APPR, . . . ]
It is important to note that field names are not literal references to the actual field descriptors, rather they use a short form validated SHA3-224 hash created from the field reference names. This not only serves as an acceleration method but also introduces another layer of transformation to the application access matrix.
“First Name”=9a4b20a2 (CRC32(SHA3-224(“First Name”)));
“Last Name”=e96049a8;
“Address-ZIP”=580e2f6;
“Email”=d53c1596; etc.

### Z-Platform Application Accounts

Z-Platform provides a walled garden approach for other services and offerings built on top of it. All Z-Platform Applications (ZP-Apps) have to be authorized by the operating entity before they can use the platform services. When a ZP-App client connects to the Z-Platform, it first establishes a device tunnel as described in the previous chapters, than identifies itself with its ZP-App ID as a first filter mechanism. If the ZP-App client can prove application identity, it can proceed to user authentication. Once a user is authenticated with the platform, it is considered privileged to use the other services provided inside the ecosystem. A ZP-App in development is Zeitmarket. It utilizes Z-Platform's user and persona management core services and the provided platform modules. The platform is open for other third-party applications. The detailed process for approved vendors and ZP-Applications to set up a platform service is discussed in the descriptions below of Z-Platform Application Gateway Services.

If a Z-Platform Application is physically hosted within the Z-Platform Infrastructure (as the Zeitmarket Application is), a relay mechanism is provided where the client transactions are directed at Z-Platform entry points, through which they are then routed to the ZP-App hosting infrastructure after basic verifications. This mechanism provides increased security through providing co-hosted services with IP/Certificate underpinnings and simplifies the process described in the Application Gateway Services section.

### Identity Translation Service (ITS)

One of the ways Z-Platform guarantees the protection of PII (Personally Identifiable Information) is through its mechanism of providing application-dependent ID translation services. ZP-Apps (application systems running inside the Z-Platform Ecosystem) refer to Z-Platform users via ZP-App domain IDs once proper access has been granted (Z-Platform login process applies to both user accounts and the used ZP-App account). The IDs are then used to contact other users, and they are stored in the ZP-App-specific contact lists. These IDs however do not directly refer to the original Z-Platform users, nor can they be found in the Z-Platform stored databases.

This level of abstraction protects against matching ZP-App IDs to Z-Platform users (real people) in case a ZP-App (or even if the Z-Platform) databases are compromised. There is no information leakage between the ZP-App and the Z-Platform user identifications, nor between different ZP-App domains.

In a concrete example, if two users (say #1 and #2) correspond with each other excessively in a given ZP-App, and #2 and #3 in another ZP-App, a third party may infer that #2 is a “bridge entity”. However, due to the Z-Platform-provided ITS, this would not only be incorrect, but the third party may not even know who the actual users are even if they get a hold of (and manage to decrypt) the Z-Platform user databases.

The ITS-related translation mechanism is a combination of database lookups and mathematical formulas. The first parameter in the ITS HMAC algorithm comes from a distributed ZP-App domain key-pair database, the second parameter is the result of a one-way HMAC operation on the Z-Platform unique ID using ZP-App domain parameters:
ZP-App_ID=HMAC(SHA2-512, Z-P_ID_ITS_lookup(Z-P_ID),
(HMAC(SHA3-512,Z-P_ID, SHA2-512(Z-P_ZP-AppID),
((SHA3-12K(ZP-AppID)+127) & 0x3FF))),
((SHA2-128(Z-P_ID)+127) & 0x3FF)))

### Unified Message Delivery System (UMDS)

Z-Platform's UMDS is a centralized and precision tuned mailbox system that facilitates message exchanges among users/personas/applications. It was modeled after the standard postal services utilizing PO Boxes, in a sense that every message is interpreted as a letter or a parcel, which has the usual attributes of senders and intended recipients, but they also contain extra information in the form of “Postage Stamps” (every message is interpreted as a business transaction, whether that be standard fee-based delivery, free-shipping, collect-on-delivery or bulk mail), Certified/Registered Mail (a unique entry is created in the BI log about the timing and the route it takes), Delivery and Signature Confirmation (a message is sent back when the recipient receives or reads the message), Delivery Scheduling (when and under what circumstances the mail should be delivered, such as marketing materials) and a complex Delivery Authorization to enabled selective filtering of messages based on senders and/or messaging patterns (such as simple time-based SPAM filtering or user configured rules).

Different from email systems, the actual message is not stored within mailboxes, but in a PO Box, allocated from Z-Platform's UMDS services. The allocated (“rented”) PO Box ID is stored with the User/Persona Information during User/Persona creation time. PO Boxes store small-footprint messages directly, larger ones follow the “parcel notification” approach; when a message is generated, it is tagged with the delivery information (ZP-App-ID and Per-App-Persona-ID, Delivery Parameters) while the actual message gets encrypted with a generated symmetric key, it gets a unique ID associated and is then stored within the UMDS storage facilities, utilizing a Z-Shelf or Z-Locker solution.

The key and the unique ID get added to the Delivery Parameters with a X509 v.3 encapsulation (using the public key of the addressee) guaranteeing total privacy and protection of both message and delivery notifications independently.

[Message, [MessageHash]_{SenderPrivateKey|GeneratedSymmetricKey} is deposited utilizing the UMDS storage facilities.
[MessageID, SenderID, GeneratedSymmetricKey]_{RecipientPersona'sPublicKey} is deposited in the Persona's Inbox utilizing the Core Services.

### Application Gateway Services (AGS)

The Z-Platform ecosystem provides opportunities for ZP-Application developers to access a host of services and shares similarities with other social platforms.

Z-Platform's Application Gateway Service (AGS) provides a variety of tools for developers to register, configure, market, and maintain their externally (or internally) hosted applications and makes it simple to ensure privacy and security is maintained for their Z-Platform users.

Registered third-party applications gain access to Z-Platform services and interact with its users through the Z-Platform Gateway APIs, similar to other common authentication services. These gateway services ensure that application developers access appropriate resources in accordance with Z-Platform's access policies while promoting quality experiences within the ecosystem. In the event that an application's data access requirements change, a user alters their privacy settings, or platform policies change, the Platform Application Gateway Service ensures data is exchanged only between consenting parties, utilizing amongst other mechanisms the information access matrices. These tools allow developers to focus on delivering unique application experiences and services to users, while guaranteeing simple and coherent security/privacy compliance with the platform policies.

Registered and verified third party applications (ZP-APPs) are issued their own unique identifications (ZP-APP-ID) and Signed Application Certificates. These 2 data blocks are included in the client applications and are necessary to establish connections with the Z-Platform services. Important to note is that while both the application ID and the corresponding certificate (which has the ID embedded) are stored in an obfuscated form inside the client applications, they only serve as a quick application credential verification (a form of pre-filtering mechanism) and do not guarantee access to user data by themselves.

### I. Setup

### I. Developer Account Registration

a. All third-party developers must complete enrollment for platform developer accounts, where they:
   i. Verify their identity and eligibility for Z-Platform's developer program.
   ii. Agree to the Platform Developer Policies.
   iii. Establish a payment method for platform services per developer account.
b. Once enrolled, developers may begin the registration process for new applications.
   II. Application Registration, Marketplace, Permissions requirements
a. Critical info: Application Name, Description, Category, etc.
b. Marketing assets (optional): masthead image, app images/video, body text, icon(s), etc.
c. App Privacy: Configure app as private or publicly listed.
d. App Security: Configure additional security measures (e.g. Originating IP/Subnet range)
e. User Privacy Requirements:
   i. Define user data access requirements for this app in IAM.
   ii. Define what levels of persona anonymity are supported by this app.
   iii. Users will be prompted for consent prior to installation of your platform app.
f. Receive Z-Platform Application Registration ID.
   i. Every app receives a unique identifier by which it will be identified internally.

This also initializes the Identity Translation Services.

### III. Gateway Access Tokens/Certificates

a. API access is dependent upon proper presentation of registration credentials while reserving platform resources through the Gateway API.
b. Owners may create, refresh, or revoke an app's API credentials at their discretion.

### 2. Application Users

Users may discover applications in a variety of ways: App Marketplaces (OS/Device Platform Markets/Stores), direct invites, user-to-user invites, deep linking, Z-Platform notifications, etc. All users must register for each application installation and agree to their permissions requirements before interacting.

### I. Registration, Permission Grants

a. User registration dialogs will clearly display all required permissions for accessing a Z-Platform app.

### II. Obtaining Consent

a. The consent wording informs data subjects in a transparent and easy-to-understand manner about the relevant data processing activities.
b. In order to make a clear distinction between satisfying the data privacy requirements of regulatory institutions and implications of the platform-specific privacy measures (Personas, ZP-App-specific Person IDs), the platform generates the consent form language.
c. Once a user opts in to the app's data requirements, they go through the registration process discussed earlier where a ZP-App-specific Persona gets created and associated with the Z-Platform User and this new Persona gets “registered” with the third-party ZP-App.
d. If a ZP-App changes permission requirements, or as Z-Platform privacy changes dictate, users may be required to update their consent by resubmitting the permissions approval form. To reduce the quantity of information that the user must read, the form builder also generates a list of salient changes and employs specific styles/colors to highlight revised portions of the form.
e. Users may also revoke (uninstall) registered ZP-Apps as they choose.

### III. Application-specific IDs/Personas

a. As with many facilities inside the Z-Platform, protecting a user's privacy is foremost. The ZP-App ecosystem translates global internal user/persona IDs to app-specific IDs utilizing the ITS mechanism. They do not follow an application user from app to app, and are unique to each app they join.

### 3. Gateway Reservations API

The Application Gateway Services provide endpoints for obtaining access to platform resources. There are various reservation types; however, most will fall into either of the following two categories:
1. Obtaining access to User/Persona data (which requires appropriate user-specific permission grants to be in place)
2. Obtaining access to platform services (Audio/Visual Communication Services. Payment Connector, KYC Connector Services, etc.)

To access Z-Platform data and services, third-party applications hosted outside the platform infrastructure (or in a segregated environment within the platform infrastructure) will communicate with the Application Gateway Service in order to reserve resources (reservations):

I. Obtaining Reservation for User data
a. In order to obtain data from a Z-platform user/persona profile, the reservations API will first require the persona to be registered with the third-party application making the request (server-to-server), i.e., present in the ITS database.
b. The application completes a request for user data and, provided all permissions are in place, the API returns a reservation for the user's data updates via the User and Device Management Services.
c. Reservations may also provide a specific host for handling subsequent requests on this reservation.
   II. Presenting Reservations with API requests
a. After receiving a valid reservation, the reservation must be presented to the handling API before access is granted to the data or service in question.
b. All platform services API endpoints with reservation requirements first must confirm the third-party's reservation. Expired or otherwise invalid reservations will be referred back to the Application Gateway Service API.
   This approach is very similar to and is rooted in the known OAUTH/KERBEROS-type authentication schemes, where both AS and TGS (in Kerberos terminology) are hosted by Z-Platform Core Services and the Service Server is the ZP-App server.

### 4. Consuming Reservations for Z-Platform Services (Internal)

Internally, all service endpoints are fronted by the reservations confirmation middleware agent. As this service acts as both authentication middleware and a reverse proxy, it prevents web servers from having to field resource requests from obviously unverified/invalid sources. This confirmation process will forward properly-reserved resource requests to their internal resource providers.

To create each reservation, the reservation service is consulted on:
1. The Persona's permission grants.
2. The Application's platform services registrations.
3. The Persona's platform policy consent.
4. The Persona's current standing within the platform.
   Step by step:

### I. Reservation Confirmation

a. The confirmation agent checks the reservation store of the service it represents for a valid reservation.
b. If there isn't one for the current API request, the request is logged and the appropriate error reply is made.
c. If a valid reservation exists, the agent forwards the request on to the appropriate service API.
   II. API request forwarding
a. Under the covers, the endpoint handler and API security modules perform a complex set of functions while proxying the external requests:
   i. TLS is terminated, request bodies are sanitized for delivery to downstream services.
   ii. Validated reservations are added to the request headers for possible later confirmation and potential contract association.
   iii. Successful responses are logged in aggregate and associated with active/completed reservations.

### III. Revocation and Expiry

a. Existing reservations become revoked when:
   i. The user uninstalls the associated application.
   ii. The application adds a new permission requirement.
b. Existing reservations will be valid for a specific number of seconds after being issued. Provided it can be reused for accessing the same (or sufficiently similar) data, the reservation's TTL may be extended as subsequent requests are completed.
c. Expiry times and details may be dependent upon each API's requirements and usage context.

### 5. Architectural Overview

Developer registration and all actions associated with application setup/configuration are provided by the gateway services web front-end. All reservation-related API requests are handled by the gateway services json:api. Internally, the gateway services front layer is load balanced and expandable. Each front layer app accesses:
1. Data stores of registration/configuration settings for each third-party ZP-Application.
2. Data stores of user/persona permission grants, privacy settings and their respective ZP-Application registrations.

3. Data store for current reservations (to be checked by confirmation agents later) Subsequent platform service API requests traverse nginx-type reverse proxies and middleware, which include services for confirming reservation requests. The confirmation agents have access to the data store for current reservations and quickly validate API requests prior to forwarding requests to their handlers.

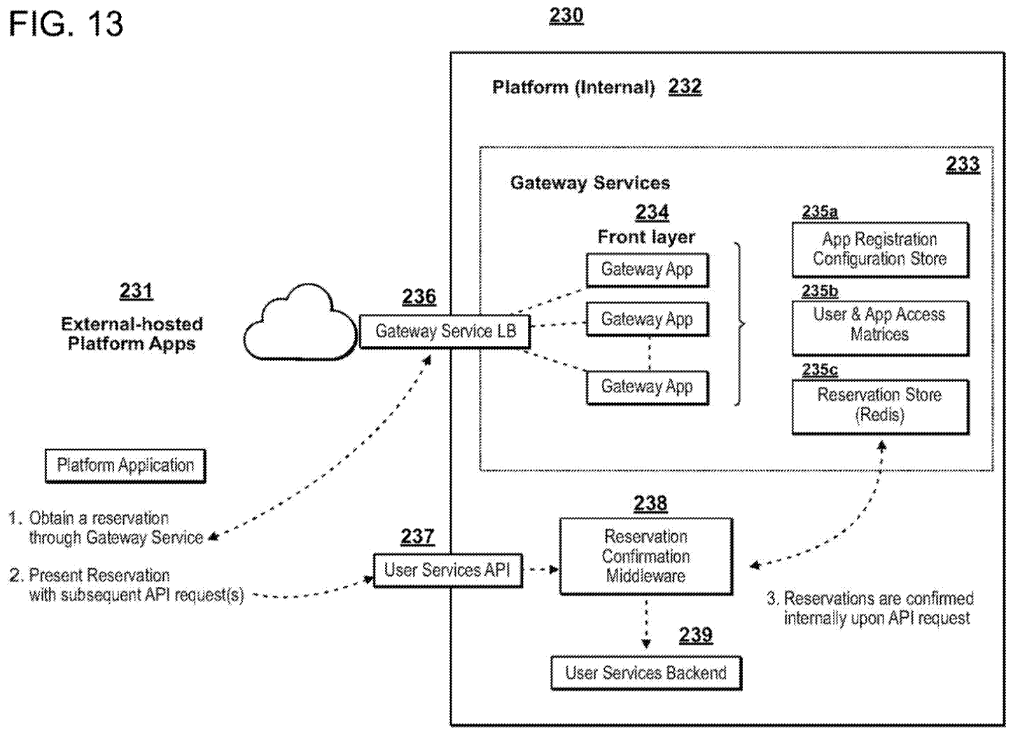

FIG. 13 is a diagram providing an overview of an exemplary system 230 according to an aspect of the invention that implements the above, depicting external-hosted platform apps 231 and an internal platform 232. The internal platform 232 includes a gateway services module 233 with a gateway app front layer 234 that accesses modules used for application setup/configuration, including: an app registration configuration store module 235a, a user and app access matrices module 235b, and a reservation store module 235c. Load balancing is provided by a gateway service load-balancing module 236. Subsequent requests are processed using a user services API module 237, a reservation confirmation middleware module 238, and a user services backend module 239.

### Z-Platform Modules

### Overview

Z-Platform Modules are logical units of services (with both back-end and front-end components) which are not considered to be part of the core services, but can provide valuable services to the Applications. These “services” are still hosted within the Platform Infrastructure and have internal secure access to the Platform Core Services while observing the ITS requirements as needed. There are six modules currently in the Ecosystem:

1. The Audio/Visual Communication Services module provides a fully featured communication service to the integrating applications. A/V sessions are handled as contracts with negotiated communication nodes and control mechanisms. Two or more users can be connected in an audio/video session, which includes adaptive bandwidth transmissions, geo-aware routing and bridged connections with all these having the ability to optimize not only for fastest delivery, but to increase routing complexity (to interfere with tracking). On top of the prioritized audio and visual channels, a custom channel is also provided, which enables file/document sharing, shared desktops and shared gestures. The stages and states of the communication sessions are closely observed and tracked (but not the content!) in order to provide immediate conflict resolution and/or contract renegotiations in case of quality problems. This feature is also essential in providing prioritizcd sessions to paying/free services. All communications are encrypted with session keys, which the participants negotiate after successful initial connection (which was encrypted with system-provided communication keys). This ensures that the Z-Platform Core Services have absolutely no access to the content of the communication. The session keys can be rotated and renegotiated on-the-fly, out-of-band as well, further strengthening the platform security services.

2. Z-Store is Z-Platform's secure off-site/on-site storage solution.

Z-Lockers are identified by reference identifiers (textual representation) and are opened/closed with passphrases (user assigned text, bitmap, sound, etc.) and PINs (system assigned). The actual location of a locker is generated from all three information sources through the combination of one-way transformations. The associated symmetric encryption key (currently 512 bits long) is also derived utilizing all three information sources, thus both finding the location and acquiring the decryption key requires proper access to all the different domain sources. Z-Shelf provides a simpler access mechanism for deposited data, similar to known “blob-store” services.

3. The Platform Management Service (PMS) module is responsible for handling device, user and application access management. This includes granting and revoking access to different actors to/from different services and is responsible for renewing/renegotiating certificates, and providing basic key management services.

4. The Application Management Service (AMS) module is responsible for ZP-App registrations and the associated account managenments. ZP-App developers utilize the interface provided by AMS for requesting changes and approvals from the Z-Platform ZP-App Account Managers.

5. The Payment Connector Services (PCS) module connects the internal accounting services of Z-Platform with third party payment gateway services. It also provides PUK decryption services in case of recovery events.

6. The Know-Your-Customer Connector Services (KYCCS) module connects the internal Real World Person (RWP) identification services of Z-Platform with a third party authorization, KYC service through the 3rd party's API infrastructure.

7. The Platform Mail Delivery Service (PMDS) module provides individualized and logically detached message delivery services within a given ZP-App, further limiting any unforeseen platform contamination and information leakage. Z-Platform's UMDS provides a global message delivery within the Z-Platform members.

### Audio/Visual Communication Service Module

Z-Platform provides its own real-time Audio/Visual services. These come in the form of “Video Sessions”, “Voice Sessions” and standard messaging services (real-time and stored, instant messaging chat type). This real-time service uses adaptive bandwidth and stream shaping techniques to guarantee acceptable communications even in low quality network environments such as cellular networks. All communications follow the client-server-client topology with parts of the messages encrypted for the platform services (these are strictly traffic and routing-related information), while an internal client-to-client encryption tunnel (with DH negotiated keys and rotating schedules) provides complete assurance of the service provider's inability to decrypt the messages flowing between the participants. Z-Platform's communication server components are comprised of a network of Communication Controllers (CommCtrl) and Communication Nodes (CommNode). The CommNodes relay media packets between clients and act as a central point of control for communication sessions. In a special bridging mode, the CommNodes may be linked together to provide better communication experience if participants have difficulties connecting to a single node. CommCtrl drives the entire communication system. It handles requests from the platform's Core Services for creating communication sessions between participants, it tracks CommNode statuses and routes sessions to optimal nodes. CommCtrl also provides central record keepings in a unique style, utilizing contracts.

### Approach for Communication Management: Contracts

Z-Platform provides its personas the ability to communicate over secured streaming sessions in real-time through its Communication Infrastructure. The process for establishing and executing communication sessions between Personas is similar to a standard contract-based approach. When a Persona contacts the Communication Service Core with the intention of starting a session with another Persona or Personas, a contract is created for defining and monitoring the service-level agreements among all platform resources involved. Beyond the basic tracking of connection quality and network/system resources, contracted sessions may underlie other billable services. These contracts allow the Communication Service Core to provide the accounting basis for premium and/or billable sessions built upon the Z-Platform.

The Communication Service Core (CommCore) is the contact entity within the Z-Platform infrastructure in charge of handling the Persona's request to connect with other Personas and organizing the necessary communication infrastructure to execute successful communication sessions. It also acts as a de facto representative of the Persona; handling accounting-related tasks, negotiating quality of services, and resolving conflicts that may arise while providing the service itself. In general, Personas only contact the Communication Service Core directly when they experience issues with the communication service.

Most of the time, the client-side routines automatically keep the CommCore apprised of communication service events, performance statistics, and connectivity issues related to the active running contract. This mechanism provides part of the required feedbacks used to evaluate service quality and contract fulfillment. Once the Communication Service Core accepts the request (user validations, presence determinations), it draws up a contract and asks the Communication Control Center (CommCtrl) to evaluate it for the requested communication session. This latter service can be interpreted as a service providing agency, which has contractors who do the work (Communication Service Nodes aka CommNodes) and it also manages the contracts, keeps a tab on the contracted work and does reporting and record keeping.

Once the Communication Control Center evaluates the needs of the clients (QoS requirements, class-of service required), it identifies the best worker (or workers, if bridging service is required) to execute the contract and contacts the candidate worker. The worker service (Communication Service Node) evaluates its current condition and either signs the contract or rejects it. If the contract is rejected, the Communication Control Center identifies another worker who is best suited to replace the previous candidate.

Contracts fulfilled by the Communication Control Center track all requests and work related to servicing a specific communication session across both client- and server-side resources. As this service is built on top of several disparate systems with perhaps-limited connectivity beyond the control of the Z-Platform, contract accounting identifies potential gaps between the system's efforts delivering the service and the Persona's experience of it.

Once a contracted session is successfully assigned to workers, the Communication Control Center returns the signed contract to the Communication Service Core for final evaluation. There is some level of autonomy in this process, but user intervention and/or agreement may need to be secured before the Communication Service Core “signs” the contract. Once the contract is accepted and signed by all parties, it gets filed under the “active contracts” folder with the Communication Service Core, a copy is furnished to the Communication Control Center and the necessary keys and locations are exchanged. Since these services are implemented on top of a range of third-party infrastructures (telecommunication 3G/4G/LTE/5G, Internet Providers, WiFi APs, smart phones, cloud services, etc.), Z-Platform's contract management provides a solution for handling conflict management that arise from the nature of combining these heterogeneous systems into a quality product experience. Clients are equipped to alert their representative (Communication Service Core) should session quality degradation or drop occur.

Conflict resolution is similar to handling real life legal contracts; if there is any type of conflict during the execution phase (or shortly after termination) of a contract (dropped calls, low-quality service), the clients may notify their representatives (Communication Service Core), which registers the complaint, looks up the contract and escalates the issue with the Communication Control Center. In return, the Communication Control Center attempts to recover session quality with the assigned worker(s) or reassign the contracted session to new workers. If no workers are able to satisfy the given contract, the contract is invalidated and the Communication Service Core is notified of the breach event.

As the Person's representative (and accountant), the Communication Service Core then remedies the situation with the session participants.

As contracts are completed, a detailed report (diagnostic information) from the Communication Service Node is stored with the contract and the decisions of the Communication Control Center are weighed against the session's reported quality and performance statistics.

Over time, historical contract data is used to inform the Communication Control Center's strategy for pairing workers (Communication Service Nodes) with clients. Using performance statistics gathered from both client and server sides to tune how the communication system distributes resources; the Communication Control Center is able to continuously improve how it provides secured real-time sessions to a multitude of users.

While the Communication Control Center provides reliable real-time sessions between platform clients, the Communication Service Core extends these capabilities to ZP-Apps to connect Z-Platform Personas. The contract process underscores the Communication Service Core's ability premium services built upon the Z-Platform.

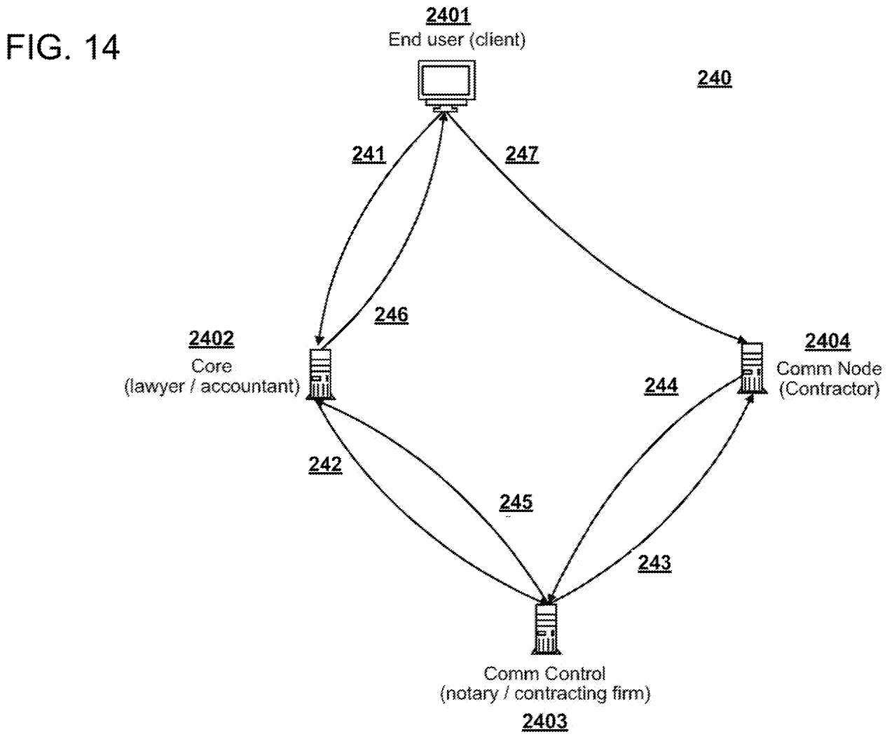

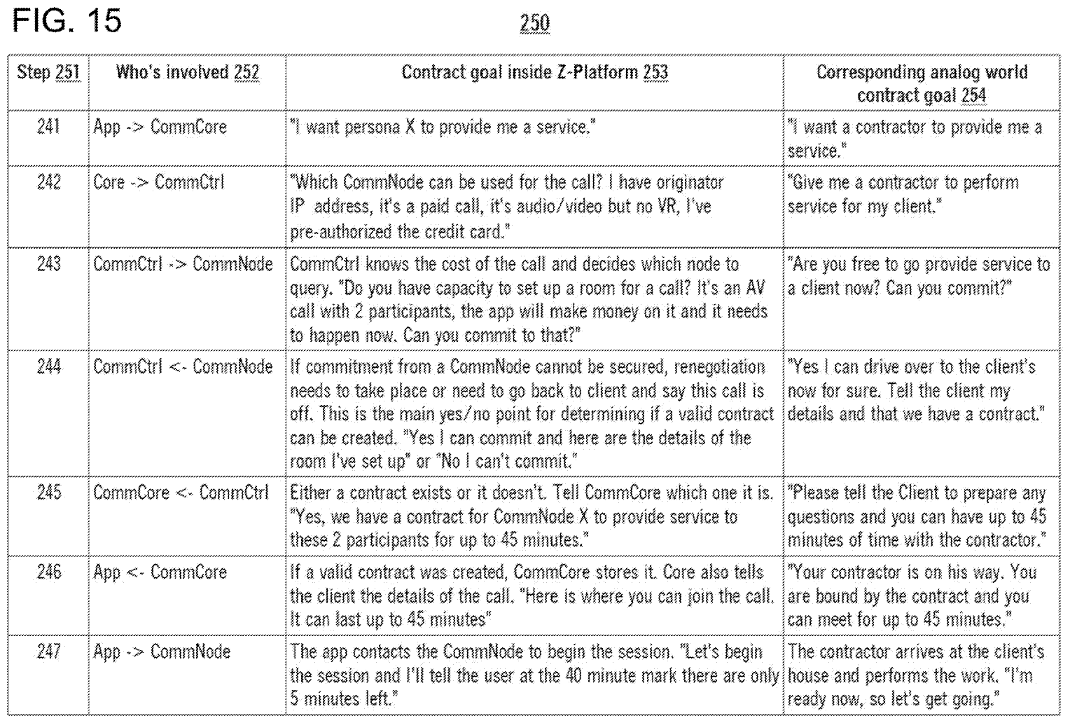

FIG. 14 is a diagram demonstrating an exemplary practice of the contract negotiation system 240, comprising end user (i.e., a client) 2401, core (i.e., a lawyer/accountant) 2402, comm control (i.e., a notary/contracting firm) 2403, and comm node (i.e., contractor) 2404, wherein arrows 241-247 represent individual steps in the data flow. FIG. 15 is a table 250, identifying for each process step (listed in column 251) the entitles involved (column 252), the contract goal inside Z-Platform (column 253), and the corresponding analog word contract goal (column 254).

### Setting up a Communication Session

1. CommClient (Persona) initiates a call request to a specific target persona from its contact list, which contains external IDs only.
2. CommClient looks up the TxID for the intended persona.
3. CommClient sends TxID communication request to CommCore using persona-encrypted channel.
4. CommCore translates TxID to TiID.
5. ConmnCore checks if TiID is online and available.
6. CommCore requests a new communication session (ZmComSession) from CommCtrl:
a. CommCore generates a new symmetric key: Kroom
b. CommCore generates a CommRequestToken (PFS) for the CommCtrl response.
c. CommCore gathers SxLD, TxID, Kroom, QoS parameters for the xID.
d. CommCore assembles the request packet.
   7. CommCtrl receives request from CommCore and sets up a session internally:
a. Generates an internal structure (CSession) and stores Kroom, CommRequestToken and xIDs.
b. Generates a crID (ContractID) and stores in CSession. This will identify this session.
c. Determines best hosting node configuration (NodeID or NodeIDs if bridging is needed) based on QoS parameters and CommNode availabilities.
d. Generates cIDs (communication ID) to each xIDs and stores it in CSession.
e. Generates ConnmControlToken (PFS) for each cID and stores it in CSession.
f. Generates a NodeRequestToken (PFS) for each target CommNode and stores it in CSession.
g. Generates a symmetric key of KCCTRL and stores it in CSession.
   8. CommCtrl requests a new session (virtual room) from the identified CommNode(s) and sends over crID, NodeRequestToken, cIDs and Kroom.
   9. CommNode allocates the virtual room (CommNodeSessionID), registers the expected participants (cIDs), crID and the Kroom. Sends back the CommNodcScssionID, ZmNodcURI and NodeRequestToken to CommCtrl.
   10. CommCtrl verifies if sent back NodeRequestToken is valid and adds CommNodeSessionID and ZmNodeURI(s) to CSession if so.
   11. CommCtrl sends respond back to CommCore using the CommRequestToken and sends back xIDs, cIDs, KCCTRL, CommControlTokens, ZmNodeURI(s), CommNodeSessionID(s) and crID.
   12. CommCore checks if CommRequestToken is valid, if so, it generates a symmetric key to be used for encrypting the initial setups, called KCONT. ConmCore then prepares packages for each CommClient containing Kroom, KCCTRL, KCONT, cID, CommControlToken, ZmNodeURI, CommNodeSessionID. These packages get encrypted in a PKCS7 format with the CommClient's public key.
   13. CommClient receives the package, decrypts with the private key. It encrypts its CommControlToken with KCCTRL, encrypts the encrypted CommControlToken and the cID with Kroom, adds CommNodeSessionID and sends it to the designated CommNode at the given ZmNodeURI: [[cID,[CommControlToken]Kcctrl]Kroom], CommNodeSessionID].
   14. CommNode identifies target session (“the room”) on CommNodeSessionID, it decrypts cID and [CommControlToken]Kcctrl using its Kroom.
   15. CommNode sends the CommNodeSessionID associated crID, CommNodeSessionID, cID and [ControlToken]Kcctrl to CommCtrl for verification.
   16. CommCtrl decrypts ControlToken with KCCTRL found for the given crID if CommNodeSessionID matches and cID is present. Checks if the ControlToken is valid for the cID. IF valid, it looks up xID for the cID. CommCtrl connects to CommCore with request to check if xID is active for the CommNodeSessionID in crID.
   17. CommCore verifies if iID (derived from xID) has an active session and verifies if the crID and CommNodeSessionID is active for the given iID. If OK, it responds back with “Client verified” to CommCtrl.
   18. If response is positive, CommCtrl responds back to CommNode as “Client Connection Approved”.
   19. CommNode enables CommClient to join the session.
   20. CommNode notifies CommCtrl that cID with [CommControlToken]Kcctrl joined the CommNodeSessionID.
   21. CommCtrd updates its CScssion to reflect the status change.
   22. CommClient uses KCONT to encrypt payloads to be forwarded to the other CommClient(s) via CommNode, as CommNode does not possess KCONT.
   23. Operation #22 above works in most cases, however, in the elevated security configuration CommClients execute a Diffie-Hellman key negotiation/exchange using the KCONT channel to establish a new session key.
   24. The new symmetric key negotiation described in Operation #23 can be executed periodically during a live session (parameters are influenced by settings) and the key-swapping/key-switch is executed and synchronized via the auxiliary stream control channels.

### Data Stored on the Participating Service Blocks

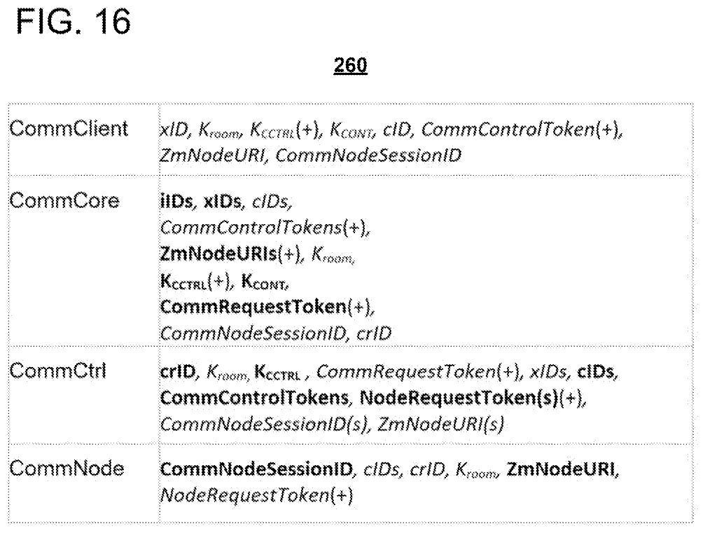

FIG. 16 is a table 260 illustrating the storage of data on participating service blocks. In FIG. 16, an italic font is used to indicate variables/parameters received and stored. A bold font is used to indicate variables/parameters generated and stored. A plus sign (+) indicates used-once variables/parameters, which get deleted after use. These variables are used to guarantee perfect forward secrecy.

### Abbreviations Used for the Communication Setup

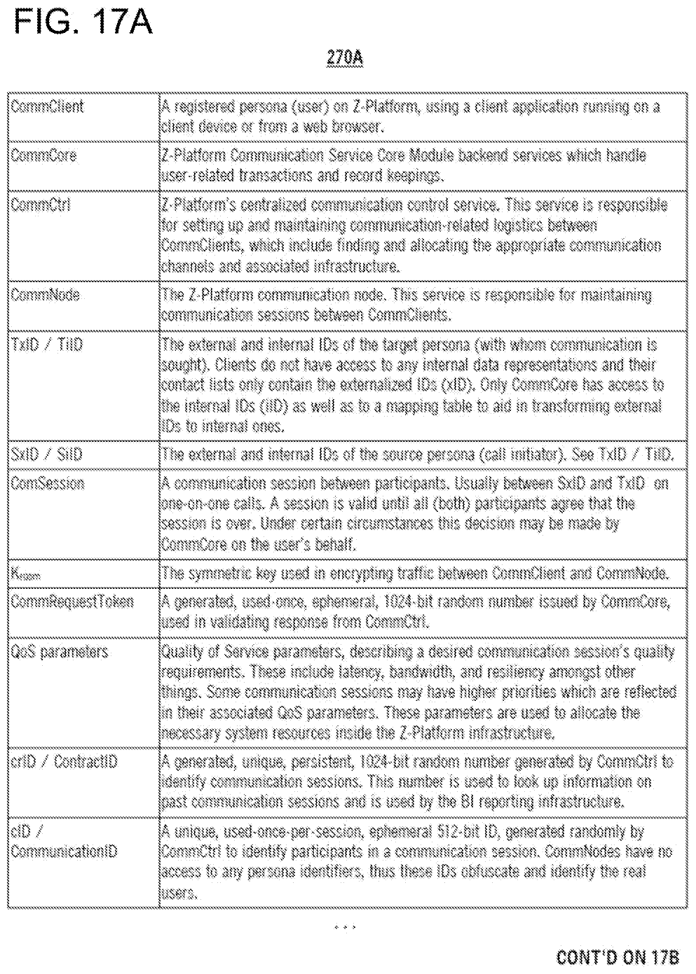

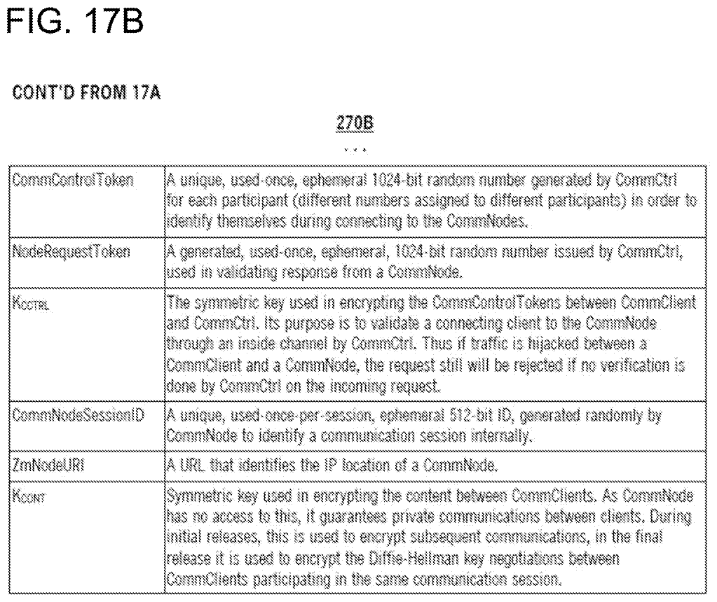

FIG. 17 is a table 270 setting forth abbreviations used for the communication setup.

### Communication Nodes

The CommNode component is a server application written in cross-platform C++ that can be deployed on Linux, MacOS or Windows based systems. CommNode instances can be deployed in regions optimal for active clients. They are relatively lightweight and because they maintain little state, require only a small amount of memory. Bandwidth consumption depends on the number of connected clients and the quantity and type of streams they publish. The primary responsibilities of the Communication Nodes are as follows:

1. Packet forwarding: a single CommNode manages multiple sessions, each with a variable number of participants. The CommNode forwards media packets from stream publishers to session participants. End-to-end encryption prevents CommNodes from accessing media content.

2. Quality of service: CommNodes provide cooperative QoS management by balancing the bandwidth usage of all active streams in a session. Streams are prioritized based on their type (e.g., audio is given higher priority over video) and CommNodes manage rate control, instructing clients to raise or lower bitrates based on network segment transmission quality. All client-node and node-client spokes have network quality tracked and measured independently to provide input to the QoS algorithm.

3. Session management: CommCtrl requests the creation of sessions with a given set of participants. The client component communicates directly with its assigned CommNode to allow a participant to join a session and this interaction in managed by the CommNode throughout the session. CommNodes report participant status (who has joined and who has left as well as other notable events) to CommCtrl, which persists relevant information.

4. Track packet reception for reliable channels: CommNodes receive acknowledgements (ACKs) from session participants for reliable media streams. These are tracked and combined at the CommNodes to reduce ACK traffic to stream publishers. From the point of view of the stream publishing client, there is just a single receiver.

5. Server locks: this feature provides a mechanism for client applications to restrict access to shared resources. Session participants can acquire these named locks with ownership status broadcast to remaining participants, greatly simplifying application logic. They can be used, for example, for a session participant to control a presentation component (e.g., pan and zoom a shared image or take control of a virtual microphone) and later release that control making it available to other participants.

Each CommNode uses a single UDP socket for most incoming and outgoing traffic. CommNodes accept TCP connections from clients to begin the session joining process, but this connection is closed once a client is accepted into the session and the remainder of the session communication takes place over UDP. CommNodes also communicate to CommCtrl over a separate connection, which utilizes ZeroMQ, a high-performance asynchronous messaging library.

### Communication Client Components

Z-Platform's Communication Client Component (CommClient) is a library that can be integrated into a larger application. Its implementation has two distinct pieces, a core component that is cross-platform and a platform-specific component that is not:

### The CommClient Core Component

The CommClient core is written in cross platform C++ and provides the majority of functionality for the CommClient component. It interfaces with the network layer and manages sending and receiving of media packets as well as communication with CommNodes.

Communication is packet-based with streams (audio, video and otherwise) segmented into packets for network transport. This allows for the flexibility to use either TCP or UDP sockets for communication with the CommNodes.

### Packet Reception

Upon packet reception, packets are demuxed into independent media streams, which are grouped according to the stream publisher participant. Packets are fed into a jitter buffer and playout queue, which reconstructs the original stream timing and determines an appropriate playout delay. The goal for most media streams is to minimize latency while still assuring the stream can be decoded without gaps. Data block transfers generally do not have the same low-latency requirement.

For audio, CommClient core utilizes the Opus codec, implemented with a cross-platform library. In addition to data compression, Opus provides forward error correction (FEC) to seamlessly cover single-packet gaps in the audio stream. For audio gaps larger than a single packet, a custom RUDP protocol is employed (described in later sections). When massive packet loss occurs, the audio playout is paused while missing packets are recovered. Once the stream resumes, packets representing silence are skipped as necessary to return playout to acceptable latency.

Silent audio frames and their corresponding video frames are treated like scene boundaries. When the audio is silent and skipped, its video is replaced by a generated transition effect that gives a receiving participant a visual hint of what transpired during the silence.

A participant with the requisite permissions can make a meeting go “on a break” for up to a configured length of time. What occurs during a break resembles what would happen if no participant made a sound for the length of it. Thus a break provides another time for a lagging stream to return playout to acceptable latency.

### Packet Transmission

CommClient's core component funnels all outgoing media packets through a send queue, which prioritizes packets as well as provides rate control for data transfers.

All outgoing media packets are sent to the client's associated CommNode via a single UDP socket (however nothing in the send queue implementation would prevent transporting over TCP in the future).

The send queue handles packetization of media data—both audio and video as well as data transfers. Packetization occurs incrementally just before a packet is sent. I.e., fragments of media data are partitioned from a larger block to fill available packet space, which allows for variable packet sizes. Z-Platform's A/V Communication packet format (further described in later sections) also allows mixing of audio, video, and generic data in a single packet. So for example, in the case of an audio frame (which may only be a few dozen bytes) other data types can fill out the packet if available. Otherwise packets will be padded to a minimum size for effective encryption and transmission.

The send queue prioritizes media data based on its type. Audio data is given priority followed by video. Data transfers, which generally don't have the same low-latency requirement, are given lower priority, unless a specific requirement is in place for prioritized data delivery. Data transfers themselves are also split further into priority levels.

### CommClient Platform-Specific Component

A smaller portion of CommClient is implemented in a platform-specific manner and provides a uniform interface to the varying device hardware and OS-specific services. The primary service used by CommClient and provided by the device's OS is the H.264 video codec.

Rate control for video is provided by the encoder, which is used in a variable bit-rate mode. Image resolution and frame rate can also be dynamically adjusted based on bandwidth and quality requirements.

CommClient currently supports the following device/OS platforms:
iOS
Android
Windows 10/UWP (desktop and Windows phone)

### Z-Platform A/V Communication Packet Format

Z-Platform's A/V Communication Services utilize a custom packet format for all communication between CommNodes and CommClients as well as several custom RUDP protocols where reliable transport is required. The Communication Services implementation includes a set of cross platform C++ classes to support this format/protocols, which is shared between client and CommNode components.

All packets exchanged between CommClicnts and CommNodes begin with a fixed length header. This header is not encrypted, but carries no personal identifiable or otherwise sensitive information. It begins with the session token, which is a randomly generated 32-bit value that allows the CommNode to route the packet. Each participant in a session gets a unique session token. Only the CommNode knows the mapping of session tokens to actual sessions so it cannot be used by a third party to determine which users are communicating with one another.

There are two main types of Communication Service packets: Control Packets and Media Packets.

### Control Packets

Used to communicate commands between CommClients and CommNodes, these packets are encrypted with the “control key,” which makes it readable by both CommNodes and CommClients.

### Media Packets

Used to carry communication content between CommClients, these packets are encrypted with the “content key”, which is only readable by CommClients in the same session. This section will not describe the rotation and DH negotiations in acquiring and scheduling key exchanges.

### Packets and Pockets

To support mixing of streams and media types within a packet, a packet is logically divided into sections referred to as “pockets”. In other words, a Communication Service media packet is comprised of one or more pockets. Control packets, which are used to exchange commands and other information between CommNodes and CommClients are not formally divided in this way (although in some cases may contain variable length lists).

Following the common header portion of a packet, media packets include a variable number of pocket headers (up to 32 pockets per packet). Pocket headers are also unencrypted, but carry no sensitive information. A typical pocket header contains:
Stream timestamp—used to reconstruct timing for playout. Timestamps are unsigned 32-bit integer values that represent ticks relative to the session clock. Currently the session clock is set to 48000 ticks per second. Modulo arithmetic is used to compare timestamps to account for wraps across the 32-bit boundary.
Stream ID—unique ID within the session that identifies the stream.
Sequence number—monotonically increasing and contiguous sequence of unsigned integers. They are 16 bits in size, but expanded to 32 bits by receivers, which track the number of wraps across the 16-bit boundary.
Pocket payload size—each pocket can have a variable sized payload.
Various bit flags—media type, priority, keyframe, etc.
   The remainder of the packet following this variable length header contains pocket payloads. The payload portion is always encrypted with the content key and is therefore not readable by CommNodes.
   All pockets are encrypted as single blocks. They are padded with a minimum of 18 random bytes, but padded with additional random bytes as necessary to meet a minimum size of 64 bytes and alignment to a 32-byte boundary.
   The video and audio contained in a given packet may, but need not, correspond to the same time interval. If they do, and if they usually arrive in order, then streaming the session may be especially efficient.

### Z-Platform A/V Communication RUDP Protocols

Z-Platform's A/V Communication Services utilize three custom RUDP protocols to provide reliability over a UDP socket connection, each customized to a particular set of needs and requirements. Note that although packet loss obviously occurs at the packet level, reliability is applied per pocket rather than per packet. In other words, if a packet is lost which contains a mixture of pockets containing both reliable and unreliable data, only the pockets marked as reliable will be recovered.

### RUDP for Commands

Immediately after a CommClient successfully joins a communication session (which takes place over a TCP connection), the CommClient switches to UDP for subsequent communication with its CommNode and closes the TCP socket. Some commands, typically ones that are cyclic in nature, do not have a reliability requirement. For example heartbeat commands are sent at regular intervals and can endure a reasonable amount of packet loss. CommClient also send regular stream reports, which describe packet loss on the CommNode to the client portion of the network segment. A lost stream report has negligible impact since a report quickly becomes stale and is updated by a subsequent report.

For commands with a reliability requirement, a custom RUDP protocol is used to guarantee delivery. This protocol is designed with the assumption that these commands carry a relatively small payload, but require timely delivery. Another assumption is that these commands are sent sparsely as opposed to a continuous stream of data.

An example of a command using this RUDP version is the command to request a video keyframe. This is sent when a video stream receiver is experiencing a gap in the packet sequence and has paused decoding to avoid the introduction of video artifacts into the image. It is imperative that the command is serviced as soon as possible to get smooth video playback.

To meet this requirement, individual command packets are ACK'd immediately upon reception rather than delaying ACKs so they can be grouped. As a result the sender can minimize the resend timeout. Since these commands rarely occur around the same time, delaying ACKs is not acceptable.
Note that commands are always exchanged between CommClients and CommNodes in either direction. A command may be sent from a client to other clients in the same session, but from the point of view of this protocol that represents two separate commands, with the CommNode relaying the command to one or more clients.

### RUDP for Generic Data Blocks

Data block transfers are used by Z-Platform's A/V Communication host applications to transfer media data other than real-time audio and/or video. An example is a shared image or document, which the application distributes to session participants around which a conversation takes place. The platform's Communication Service doesn't require knowledge of the type of data contained in the block rather it is viewed as an opaque binary block of data of some arbitrary, but specified size.

The primary requirement is to transfer the data efficiently without disturbing the audio/video portion of communication, rather than low latency. The data block may be large (several megabytes in size) and thus split into many packets. There is no requirement to maintain the order of individual packets that make up the data block.

Data block transfers are categorized into 3 priority channels, plus a 4th unreliable channel, which is also described below. The three reliable channels allow data transfers to be separated by low, medium, and high priority. An example use would be to send a large image over the low priority channel while smaller chat messages are sent on the high priority channel. In this example, the chat message is likely delivered before the image even if it is sent afterward (but before the image transfer has completed). Within a channel transfers are guaranteed to be delivered in the order they are sent.

Data block transfers are not ACK'd until the final fragment is received, at which time an ACK command is constructed that either lists packets missing, or packets received, whichever form is more compact. If the packet containing the final fragment is lost, the sender will resend it when its resend timer expires. The ACK command itself may also be lost (it is not sent using command RUDP) and will be resent each time a duplicate final fragment is received. The transfer is completed (and the sender can release the memory holding the data block) when the final ACK is received. A data receiver delivers the data block to the application layer immediately upon receipt of the final fragment (and after assembling fragments into a contiguous block) assuming all previous transfers on that channel have also been delivered. If not, Z-Platform's Communication Service holds the block until previous blocks have been completed so they can be delivered in the order they were sent.

CommNodes receive ACKs from all data-receiving participants in the session and track packet reception. After each round of ACKs is received the CommNode will combine this information into a single ACK command, which is relayed to the data sender. Thus from the sender's point of view, there is just one receiver. CommNodes can use packet reception info to filter resends to only recipients that need them.

The 4th unreliable channel allows for transfers of small (currently limited to 1 k byte) pieces of low latency data that doesn't require reliability (i.e., they are not recovered if packet loss occurs). This channel is intended for application defined control messages that, for example, provide for interactive control of a shared communication session resource, such as panning and zooming a shared image. Data transfers on this channel are given higher priority than reliable data transfers due to their low-latency requirement, but lower priority than audio or video. Although reliability is not guaranteed on this channel, the data is still delivered to the application layer in the order it was sent.

### RUDP for Audio

For effective full duplex communication, it is critical that audio streams are low-latency. At the same time, packet loss, which produces gaps in the audio stream, also disrupts communication. The Opus audio codec used by Z-Platform's A/V Communication Services provides forward error correction (FEC), which can repair small gaps in the audio stream by recovering the previous packet, which is encoded in the following packet. Because a small playout delay is required at receivers to account for jitter and out-of-order packets, the next packet in the sequence following a single missing packet is usually available without further delay. However at the same time, to reduce latency, a relatively small frame size (currently 1/50th of a second) is used so FEC is only able to cover a small gap. Z-Platform's A/V Communication Services use a custom RUDP protocol to recover packets and avoid gaps too large for FEC to handle. There is a requirement to maintain low latency if possible, but also avoid audible gaps. Audio RUDP attempts to balance these two goals.

The send queue buffers audio packets for resend up to a limit (currently approximately 30 seconds of audio). Strictly speaking this protocol does not guarantee 100° % delivery of all packets. If audio data becomes too old, it is no longer relevant to an interactive conversation and is dropped, unfortunately producing a gap in the stream. However audio stream receivers will pause playback if necessary up to a certain threshold in an attempt to recover missing packets. Once the stream resumes, playout will skip silent frames to return to acceptable latency. Note that some silent frames are left in place so as not to alter the structure of speech.

Unlike sparse commands, or data block transfers that don't require low latency, audio data is a continuous stream with packets arriving at a fixed rate (50 FPS). Therefore ACKs are also sent at a fixed rate (also 50 FPS). They primarily consist of the greatest received sequence number (GRSN), which is a single unsigned 32-bit integer value, and a list of out-of-order received packets (represented by their 32-bit sequence number).

ACKs also include a late time, measured in session clock ticks, which is the amount of time the GRSN+1 packet is considered late compared to a threshold. This threshold is the minimum time-to-live where packets are expected to be received and ready to be decoded so audio sample data can be presented. Note that the late time may be negative, which is often the case when packets arrive in a timely manner. In this case the late time is clamped to zero so it can be stored as an unsigned timestamp.

In a 1:1 session (i.e., a session with only two participants) it is not necessary to send ACKs if the GRSN+1 packet is not late. The audio sender will continue to store packets for resend, but discard them when the threshold limit has expired even if they have not been ACK'd. For sessions with greater than two participants, CommNodes track audio packet reception for each receiver and combine this information into a single ACK stream sent to the audio publisher. From the point of view of the publisher, there is just one receiver and one incoming ACK stream. However in this case all receivers must ACK even if their GRSN is not late in order to keep packet reception info at the comm node up-to-date and produce correct combined ACKs from the Communication Node.

When an audio publisher receives an ACK, it resends packets that are late and have not been received. If the packet indicated by the ACK command with sequence number equal to GRSN+1 is late it is the first to be resent. Subsequent packets (GRSN+2, +3, . . . ) can also be resent if they are also late and not received as indicated by their lack of presence in the ACK command's out-of-order received packet list. A subsequent packet's late time is easily calculated by subtracting the audio frame duration from the late time of the GRSN+n packet. After some number of subsequent packets that late time is less than zero and no resend is needed. Audio frames are typically small (a few dozen bytes) so a single packet is able to transport multiple resend pockets.

### The Z-Store Service Modules

Z-Locker and Z-Shelf services (collectively known as Z-Store services) are Z-Platform Modules providing personal cloud storage services with enhanced security. Z-Locker was originally modeled after the luggage lockers at public spaces (such as train stations), utilizing the same lock approach for depositing and retrieving contents. Its usage was deliberately kept simple; find empty locker (use system-provided functions to automate), deposit content (utilizing Z-Platform secure channels), lock door (activate access control), remove key (change to read only), give key to recipient. Enhanced features include key-expirations (both time and number of usage), content disposal (both time- and access pattern-based), “multiple-retrieval” option (such as in newspaper vending machines). Z-Shelf differs in its access mechanism; it is effectively a public Z-Locker with simplified controls, while retaining the time and basic allocation and retrieval functions. It is mostly used as Z-Platform's enhanced security CDN solution. Z-Locker utilizes Z-Shelf in the background to store Z-Locker contents.

### Allocation of a Z-Locker

When a request for a ZP-Locker allocation is registered, a randomly generated or a transformed user expression (PBKDF2) Location Reference Name (LRN) is computed alongside with a strengthened Content Encryption Passphrase (CEP). These 2 parameters with the set/determined allocation qualifiers (TTL, locker type) are sent to the platform module, which computes the actual Z-Locker address (location) utilizing a server generated 3 digit PIN number:
SHA3_512(CEP)=SCEP
TMPS=SCEP; PIN times TMPS=SHA2_512(TMPS); PSCEPP=TMPS;
SHA3_512 (PSCEPP)=PSCEP;
SALT=PSCEP[0 . . . 61];
ITER=(PSCEP[62]<<0.8+PSCEP[63])&0x1FFF+3579;
ZLCLP=PBKDF2_SHA2_512(LRN,SALT,ITER);
ZL_LOCATION=SHA3_512 (ZLCLP);
ZLLTOKEN=SHA3_512(PSCEP[0 . . . 31]);
   If the computed ZL_LOCATION:ZLLTOKEN is already occupied, a new PIN is generated and a new ZL_LOCATION:ZLLTOKEN pair is calculated. If all attempts fail, the ZP-PM responds with a failure and a new LRN is requested, which can either be a request for a user to change the location reference name, or a new random ID is generated. If the computed ZL_LOCATION succeeds, the ZL_LOCATION locker gets allocated in the Z-Locker infrastructure and the associated SHA3_512(ZLLTOKEN) is stored in it. The generated PIN is transmitted back (symmetrically encrypted with SHA3_512(LRN)) to the client application and is shared with the user.

### Depositing Content in a Z-Locker

Once a Z-Locker allocation succeeds, the client has in its possession LRN, CEP and PIN (symmetrically decrypted with SHA3_512(LRN)). Based on the above formulas (which were executed on the server), the client generates ZL_LOCATION and ZLLTOKEN. The client can now proceed to encrypt the content which is then transferred for storage in the Z-Locker facilities. The client generates a 62 byte SALTZLCKP, 2 byte ITERATIONZLCKP, 32 byte IVZLK (4 salt+28 IV), 64 byte ZLK_CHALLENGE and a 64 byte ZLPEK (Package Encryption Key Seed). The client then proceeds to compute the Package Symmetric Encryption Key (ZL_KEY):
SHA2_512(LRN)=SLRN;
TMPS=SLRN; PIN times TMPS=SHA3_512(TMPS); PSLRNP=TMPS;
SHA2_512(PSLRNP)=PSLRN;
SALT=PSLRN[0 . . . 61];
ITER=(PSLRN [62]<<8+PSLRN [63])&0x1FFF+3579;
PBKDF2_SHA2_512(CEP, (SALT|SALTZLCKP), (ITER|ITERATIONZLCKP))=ZLCKP;
SHA3_512(ZLCKP)=ZL_KEY;
SHA3_512_HMAC(IVZLK, SHA2_512(ZL_KEY))=HMAC(IVZLK);
SHA2_512_HMAC(ZLK_CHALLENGE, SHA2_512(ZL_KEY))=ZLK_CHALLENGE_RESPONSE;
AES_GCM(IVZLK, ZLPEK, “Z-LockerAuthenticationTag”, PAYLOAD)=[PAYLOAD]ZLPEK and AuthTag;
SHA3_512_HMAC([PAYLOAD]ZLPEK, SHA2_512(ZL_KEY))=HMAC([PAYLOAD]ZLPEK);
AES_512(ZLPEK, ZL_KEY)=[ZLPEK]ZL_KEY;
   The client now assembles a Locker Content Deposit Request (LCDR) which contains:
SALTZLCKP,
ITERATIONZLCKP,
IVZLK,
HMAC(IVZLK).
ZLK_CHALLENGE,
ZLK_CHALLENGE_RESPONSE,
HMAC([PAYLOAD]ZLPEK),
AuthTag,
[ZLPEK]ZL_KEY,
and the encrypted content payload ([PAYLOAD]ZLPEK).
   This LCDR is sent to the Z-Locker infrastructure with the locally computed ZL_LOCATION:ZLLTOKEN pairs. The receiving platform module server checks if the ZL_LOCATION is allocated by the user/persona and if the ZLLTOKEN is the same in the referenced ZL_LOCATION. If both of these tests pass, the Data Storage is allocated (with Z-Shelf), a Z-Lockcr System Symmetric Key (ZLSSK) is generated, the content gets encrypted with it and CRC hashed (ZLSSKCRCH), gets deposited in the allocated Z-Shelf location, and the ZLSSK and Z-Shelf location is added to the LCDR content for the associated ZL_LOCATION.
   Content Retrieval from a Z-Locker

Retrieving content is a much simpler procedure. Interested parties need only to know LRN, CEP and the PIN. Just as during the allocation event, the L_LOCATION:ZLLTOKEN is computed. With these access parameter pairs, a Locker Content Retrieval Authorization Request (LCRAR) is sent over to the Z-Locker infrastructure. The corresponding server locates the locker based on the ZL_LOCATION parameter and verifies if the stored ZLLTOKEN matches the one inside the LCRAR. If there is a match, the server sends back SALTZLCKP, ITERATIONZLCKP and ZLK_CHALLENGE. Based on these, the client then computes the challenge response and sends it back for verification:
SHA2_512(LRN)=SLRN;
TMPS=SLRN; PIN times TMPS=SHA3_512(TMPS); PSLRNP=TMPS;
SHA2_512(PSLRNP)=PSLRN;
SALT=PSLRN[0 . . . 61];
ITER=(PSLRN [62]<<8+PSLRN [63]&0x1FFF+3579;
PBKDF2_SHA2_512(CEP, (SALT|SALTZLCKP), (ITER|ITERATIONZLCKP))=ZLCKP;
SHA3_512(ZLCKP)=ZL_KEY;
SHA2_512_HMAC(ZLK_CHALLENGE, SHA2_512(ZL_KEY))=ZLK_CHALLENGE_RESPONSE;
   If the challenge response matches the one stored inside the Z-Locker, the server sends down IVZLK, HMAC(IVZLK), [ZLPEK]ZL_KEY, AuthTag. HMAC([PAYLOAD]ZLPEK), and the encrypted payload ([PAYLOAD]ZLPEK) utilizing the Z-Shelf service internally. The server then registers the retrieval event, updates its records and waits for a “content downloaded” event. Once proper download of the content is verified (checksum and length verification), the records are updated and modified for the associated Z-Locker (content may be deleted upon “burnt” lockers).

Once the client is in possession of the payload, it sends a “content downloaded” event to the Z-Locker service which in return (after verifications) sends back the ZLSSK and ZLSSKCRCH encrypted with the User's Public Key. With the decrypted ZLSSK/ZLSSKCRCH, the client performs an integrity check and decrypts the payload, effectively removing the system imposed outer encryption layer. The client now proceeds to the verification of IVZLK (computes its own HMAC(IVZLK) and compares it with the received one), it decrypts ZLPEK utilizing its locally computed ZL_KEY, verifies if the computed and received HMAC([PAYLOAD]ZLPEK) values match and proceeds to decrypting the content in case of success. After the AES_GCM decryption, it verifies if the received and computed AuthTag values match. If they do, a successful content retrieval was achieved.

### Application Management Services Module

As described earlier, Z-Platform's Application Gateway Services (AGS) provide access for registered third-party applications to Z-Platform services. Application registrations, permission assignments, certifications and other account management-related tasks are handled by the Application Management Services Module. Through this service are the requests made by the ZP-App developers and approvals granted or revoked by Z-Platform's ZP-App Account Managers.

### Platform Management Service Module

The Platform Management Service module provides access to Z-Platform maintenance services for managing device registrations and associations, user and persona certifications, changing the Information Access Matrices, managing Z-Lockers and many more platform-provided services. It also provides reporting and overview on the platform's current running state.

### Payment Connector Service Module

The main purpose of the Payment Connector Service Module is to provide functionality for turning internal accounting information into real world financial transactions. On top of this core requirement, user verification is part of this process in order to fulfill a fundamental Z-Platform requirement of non-anonymity.

Exemplary embodiments include establishing local e-valets that track income/spending and are synchronized with accounting information (where free items are also tracked). Valet transactions affect real money utilizing a Hosted Card Capture approach with Payment Tokenization, where MINE Zero Inc. is a registered Services Account Holder in possession of a unique Merchant ID and the associated Security Elements. This reduces the burden of PCI DSS (Payment Card Industry Data Security Standard) and enables the platform to switch to new and emerging payment methods as required.

Utilizing a pre-registered card service of the hosting financial firm, new transactions can be performed on credit or debit cards which were used during the user registration process by passing information to the Payment Gateway Services on previous transactions, such as during registration and consequent transactions. Z-Platform uses the registration transaction (nominal fee charged or credited) as the root of the linked trust process. The process tracks payment provider dependencies (such as timing-related limits between transactions, card expirations) and stores only what is truly needed to maintain an active payment status, such as the value, type, and reference identifications to the previous transactions. Individual payments then can follow the usual Payment Authentication Request/Response path with the Access Control Servers and Payment Gateways for executing financial transactions.

### Know-Your-Customer Connector Service Module

The main purpose of the Know-Your-Customer (KYC) Connector Service Module is to establish and verify real world entities (real persons) utilizing known third-party KYC services. When the need arises for Z-Platform to verify real identities, an Authorization Code Grant process is initiated on the client app. A separate screen is invoked on the user's device (in order to avoid violation of trust boundaries) to establish the KYC link. The third party's authorization service checks whether the customer is valid utilizing their own login mechanism (usually through an account identifier—such as an FKN or user name—and PIN combination) and the authorization code will be handed over to the Z-Platform response handler. Important to mention, that the app also informs the platform about the invoked process and hands over the same unique identification (also known as state parameter to avoid CSRF attacks) as it was handed over to the third party's authorization service. Z-Platform then verifies the return state and exchanges the received code to an access token. This access token (bearer access token) is then used for accessing the user's information such as his/her Name, Date of Birth or Address utilizing the third party's APIs.

### Platform Mail Delivery Service Module

Individual ZP-App Servers may have their own message delivery services which restrict their usage within the given ZP-Application. While this may adhere to tighter security requirements, it also can increase development time and requires constant maintenance of the service. Instead of requiring individual ZP-App Inbox developments, Z-Platform may provide message delivery for ZP-Applications by utilizing the Platform Mail Delivery Service Module for setting up message deliveries while utilizing the earlier discussed Unified Message Delivery System for handling the actual delivery process of messages. Per UMDS, messages are created with envelope information containing addressee (ZP-App-ID and ZP-App-Persona-ID) and may contain delivery requirements (delivery time, delivery charges). UMDS only acts as a delivery service, while the PMDS Module is responsible for proper target setups (addressee) and delivery requirement definitions, verifications and executions (paid messages need to be registered with the accounting services).

### Developing Client Applications for the Z-Platform

On top of providing the Z-Platform's Server-side services and detailed descriptions of offered services, client sample codes for utilizing the platform services for iOS and Android are also provided. All security transforms and core processes are implemented in C and are also available as libraries. Transactive communications are executed utilizing Protocol Buffers taking advantage of its robust serialization and deserialization features. Detailed description on its usage and organization is provided elsewhere herein. The Z-Platform Client SDK contains all necessary APIs to initiate platform requests and handle platform responses while providing the necessary security functionality.

### Addressing Secure Data Retention Compliance

Since Z-Platform is inherently secure, Z-Platform operators do not have the ability to decipher exchanged messages between platform users. While this feature is at the platform's core and is an uncompromisable offering, certain scenarios may require the ability for authorized operators (such as in the Enterprise Edition) to be able to decipher and record exchanged messages between predefined users in order to comply with government mandated retention policies. As the platform servers have no ability to decipher the messages, enabling this feature requires client application modifications. In an observed environment, where a third party requires full access to the transcripts of selected communications, the developed application (ZPApp) is registered with a “Data Retention Required” flag with the Z-Platform's Application Gateway Service and during use, a dedicated channel is opened to a predefined data collection Z-Platform entity; the Data Retention Entity (DRE). This does not affect normal behavior of the base application; it only increases the outgoing bandwidth by a small factor. When users log in from their devices. Z-Platform recognizes that the connecting application is marked as “Data Retention Required” (DRR) and fetches data collection rules for the given user. It also marks that connection has been established and registers the activity and its timestamp with Z-Platform's BI infrastructure. This is an important feature which gets later cross-checked with the DRE logs. As the application running on the device has the DRR marker encoded in it, it will establish an immediate connection with the dedicated DRE on Z-Platform. This DRE can either be a universal recording entity (same DRE ‘user’ for all connecting platform users) or can be independently assigned to each user (DRE IDs have a hashed ZPAppID and ZPUserID combinations included).

It is important to note that the application connects to the same servers as it would do for its usual operations, to mitigate selective endpoint filtering. The DRE entity running on the platform then marks the connection event in both its own BI data collection facilities and in the user's BI utilizing the platform's Core BI Services. This marks in the Z-Platform's BI records that a successful DRE connection was established. Subsequent recorded events (such as conversations with other users required by company policies) are then collected on the client, compressed and secure packaged the same way as normal user-to-user communications do. Effectively, the overhead is very low, the messages are just sent to 2 users; one being the original target the second one the DRE. Important also to note, that hashes of the original texts are also sent, which get registered with Z-Platform's BI in case of DRR flagged activities. This feature enables a deeper level of cross-referencing message integrity between DRE services and Z-Platform's standard BI. Once the DRE receives a copy of the transmitted message(s), it decrypts it then computes the hash and may either immediately cross-reference its own hash with the original Z-Platform BI hash (immediate integrity check for real-time verifications) or simply store it for later integrity checks. Z-Platform DREs can either store the re-encrypted data logs with Z-Platform, or—preferably—utilize their own compliant, external data collection and storage services. Connection between Z-Platform DREs and their data collection services can be established and maintained by industry standard approaches, such as dedicated VPN lines or other form of end-point protection facilities. If data access is required at a later date, the DRE's data store has all the necessary information which can be verified against Z-Platform's BI for integrity via the message hashes and timestamps, unless real-time verification took place.

### PART 3: TECHNICAL IMPLEMENTATION

The purpose of Part 3 is to provide a design overview and describe the architectural implementation of the Z-Platform from an infrastructure and technologies perspective.

This section addresses the systems and concepts that support the design of the platform services in detail. The platform design is discussed elsewhere herein. The design goals of the current implementation are a function of all the past accumulated experiences enabling similar production environments in the past and recognition of the limitations to predict all challenges that lie ahead for both deploying and maintaining Z-Platform in a high-availability and highly scalable manner.

Part 3 is organized into the follow sections:

Z-Platform Conceptual Overview
Technologies/Methodologies
Stack Primitives and Scaling Principles
Load Balancing
Front Layer Stack Components

Z-Platform Core Services Implementation Details
Device Registration
User/Persona Account Services
Identity Translation Service (ITS)
Unified Message Delivery System (UMDS)
   Application Gateway Services (AGS) and the Application Management Services (AMS) Module
The Z-Locker and Z-Shelf Service Module

Audio/Visual Communication Service Module

### Z-Platform Conceptual Overview

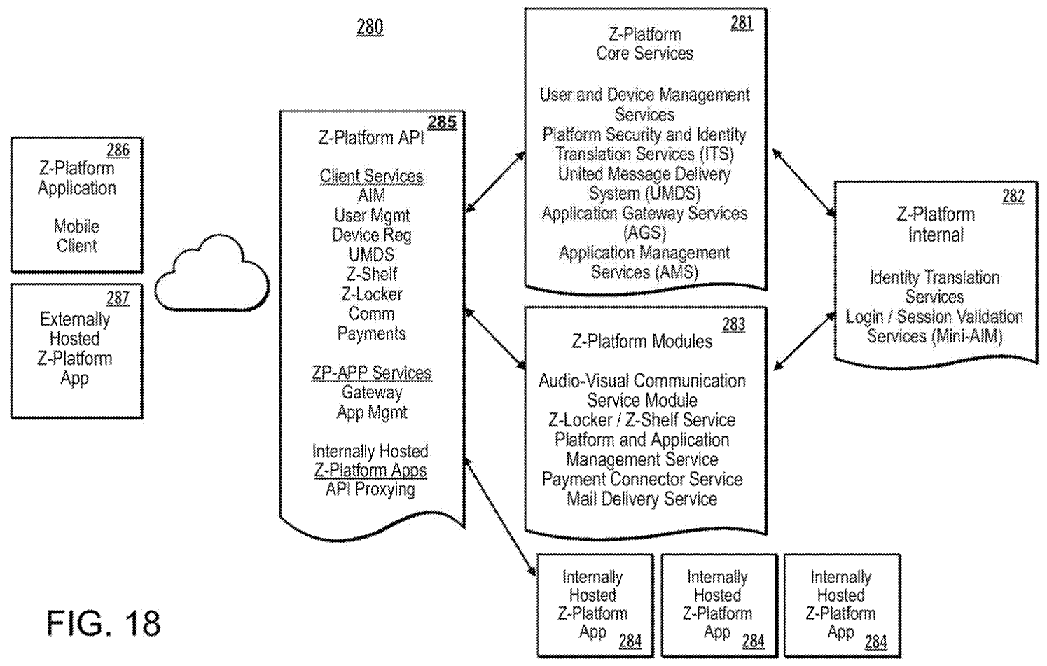

FIG. 18 is a diagram of a Z-Platform Services Component Model 280.

As discussed in greater detail elsewhere herein, the Z-Platform services are logically separated into three major offering categories:
Z-Platform Core Services 281 (and Internal Core Services 282)
Z-Platform Modules 283
Z-Platform Applications 284

The underlying support structures for these platform features can be generally divided into three basic access patterns:
Core Services 281 and Platform Module 283 features, provided via Public API 285
Internally hosted Z-Platform Apps 284, proxied via Public API 285
Internal Z-Platform Services 282, which have no externally-accessible API

Subsequent sections cover each and its related infrastructural elements in greater detail. The conceptual model of platform features and their relationships to one another is that of a unified externally-available API 285 which load-balances and proxies the various infrastructural pieces that make up the platform architecture behind it.

Note that the Z-Platform Public API represents a unified destination for accessing Z-Platform features across the range of core services, platform modules, and internally hosted Z-Platform apps. These API offerings are generally consumed by Z-Platform client libraries 286 and externally-hosted Z-Platform apps 287.

### Technologies/Methodologies

Z-Platform's development methods emphasize quick prototyping and development agility, while keeping an experienced eye toward future scaling and potential regulatory compliance needs. The stack choices reflect the collective background launching, monitoring, scaling and optimizing high-concurrency production web services, data persistence and mobile properties.

As much of the Z-Platform feature set is comprised of both providing traditional web-scale service APIs and crypto-forward security products, the majority of the platform backend code divides responsibilities between a couple of development paradigms:

1. Dynamic language-based web frameworks field boilerplate HTTP request/response handling, business logic, object-relational mapping, offline queuing, etc.

2. Compiled libraries support performant, compute-heavy operations where interpreted code is less-than-appropriate: crypto, hashing, serialization, deserialization, etc.

(The platform's Ruby-based application code is designed to run atop the JVM via JRuby; a high performance, stable, fully threaded Java implementation of the Ruby programming language with full two-way access between Java and the Ruby code. Where concurrency performance matters, there are huge performance benefits to be had by graduating to JRuby and its GIL-less threading model.) Z-Platform's software development choices favor industry-standard open-source components which leave the platform's intellectual property acceptably unencumbered from a licensing standpoint, and also have widely-traversed commercial/managed-service analogues. Development tools and frameworks are chosen to enable the growth of the platform team efficiently, to allow for interoperability with a breadth of open-source standards, and scale efficiently to meet the needs of the production environment. Platform design plans also include utilizing professional solutions for mission critical systems both for final-stage developments and deployments.

As the local and/or international regulatory compliance is becoming an imperative for the supported business model, the majority of the deployed practices, controls and tech stack components are ready to meet OWASP, ISO27001, SSAE16 and ISAE3402.

### Stack Primitives and Scaling Principles

As the platform's technical approaches start from traditional web-scaling techniques, much of Z-Platform's basic infrastructure is built from common components that standardize the utilized approaches to the task of splitting popular API features out into individually-scalable services and growing the data sets as demand/traction increases.

### Load Balancing (External and Internal)

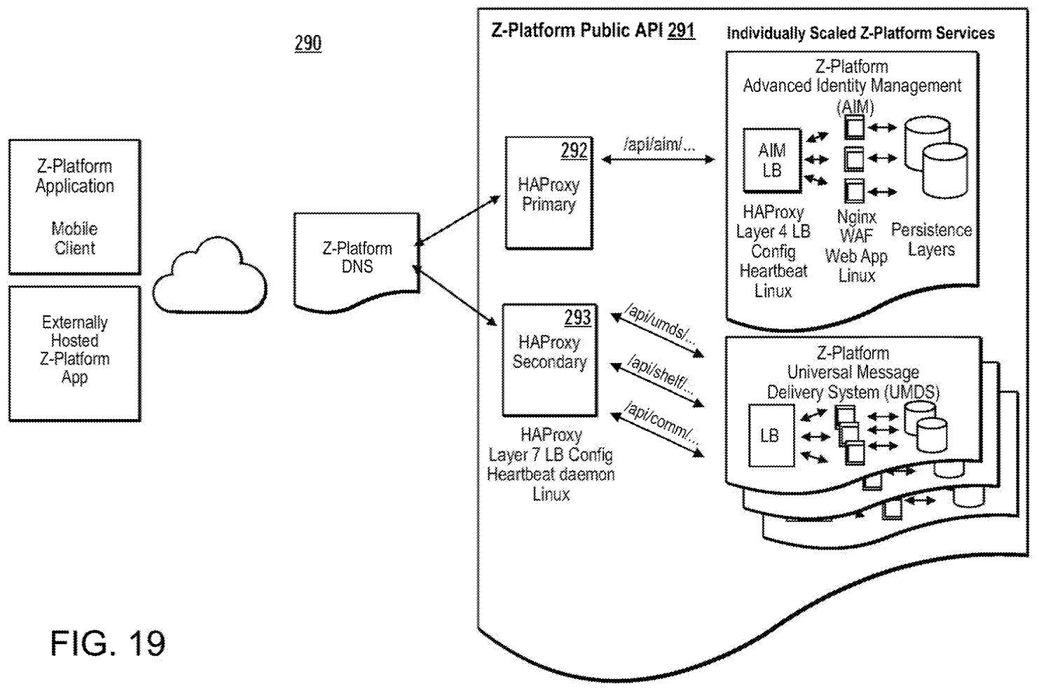

FIG. 19 is a diagram of a Z-Platform Public API Proxy/Load Balancing scheme 290 according to an aspect of the invention.

For software load balancing, Z-Platform utilizes the well-established HAProxy suite, which comes in an Enterprise Edition and in optional ALOHA Load Balancing Appliances.

For the Z-Platform Public API 291, a high-availability configuration enables routing decisions to be made based on the content of an HTTP request and then proxy requests to multiple backend services as necessary. As individual platform features/services grow (and are scaled up), HAProxy fronts the API from edge servers back to individually scaled services behind the scenes.

Using Linux cluster/heartbeat daemons between primary and secondary HAProxy boxes 292 and 293, they are configured with a shared (floating) IP to accommodate in case of a failover. As more load balancing resources are required for the Public API, DNS round-robin implementation (with health-checking) enables the scaling of the HAProxy configuration horizontally.

Behind the Public API, separate HAProxy instances are also used to load balance requests the front layer resources of individual services. Based on the results of the ongoing per-endpoint response time measurements and a workload analysis (to avoid lopsidedness), Z-Platform has the ability to change from its current basic round-robin load balancing strategy.

### Front Layer Stack Components

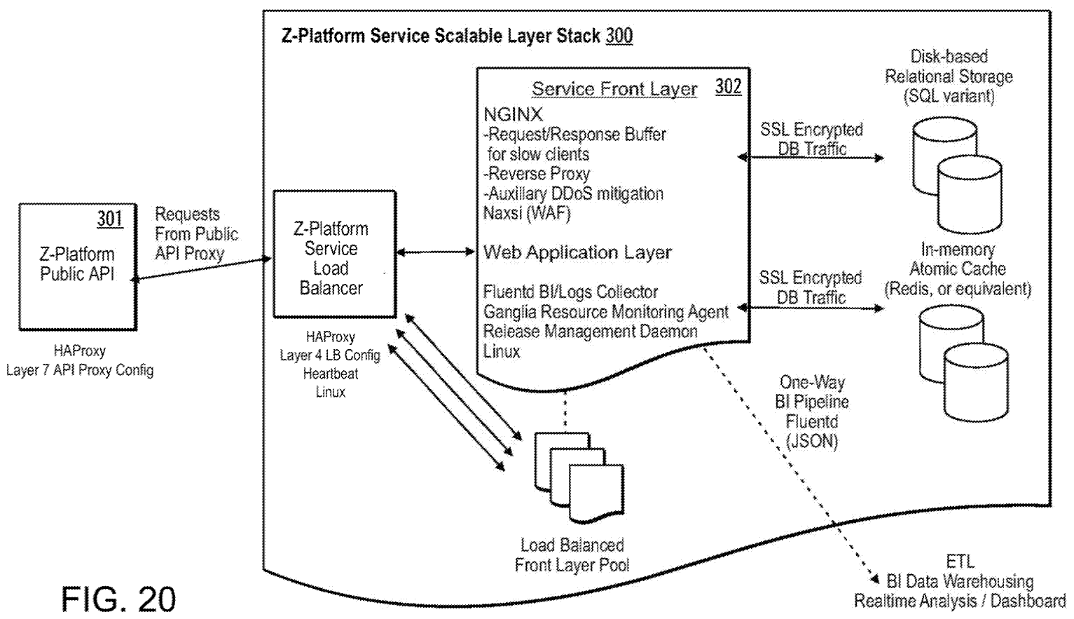

FIG. 20 is a diagram of a Z-Platform Service Front Layer Stack 300 according to an aspect of the invention.

Regardless of the framework(s), application code or data stores involved while providing various platform services, there are a few key elements common to most of Z-Platform's web application servers that help tackle performance, reliability, monitoring, and platform security tasks that fall outside traditional basic web application programming:

1. Reverse Proxy/SSL Termination

2. Web Application Firewall (WAF)

3. Application Resources

4. Limited Persistence Layer access

5. Fluentd BI/Logging data collector

6. Ganglia Monitoring agents

7. Change Management Daemon

8. Service Guarantors

In general, the majority of Z-Platform's individually-scaled platform services take a form similar to the diagram above. Web requests from external sources (Z-Platform clients and ZP-APPS hosted outside the platform ecosystem) are proxied from the public-facing API 301 to individual Z-Platform Services. Within the service stack, proxied requests arc load-balanced by HAProxy across several Front Layer servers 302 (which may be added or removed as necessary). Each Front Layer 302 server uses NGINX locally to receive and pass HTTP requests (slow client connections) to the web application via a shared Unix socket (fast client connection). Each web application generally has one or more databases (or similar persistence layer) to which it must connect, and is provisioned with SSL certificates to do so over encrypted channels. In order to optimize usage of individual server resources, the Front Layer stack includes a master process that monitors and maintains a pool of workers running the service's web application code (Unicorn).

Each server is configured, initialized, deployed, and continuously monitored by Z-Platform's configuration management and automation framework (CFEngine) through an agent process (or Release Management Daemon) which periodically reports the compliance state of each system. Similarly, each server maintains an agent process for reporting its resource utilization statistics (CPU, Disk, Network, etc.) to the platform's distributed monitoring system (Ganglia).

The front layer server also provides a local buffering and delivery process for handling application log and business intelligence data (Fluentd). This service is a non-blocking one-way pipe that collects, parses, transforms, and securely delivers various types of data to the platform's analysis tools and/or data warehouses. Whenever applicable, Fluentd supports retry, failover, and local buffering to provide guaranteed delivery of logged data.

These elements make up the bulk of the platform's web stack and are explained in further in the following pages.

Reverse Proxy—In order to provide a robust, tunable solution for handling slow client connections (internet requests), NGINX (pronounced Engine-X) is utilized as a reverse-proxy for web traffic for the upstream web application resources on the platform frontend servers. NGINX receives requests, validates SSL certs, terminates SSL/TLS, interprets, buffers, and forwards requests in a time-domain-adjusted fashion to the platform API services. NGINX benefits from zero-downtime reconfigurations, restarts and failover; it is also highly configurable and performant with a diminutive resource footprint.

NGINX—Provides another line of defense against DDoS attacks with configurable options for request rate limiting, limiting the number of concurrent connections that can be opened by a single client IP address, timing out slow connections, and IP blacklisting/whitelisting. It also shields upstream platform services by allowing configurable per-service connection limits while proxying requests (in the case of the Public API).

Web Application Firewall—WAF is deployed to protect the platform's web applications (or a set of web applications) in conjunction with rules for the known-acceptable access patterns. As the majority of the Z-Platform API services run on documented URLs and abbreviated HTTP verbiage, implementing WAF rules per service are straightforward. Naxsi (NGINX Anti XSS & SQL Injection) is the Web Application Firewall currently utilized, which is developed specifically for NGINX and is recommended by the Open Web Application Security Project (OWASP).

Application Resources—Much of Z-Platform's API services run as Rack-based web apps, which is a configurable filter chain for handling HTTP requests (similar to the Java Servlet API+Servlet Filters), resource-balanced across individual servers with Unicorn, a pre-fork Rack HTTP server for fast clients and Unix.

Unicorn—Much like NGINX and IHAProxy, Unicorn provides the benefit of no-downtime reloads. It is tunable for optimizing resource usage per server and automatically manages its worker pool based upon configurable parameters like performance, memory consumption, latency, or total requests.

Long-running, expensive and/or periodic actions within the platform feature-set are easily deferrable to offline worker queues using the same application codebase through Sidekiq (an open-source background processing framework) and Redis (an in-memory data structure store frequently used as a database, atomic cache or message broker service).

Offline workers are simply a daemonized, headless copy of the same Ruby application as the API. Workers subscribe to one or more Redis queues and process deferred tasks as they become available. As workloads increase, adding additional offline workers is a simple matter of deploying additional server instances. Deferrable versions of long-running or compute-intensive methods are created with minimal extra code, and as such they employ the same rich object modeling as elsewhere within the platform codebase. Essentially, this allows Z-Platform services to achieve higher performance (mostly involving concurrency) without negatively impacting the synchronous codebase's developmental simplicity and readability.

Offline worker pools may also employ native extensions to compiled system libraries, JVM-based classes, NodeJS and other platforms thanks to a wide availability of client ports for Sidekiq. Limited Persistence Layer Access—Database access provisioning for front-layer service boxes adhere to the Open Web Application Security Project (OWASP) standards using a mixture of lowest possible user permissions, table- and database-level access restrictions commensurate with necessary application functions, and encrypted network connections.

BI/Logging Collector—Z-Platform maintains a unified data logging and analysis pipeline that begins with a Fluentd collection agent on each front layer server. The application may push logs and sanitized business intelligence (BI) data to the Fluentd agent. Fluentd is similar to other logging options like Syslogd or Apache Flume, but offers many advantages over the majority of other logging libraries. Specifically, Z-Platform uses it as a non-blocking one-way pipe that collects, parses, transforms, and securely delivers logged data. It does not lose data when a network failure occurs and offers retries, failover, and encryption of message channels.

The data is transferred to a central Fluentd agent that collects and distributes logged data to the platform data repositories (Elasticsearch for real-time analysis and Hadoop's HDFS for data warehousing). Again, the process provides non-blocking unidirectional delivery of logged data with built in fault tolerance.

This toolchain has made collecting new data points for features in application code simple and flexible. Application code may publish data into the BT pipeline for delivery to the data warehouses and/or real-time indexing system for analysis.

This model is meant to simplify security and enforcement of Z-Platform's data retention policies, while simultaneously being fault-tolerant and non-blocking to the application code. The data warehouse, analytics cluster and dashboards may all be physically segregated from Z-Platform servers and data persistence resources for a greater degree of security.

The combination of Kibana (an open-source analysis and dashboarding interface) and Elasticsearch (a Java-based open-source full-text search engine) allow Platform product and technical staff to easily search, graph, inspect, visualize and analyze the data collected from the BI pipeline to follow trends, measure performance or detect and inspect incidents.

Dashboard configuration is done entirely in the Kibana UI, without code. Once the metrics data is delivered to the BI pipeline, Kibana is used to create rich visualizations that update on the fly. BI/Data Warehousing—The bulk of Z-Platform's sanitized business intelligence and semi-structured log data is warehoused using Hadoop's HDFS, configured with the TransparentEncryption module. When transitions to other hosting providers (Azure, Amazon AWS) occur, investigations on the security and performance implications are scheduled. Using Amazon S3 as the primary data warehouse solution and combining Elastic Map Reduce with Z-Platform's current analysis tool choices (Apache HIVE) have already been specified.

Resource Monitoring Agent—Ganglia (an open-source distributed cluster monitor) logs system performance and uptime across the deployed server ecosystem. Result sets can be easily customized (though the defaults are usually sufficient for most resource monitoring needs) and are automatically centrally dashboarded.

Release Management Daemon—All tasks configured in Z-Platform's Continuous Integration/Deployment system run on Go Agents within the build and deployment ecosystem. Once tested, built and deployed, the continued compliance of all production systems is monitored and enforced by CFEngine (Z-Platform's configuration management tool).

Service Guarantors—A combination of CFEngine and Systemd provides a wealth of options for process uptime monitoring, automated notification, and restarting of essential services.

Linux—Z-Platform's production distribution of choice is CentOS, the open-source version of Red Hat Enterprise Linux (RHEL).

Production DNS—In view of the platform's potential need for advanced DNS features like Geography-aware DNS, load-balancing and latency-based routing, Amazon Route 53 is currently targeted as the production DNS solution.

CDN—A combination of Amazon S3 API proxying (for high-availability bulk storage) and Amazon Cloudfront (for low-volatility static assets) has been specified as Z-Platform's current choice for CDN.

SQL-agnostic Data Modeling—In an effort to keep the platform production environment portable between relational database choices, object-relational model usage was selected. This provides a rich language for data modeling while keeping Z-Platform technology agnostic. The application code is largely decoupled from any specific SQL-variant and leverages adapters that are used for a variety of persistence layers.

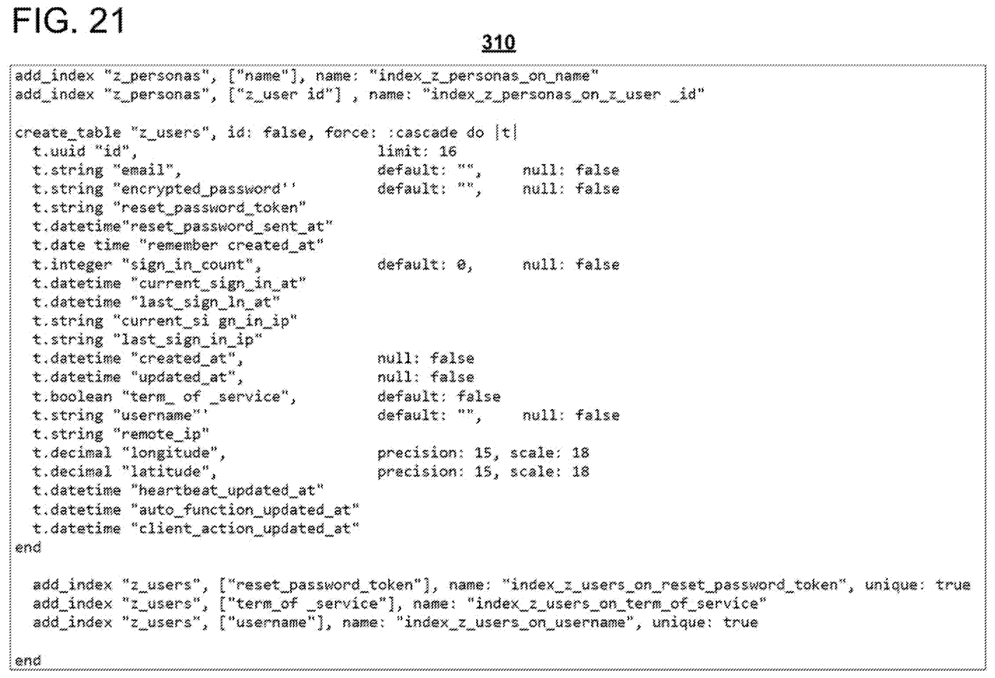

FIG. 21 is a code snippet 310 that illustrates how the platform table schemas are written in code and are portable to any SQL choice. Table attributes and indices for a wide variety of relational databases are described in this SQL-agnostic modeling layer.

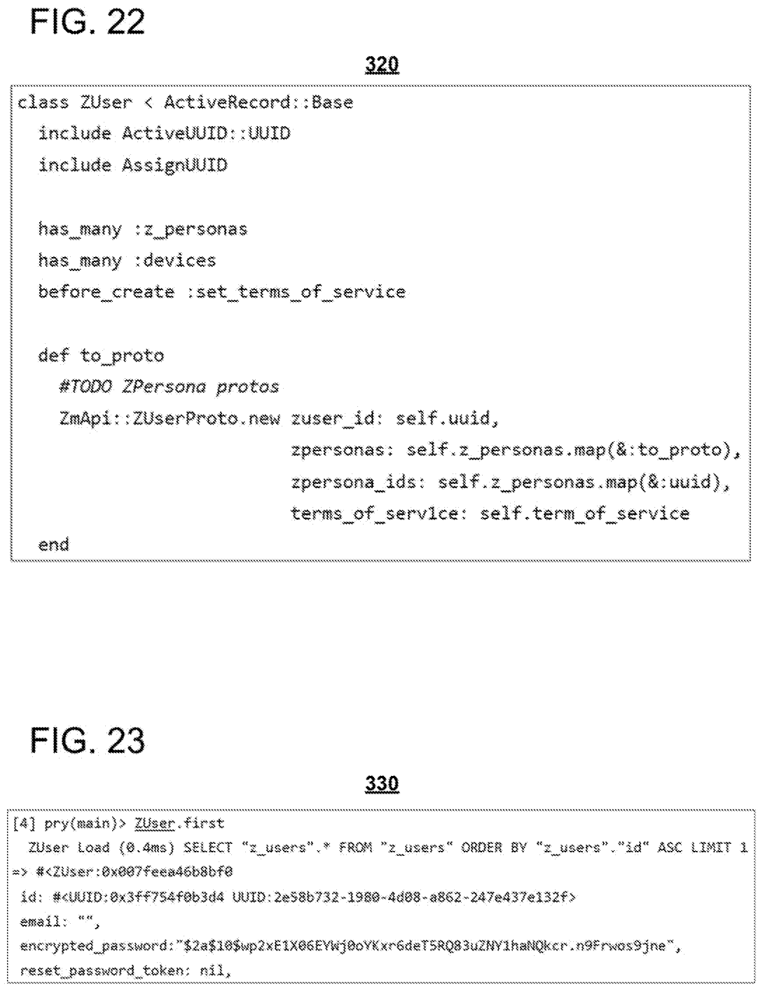

FIG. 22 is a code snippet 320 that provides a sample of how the relationships between platform data models are defined.

Instead of provisioning table schemas for a specific SQL format (like MySQL, MSSQL, or Postgres), Z-Platform development defines data models and migration files which translate to many relational databases. Instead of writing SQL queries in-line, the platform's data modeling layer compiles SQL queries from simple, expressive set of Class and instance method that match specific requirements from the relational databases (for example: “Session.where(status: IN_PROGRESS)” instead of “SELECT*FROM sessions where status=‘IN_PROGRESS’;”).

FIG. 23 is a code snippet 330 that demonstrates how calling the ZUser class methods build the SQL queries for the current SQL implementation.

This turns what could have easily been a mash up of business logic and database-specific directives, into objects that each wrap a row in a database table or view, encapsulates the database access, and adds domain logic on that data.

Cross-platform Messaging and Object Serialization/Deserialization—Google Protocol Buffers (Protobufs) are a language-neutral, platform-neutral, extensible mechanism for serializing structured data. Z-Platform uses them extensively for creating and implementing cross-platform object relationships, shared APIs and structured messaging protocols throughout the platform.

For example, Protobufs allow the platform to define the data to be exchanged between a client and server in a single, canonical location (the .proto file). That definition is then compiled into the server- and client-side libraries (Ruby, Objective-C, C++, Java), which automatically generates all the boilerplate code for handling common message tasks like serialization and deserialization, attribute getters and setters, object validators and introspection methods.

This keeps Z-Platform developers from writing (and rewriting) usually error-prone and ad-hoc message serializing/parsing code to support basic RPC models. As the platform's protocol develops over time, simple updates to the .proto file and recompilation of the libraries take place. This enables immediate interactions with the newly added features. An additional benefit is that code completion for these classes is present for IDE's that support it (like Xcode, Eclipse and Android Studio).

Having a single contract (the .proto file) also prevents platform developers from accidentally creating implicit schemas and undocumented dependencies for used RPC message formats.

Protobufs also provide backward compatibility support for mobile clients that may lag behind the latest release cycle and the wire size for Protobufs are often much smaller than competing serialization formats (like JSON).

These aspects leave more time for platform developers to focus on coding features, rather than initiating RPC and modeling code bring ups when the protocols change.

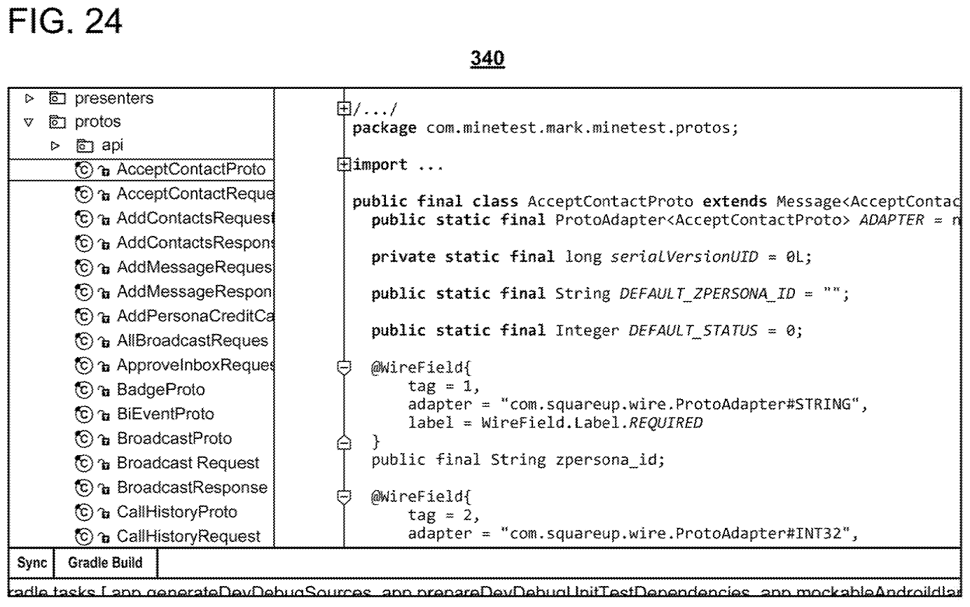

FIG. 24 is a screenshot of a Java listing 340, demonstrating how Java Protobuf classes are added to Android projects.

Protocol buffers currently support generated code in Java, Python, and C++. With the latest proto3 language version, it also works with Go, JavaNano, Ruby, and C#. Z-Platform's choice of the Protocol Buffers is rooted in emphasizing simplicity and performance. In particular, it was designed to be a smaller and faster interchange format than XML and is not encumbered by RPC references. Protocol Buffers are similar to the Apache Thrift (used by Facebook) or the Microsoft Bond protocols.

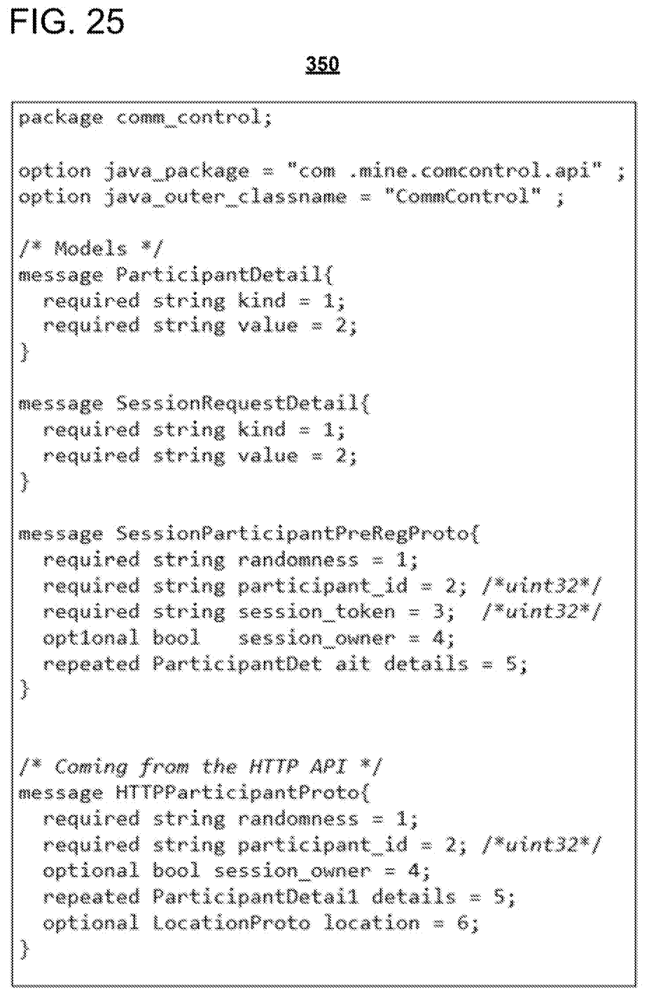

To demonstrate its usage. FIG. 25 shows a .proto file listing 350 that is an excerpt from Z-Platform's Communication Control session handlers.

This is compiled for target platforms like Ruby, Objective-C, C++, and Java. Classes and all utility methods for working with RPC messages are auto-generated by the Protobuf compiler.

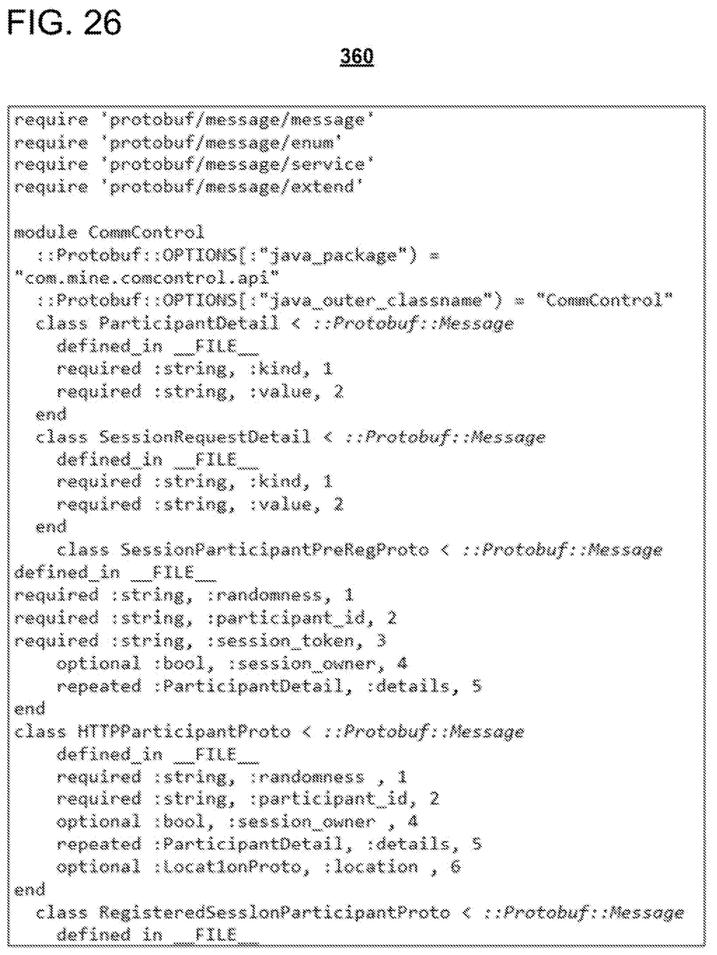

FIG. 26 is a code snippet 360 auto-generated by Ruby that is available to the server project.

### Z-Platform Core Services Implementation Details:

The Z-Platform provided Core Services offer a variety access functions to user, device, and endpoint management, which will next be discussed.

### Device Registration

The Device Registration Core Service specifically bootstraps the security relationship for all client devices. Initial provisioning of client devices is the first step every platform user takes on the way to enjoying subsequent platform services.

### Design/Service Goals

The Device Registration Service provides the required registration of user devices. Z-Platform does not depend on manufacturer/device operating platform provided identifications for several reasons. This service filters all hardware entities that will access platform services and provides an API for registering and kick-starting the necessary cryptographic services and account credentials (largely automated by client-side libraries).

As described in more detail elsewhere herein, Z-Platform clients compute their own device IDs, which are essentially 32-byte unique identifiers generated from entropy sources and their digests. Upon successful registration a signed device certificate is generated, stored, and communicated back to the device for consequent communications.

Device registration is a necessary step in joining the Z-Platform infrastructure, as clients are required to satisfy the platform's 2-way mutual TLS authentication requirements using client-side X.509 authentications. Upon a client establishing a TLS connection, the presented client certificate is checked for validity (verifying if it was signed by Z-Platform's Client SubCA—discussed in greater detail elsewhere herein) and if the certificate has been black-listed or not. The black-list is maintained by automated scripting which updates the list file and refreshes the TLS terminator's associated links.

### Technology Stack Overview

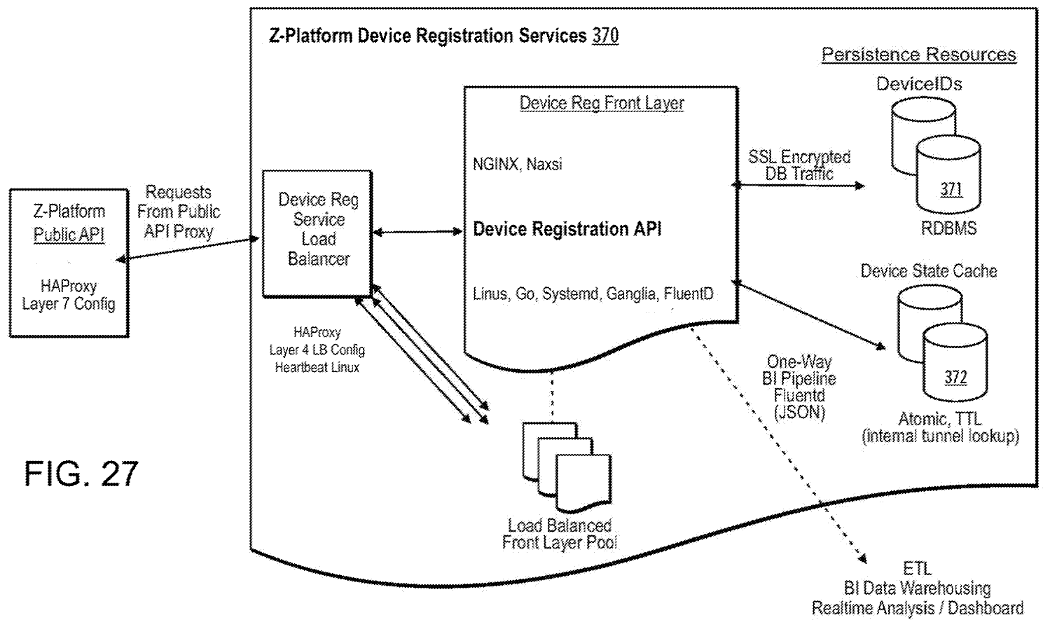

FIG. 27 is a diagram of an exemplary technology stack 370 for a Z-Platform Device Registration Services module according to an aspect of the invention.

Apart from the Z-Platform hallmark load-balanced web stack for platform services (described in greater detail in the “Stack Primitives and Scaling Principles” section), this service features disk-based row stores to store the Device IDs and their associated registration/usage information. The data is used when a user logs in to verify device-user associations and established standard usage patterns.

The two storage components are:

1. Device IDs storage 371
2. Device State Cache (with TTL) 372

As the device registration process may take several round-trips to complete, an atomic in-memory cache (utilizing Redis, according to the platform's current implementation initiative) facilitates centralized state management for all front-layer API servers.

### User/Persona Account Services

User and Persona accounts are at the core of Z-Platform's value offering. User accounts have real people with real identities directly associated with them, while persona accounts are different representations of and are rooted in the user accounts. Personas are customized user representations with the purpose of identity protection and ZP-App domain-specific expansions. In order to minimize possible information leakage between the different application domains, and to provide maximum resilience against both logical and physical attacks, all stored information is segregated into several chunks with different security domains and rules. Persona information is stored independently (both logically and physically) from the User Accounts and there is no direct link going from Personas to the User. The association and logical linking is done by using Z-Platform's Identity Translation Services (ITS) for which identity seeds are also stored separately. Virtual Entity Preferences (VEP—stores Persona preferences) and Real World Personal Information (RWPI—stores links to the physical world, such as payment and know-your-customer references) are also stored and managed separately, increasing the system's resistance against malicious attacks. The goal was to spread the information domains as far as possible, while maintaining a high-performance and scalable system.

While the distinction between Users and Personas is a valuable feature of the Z-Platform, the difference between the two in regards of authentication and authorization is minor. From the security perspective, User/Persona sessions introduce a secondary encryption layer, also referred to as The Inner Tunnel. Users' identities are represented by certificates and their associated secret keys which are stored and retrieved via Z-Platform's Advanced Identity Management (AIM) mechanism utilizing Reference Boxes (REF) and Secure Boxes (SEC).

### Design/Service Goals

As discussed above the main design and service goals for the user and persona account services are the physical separation and access restrictions for the stored information while maintaining a responsive and flexible system.

### Technology Stack Overview

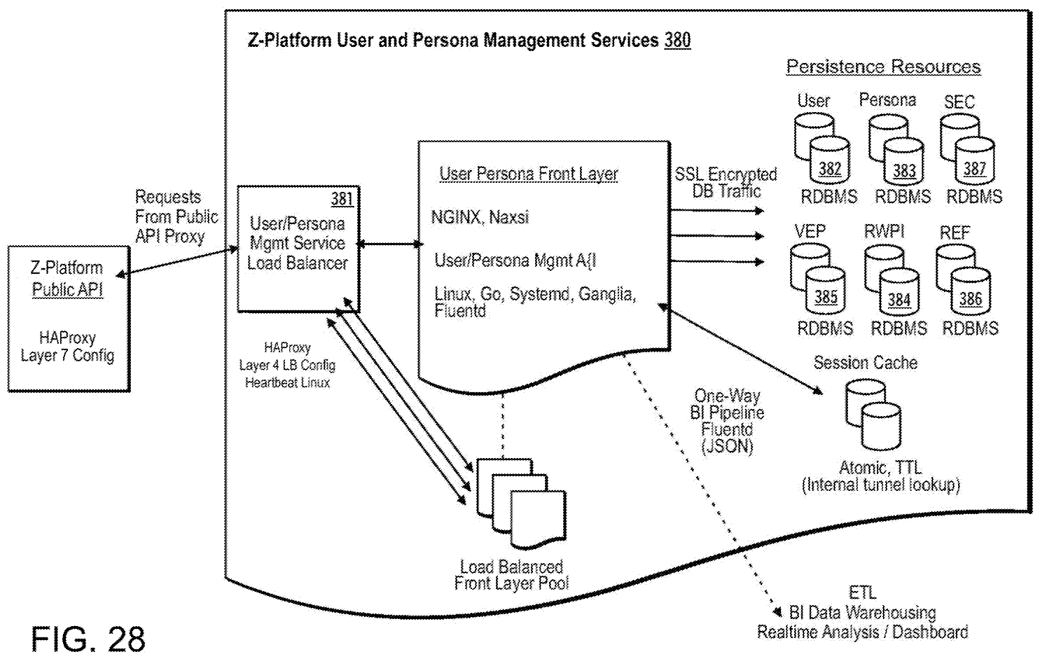

FIG. 28 is a diagram of an exemplary technology stack 380 for a Z-Platform User and Persona Management Services module according to an aspect of the invention.

The implementation of the user and persona account/management services are similar to other basic web services behind a load balancer 381. Establishing valid sessions start with the AIM process (utilizing REP and SEC) and consequent user/persona data manipulation takes advantage of the AIM session validation module.

All messages and transactions require valid user/persona sessions in order to successfully decrypt the inner tunnel request body data.

An exemplary implementation utilizes 6 distinct row-based data stores:

### 1. User Core Entries (User) 382

### 2. Persona Core Entries (Persona) 383

### 3. Real World Personal Information (RWPI) 384

### 4. Virtual Entity Preferences (VEP) 385

### 5. Reference Box (REF) 386

### 6. Security Box (SEC) 387

Physical separation of these data sets is mandated to achieve Z-Platform's security goals. References are implemented from one database to another, but no single source connects real world personal information to user accounts or personas or their various platform preferences.

Upon completion of user/persona registration or login, a valid session (with keys for validating and decrypting subsequent API calls) will be stored in another in-memory cache with TTL governing session expiry (utilizing Redis, according to the platform's current implementation initiative).

### Identity Translation Service (ITS)

One of the ways Z-Platform guarantees the protection of Pit (Personally Identifiable Information) is through its mechanism of providing application dependent identity translation services. ZP-Apps (Z-Platform applications, platform-based independent systems running inside the Z-Platform Ecosystem) refer to Z-Platform users via ZP-App domain specific IDs once proper access has been granted. The IDs are then used to contact other users, and they are stored in the ZP-App specific contact lists. These IDs however do not directly refer to the original Z-Platform users, nor can they be found in the Z-Platform stored databases. This level of abstraction protects against matching ZP-App IDs to Z-Platform users (real people) in case a ZP-App (or even if the Z-Platform) databases are compromised. There is no information leakage between the ZP-App and the Z-Platform user identifications, nor between different ZP-App domains. Detailed description on the used process and algorithms can be found in the TDD.

### Design/Service Goals

In order to satisfy the security requirements for ITS, the implementation called for strictly internal-facing service APIs. This service can only be accessed internally within the Z-Platform infrastructure and the calls are scrutinized for access locations and calling service identities.

### Technology Stack Overview

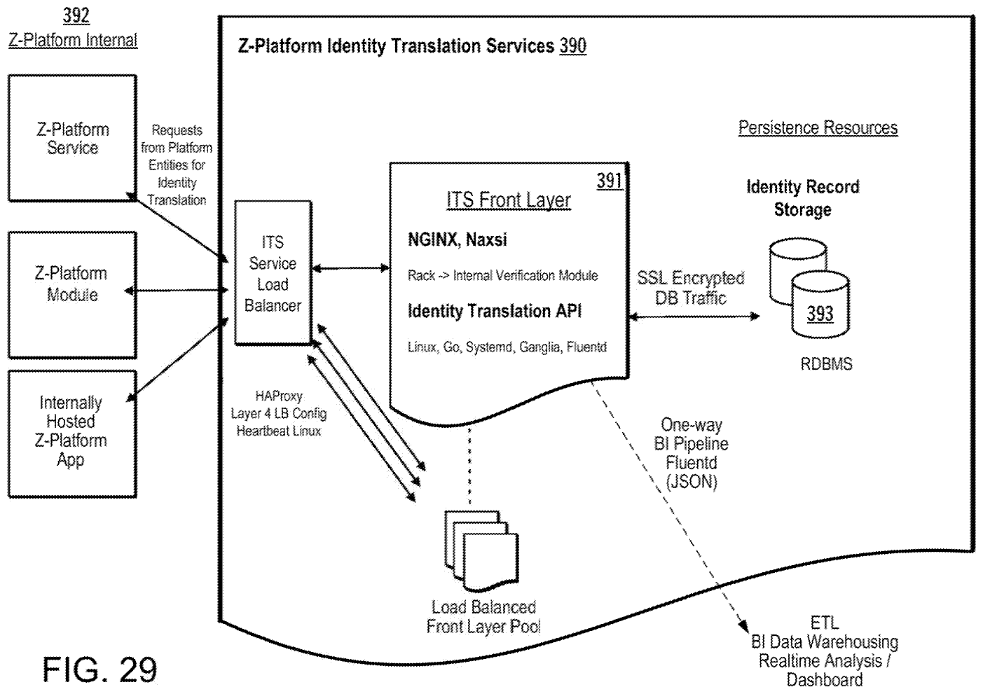

FIG. 29 is a diagram of an exemplary technology stack 390 for a Z-Platform Identity Translation Services module according to an aspect of the invention.

The front layer 391 accepts requests from strictly internal Z-Platform entities 392, so it verifies sources before working on identity translation requests. As new identities are created for a given user-app context, they are stored in the Identity Record Storage database 393. For subsequent translation requests, the mechanism for finding a given translated identity is a combination of database lookups and mathematical formulas.

### Unified Message Delivery System (UMDS)

Z-Platform's UMDS is a centralized and precision tuned mailbox system that facilitates message exchanges between users/personas/applications. In combination with the Platform Mail Delivery Service (PMDS), it provides the backbone for the platform's postal services as well.

The approach was modeled after the standard postal services utilizing PO Boxes. Different from email systems, the actual messages are not stored within user/persona mailboxes attached to the user/persona information, but in a PO Box, allocated from Z-Platform's UMDS services. The allocated (“rented”) PO Box ID is stored with the User/Persona Information during User/Persona creation time.

PO Boxes store small-footprint messages directly, larger ones follow the “parcel notification” approach; the delivered message is tagged with the delivery information (ZP-App-ID and Per-App-Persona-ID, Delivery Parameters) while the actual payload message gets encrypted with a symmetric key, has a unique ID assigned and is stored within the UMDS storage facilities, utilizing the platform's Z-Shelf solution. The key and the unique ID are added to the Delivery Parameters with a X509 v.3 encapsulation (using the public key of the addressee) guaranteeing total privacy and protection of both message and delivery notifications independently.

### Design/Service Goals

The Unified Message Delivery System (UMDS) represents a sizable challenge for scaling voluminous data associated with not only message creation, delivery, and reporting; but also the secure storage of cryptographic elements related to these messages in transit.

Similar to the Z-Shelf and Z-Locker platform services, this service is largely a logistical layer built atop the platform's underlying secure storage infrastructure (covered in greater details later). Owing to this dependency, the UMDS mostly concerns itself with basic authorization, confirmation, recording-keeping and reporting around message-related transactions. Integration with the platform's secure storage infrastructure allows UMDS to offload the remainder of the service's sizable content-handling work.

### Technology Stack Overview

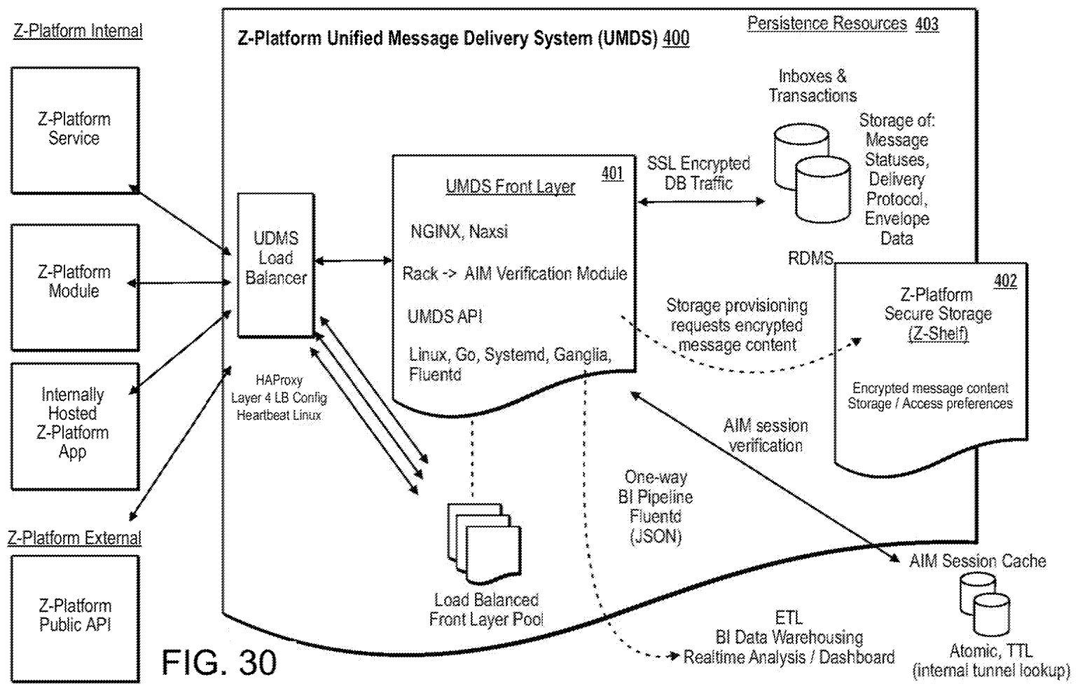

FIG. 30 is a diagram of an exemplary technology stack for a Z-Platform Unified Message Delivery System (UMDS) module 400 according to an aspect of the invention.

As in most other services, the technology stack behind this platform service looks similar to others with its load-balanced front layer resources 401. Each validates session information through the AIM's Session and Access Matrix module prior to any interaction with the UMDS API.

User and ZP-App message sending limits are handled at the Platform Mail Delivery Service (PMDS) level, where delivery requests are set up and stored assuring that appropriate rate limiting, send permissions, service restrictions, bans and recipient preferences are observed. The above diagram only describes the message delivery system and does not go into detail of the postal services. The main difference between UMDS and PMDS lies with the access controls. If the sender and the addressee has direct access links (they are in each other's contact list, or they are currently in a real-time communication session), UMDS can be utilized.

This service integrates with the underlying Z-Shelf secure storage service 402 and therefore requires persistent storage resources 403 for handling its own record-keeping. Encrypted message content is pushed off to the secure storage infrastructure (as with Z-Shelf and Z-Locker).

### Application Gateway Services (AGS) and the Application Management Services (AMS) Module

The Application Management Services Module handles ZP-App registrations, permission assignments, certifications and other account management related tasks. The Application Gateway Services enforce the established rules by providing access request handlings and reservation services for the given outside-hosted ZP-App towards platform resources.

### Design/Service Goals

The roles of the Application Gateway Services (AGS) and Application Management Services (AMS) Module straddle several domains involving Z-Platform developers and the ZP-App ecosystem. While they have separate roles, it is helpful to consider them united in the process of providing a rich ZP-App marketplace experience to the platform.

The Application Management Service Module's API encompasses:

1. Registration and management of Z-Platform Developer accounts.
2. Registration and management of ZP-Apps and their permissions/resource requirements for Z-Platform Developers.
3. ZP-Apps Marketplace organization and presentation layer.

### (Including Search-Related Efforts)

4. Z-Platform Account Managers review/approval process for all ZP-App submission, change requests, etc.

The Application Gateway Services provides API services to registered ZP-Apps:

1. Authorization API of externally hosted ZP-Apps.
2. Resource reservations for Z-Platform services.

This approach is similar to the relationship handling between other platforms application space and the provided APIs (such as Facebook Apps and Facebook's API)

As such, the design requires resources and systems for handling static marketing-related content (graphics and potentially video); post-processing, optimization, and CDN-like caching/replication of static content.

ZP-App marketplace presentation will typically involve full-text search services and subsequent semi-real-time indexing resources.

Z-Platform Account Managers use this same API to review and approve/reject ZP-App related submissions, change requests, etc.

### Technology Stack Overview—AGS

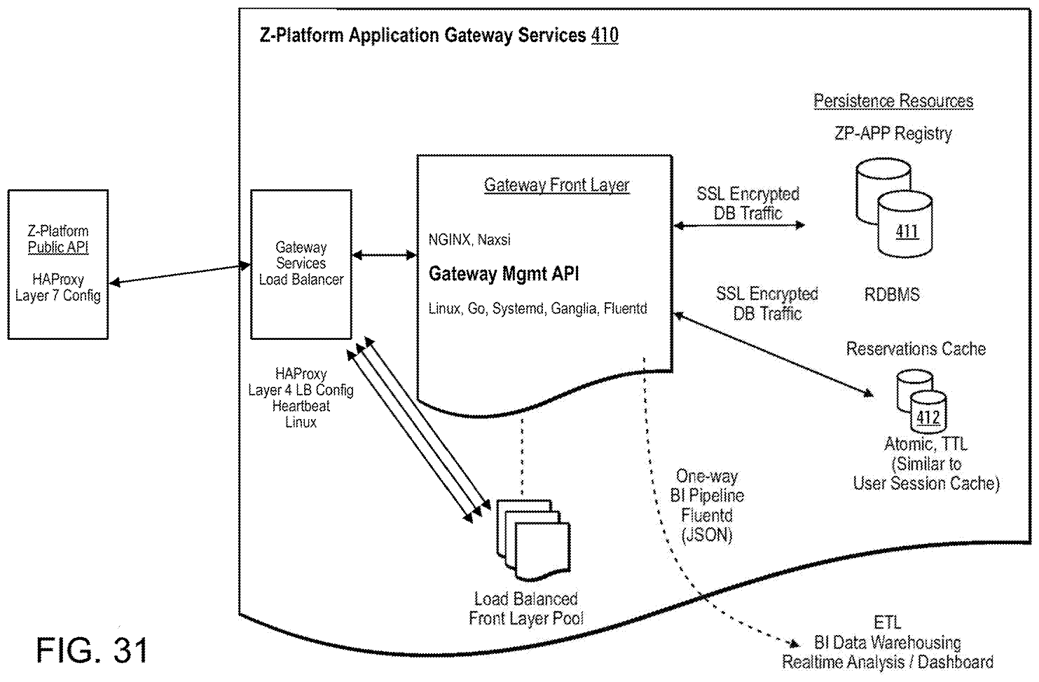

FIG. 31 is a diagram of an exemplary technology stack 410 for a Z-Locker Application Gateway Services (AGS) Module according to an aspect of the invention.

The Application Gateway Service shares much with the architecture of the Device Registration Service. When a ZP-AP requests access to platform resources, the service confirms the ZP-APP's access through the ZP-APP Registry database 411. Once this has been validated, a reservation (much like a validated session) is added to the Reservations Cache 412 with an expiration time (TTL). The reservations will be confirmed by an AGS module when the ZP-APP continues to their reserved platform services.

### Technology Stack Overview—AMS

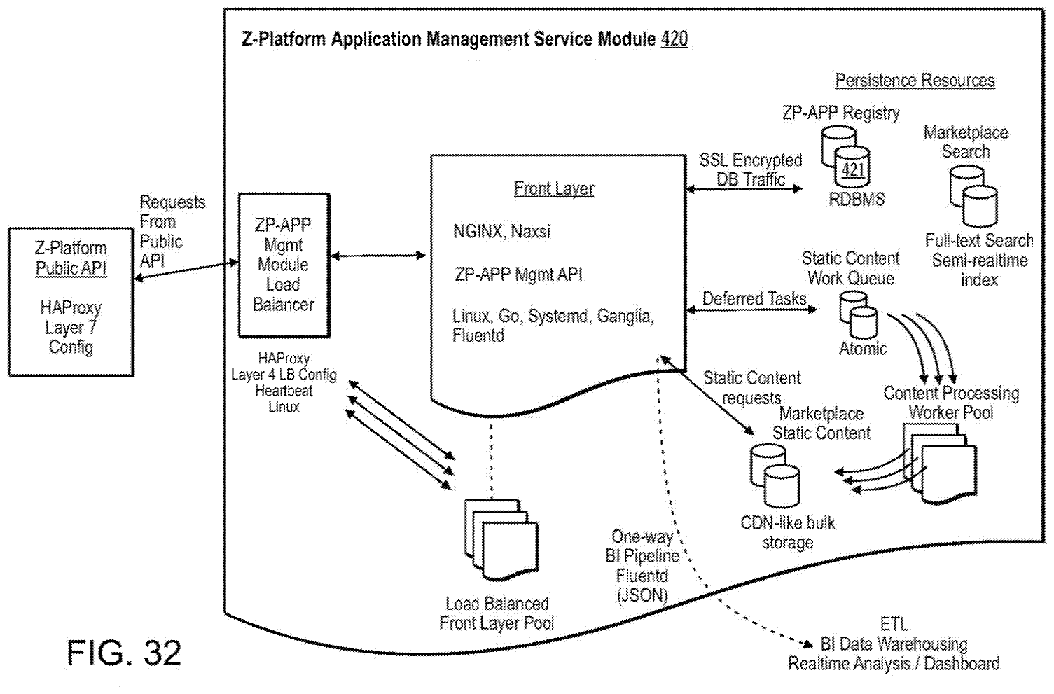

FIG. 32 is a diagram of an exemplary technology stack for a Z-Locker Application Management Service (AMS) Module 420 according to an aspect of the invention.

As shown in the accompanying drawing figures, the ZP-APP Registry 421 is shared between the AGS and ZP-App Management Service Module (AMS) to guarantee the setup and the access control enforcements. The Application Management Service Module API handles indexing of searchable records within the ZP-APP registry. Elasticsearch (a Java-based open-source full-text search engine) is utilized for providing a wide array of search features. It is also important to note that the Application Management Service Module facilitates of both upload and post-processing tasks of static assets (perhaps pictures or video). These assets are added to a queue for offline processing by a pool of workers responsible for preparing media for the ZP-APP marketplace. While this may result in a slightly delayed update to both static assets and their presence in the ZP-APP Registry once uploaded, it provides better scaling and a more balanced resource management.

### The Z-Locker and Z-Shelf Service Module

The Z-Locker and the Z-Shelf service is a Z-Platform Module providing a personal cloud storage service with enhanced security for Z-Platform's users and their personas. Z-Locker was originally modeled after the luggage lockers at public spaces (such as train stations), utilizing the same lock approach for depositing and retrieving contents. Its usage was deliberately kept simple; find empty locker, deposit content, lock door, remove key, give key to recipient. Enhanced features include key-expirations (both time and number of usage), content disposal (both time and access pattern based), “multiple-retrieval” option (such as in newspaper vending machines).

Z-Shelf differs in its access mechanism; it can be described as a public Z-Locker with simplified controls, while retaining the time and basic allocation and retrieval functions. It is mostly used as Z-Platform's enhanced security CDN solution. Z-Locker utilizes Z-Shelf in the background to store Z-Locker contents.

### Design/Service Goals—Z-Locker

The Z-Locker Service Module is designed in a similar fashion to the UMDS service, as it largely benefits from the secure storage features the Z-Shelf Service.

### Technology Stack Overview—Z-Locker

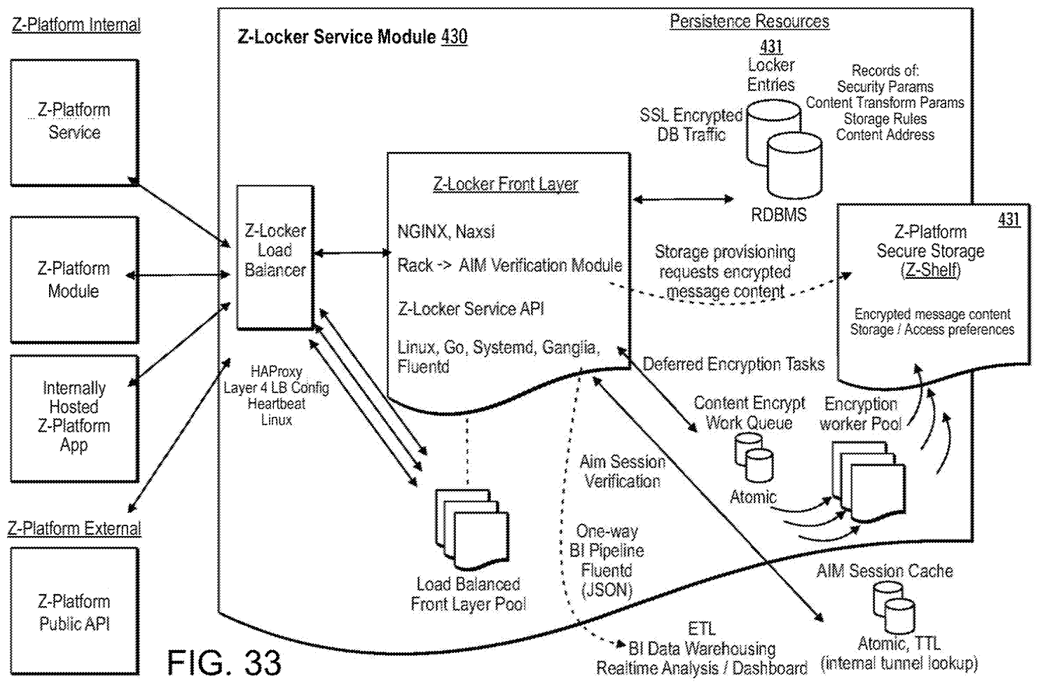

FIG. 33 is a diagram of an exemplary technology stack for a Z-Locker Service Module 430 according to a further aspect of the invention.

A significant processing element of this module is the content encryption work module, which encrypts the payload with a randomly generated symmetric key, adds the key (with CRC and payload size) to the Locker Entries database 431 and pushes the content to the Z-Shelf data management service 432. Upon retrieval, the content is sent to the client and the Z-Locker Service Encryption Key is shared with the client upon successful authentication and retrieval in an X509 v3 fashion.

### Design/Service Goals—Z-Shelf

The Z-Shelf Service Module is designed to provide Z-Platform with a secure, advanced CDN-type blob-store functionality. Shelf entries comprise of access rules and parameters and an internal reference to a bulk key/value content storage.

### Technology Stack Overview—Z-Shelf

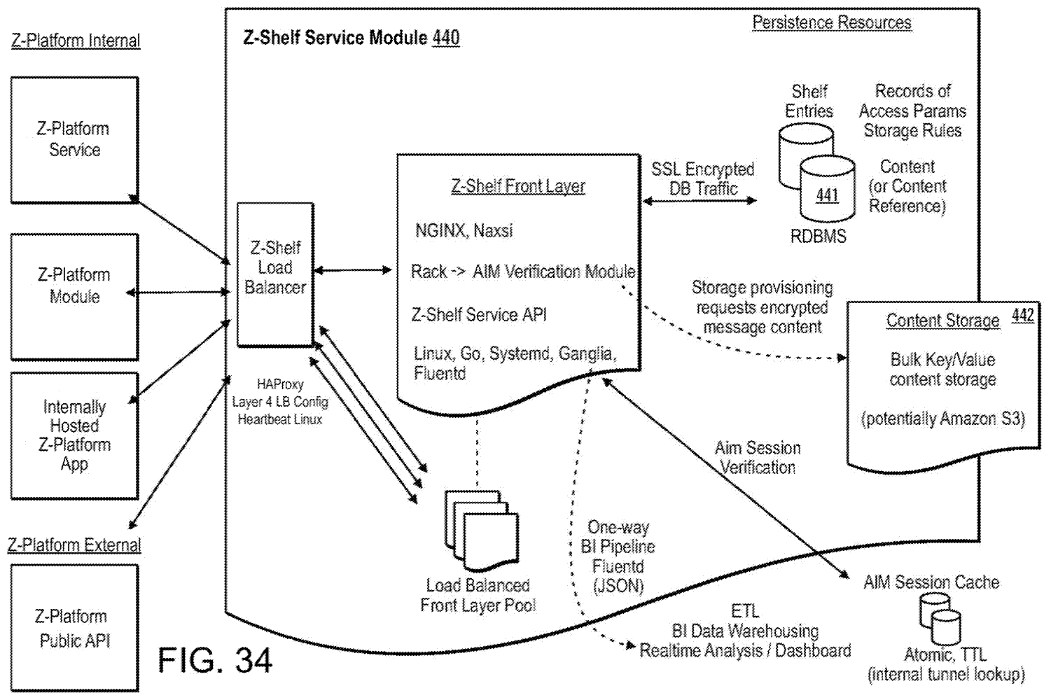

FIG. 34 is a diagram of an exemplary technology stack for a Z-Shelf Service Module 440. The Z-Shelf Service API is largely responsible for storage and retrieval of data it receives. When data is uploaded to Z-Shelf, its associated storage options (like content expiry time) and access parameters (who can access this data and how many times it may be retrieved) are added to the Shelf Entries database 441.

Entry records contain references to the associated content in the Z-Shelf bulk storage 442. Amazon S3 is utilized to meet the backend storage needs of the Z-Shelf Service Module (as it did for Dropbox), but the design of implementing a custom solutions is also available.

The Z-Shelf Service Module's application layer generally governs access rights and storage limits for Z-Platform entities (who can store data, who can retrieve data). Once users are authorized to store or receive a given amount of data, Z-Shelf provisions the appropriate space inside of its bulk storage platform (through the Amazon S3) and ferries the data to its storage location.

### Audio/Visual Communication Service Module:

### Design/Service Goals

Z-Platform's Audio/visual Communication System consist of three major parts: the Communication Service Core, the Communication Control Center, and the Communication Nodes. The Communication Service Core (CommCore) provides a service API for Z-Platform personas and ZP-APPs to reserve Audio/Visual sessions between each other. This service provides accounting and reporting services for sessions, both free and paid. CommCore enforces persona access rules according to their stated preferences. CommCore reserves session resources with the Communication Control Center. The Communication Control Center's (CommCtrl) role is that of a service provider for A/V sessions (and is specifically concerned with handling service requests from CommCore). CommCtrl maintains the available pool of Communication Nodes (CommNodes), which may reside across many geographically distinct locations. It also monitors CommNode performance, latency, workload in order to choose the most appropriate CommNode(s) to service a given A/V session.

CommCtrl is capable of sending notifications to CommCore as session events occur (participants join or leave, performance thresholds, etc). Conversely, CommCore may subscribe to session events to monitor and report on sessions that are in progress.

CommNodes themselves act as endpoint providers for secure streaming A/V sessions. At times, single A/V sessions may benefit from being bridged across multiple CommNodes.

### Technology Stack Overview—Communication Service Core

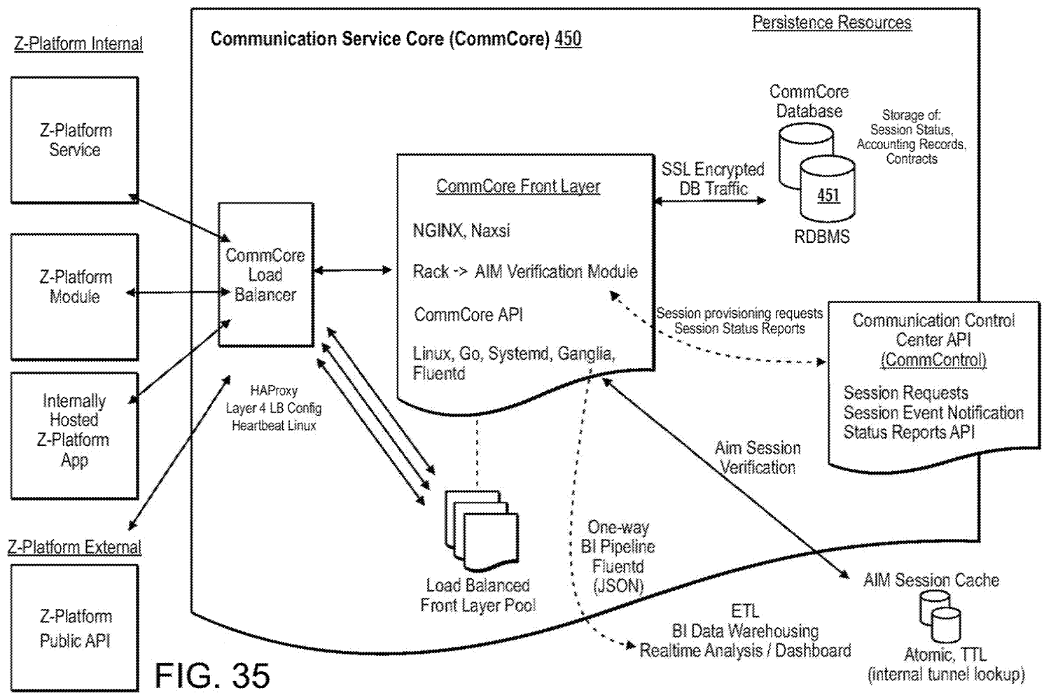

FIG. 35 is a diagram of an exemplary technology stack for a Communication Service Core (CommCore) module 450.

The Communication Service Core stores A/V Session-related information in a relational database 451 and accounts for session usage between personas. It relies heavily on the Identity Translation Service (ITS) to ensure the privacy of session participants. As a rule, participants are identified by a different ID in each part of the Communication architecture (CommCore, CommCtrl, and CommNodes). After enforcing each personas contact/access preferences, CommCore contracts the necessary session from the CommCtrl API and notifies all participants involved of the session.

The Communication Service Core also subscribes to event notifications from CommCtrl by providing an endpoint to CommCtrl during session initialization.

### Technology Stack Overview—Communication Control Center

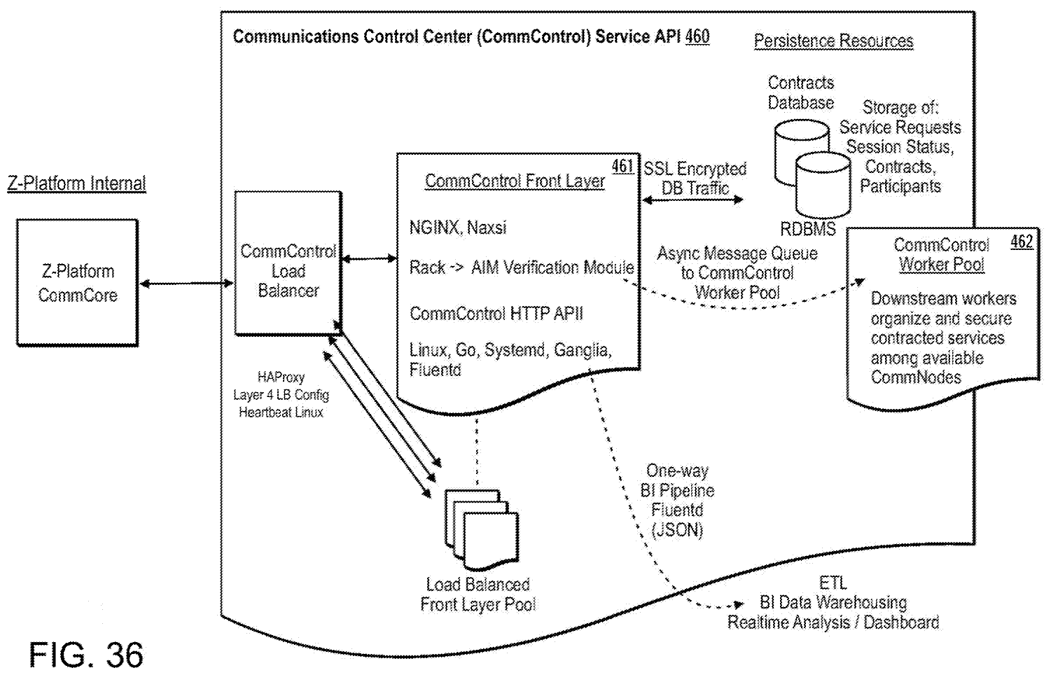

FIG. 36 is a diagram of an exemplary technology stack for a Communication Control Center (CommControl) Service API module 460.

Similar to the Z-Platform API itself, the architecture of the Communication Control Center is configured to provide a scalable service offering. Its service API is provided by a front-layer 461 that specifically handles requests for AN Session services and begins the process of converting them into contracts within the CommCtr system. The front-layer queues work that must involve sessions among available CommNodes and the contracted work is tracked as it is handled by each worker within CommCtrl. The CommCtrl worker pool 462 is tasked with all work that requires interfacing directly with CommNodes. After a service request has been handled by a worker, completed work is logged with its respective service contract, and an HTTP response is returned from the Service API.

### PART 4: BLOCK DIAGRAM OF EXEMPLARY EMBODIMENTS OF INVENTION

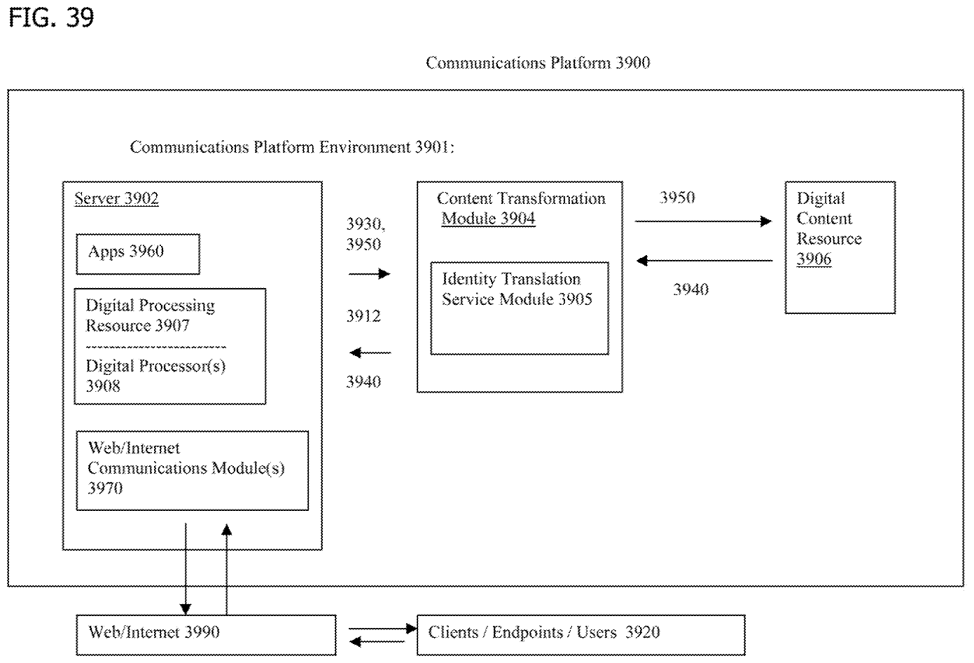

FIG. 39 is a block diagram showing an exemplary embodiment of a communications and transactional platform according to the invention. As shown in FIG. 39, Communications Platform 3900 comprises a Server 3902, a Content Transformation Module 3904, and a Digital Content Resource 3906. The Content Transformation Module 3904 can comprise an Identity Translation Service Module 3905. The server 3902, which can be constructed in accordance with known server/digital processor principles, methods and structures, contains a digital processing resource 3907 composed of one or more digital processors 3908, and is operable to communicate with other entities, such as clients/endpoints/users 3920, such as by utilizing conventional network architectures or means, such as the Web or Internet 3990, cloud-based architectures, or other known configurations. The digital processor(s) 3908 (and the digital processing resource 3907 formed collectively by the processors 3908 and any ancillary structures associated with the processor(s)) can be of conventional design and construction. It should also be noted that Communications Platform 3900 can also form part of or the entirety of, and can functionally create or help create, a Communications Platform Environment 3901, as described elsewhere herein.

The Digital Content Resource 3906 can be constructed in accordance with known digital storage techniques, methods and structures, and is operable to store, deliver or forward digital content, for example, in response to requests 3950 for content 3940. Examples of structures suitable for the Digital Content Resource include, but are not limited to, disk-based storage arrays and the like.

The requests 3950 for content 3940 can come from the server, either directly or, in accordance with exemplary embodiments of the invention, through the Content Transformation Module. In response to requests 3950, the Digital Content Resource can store deliver or forward digital content 3940 to the server directly, or, in accordance with exemplary embodiments of the invention, to the server through the Content Transformation Module.

In exemplary embodiments of the invention, the Content Transformation Module is operable to apply selected content transformations to digital content directed to (or towards) the server from the digital content resource.

It should be noted that although in FIG. 39, for purposes of a given exemplary embodiment or practice, requests from the server are shown as passing first through the Content Transformation Module before reaching the Digital Content Resource, it is also possible that the server may, in exemplary practices or embodiments, apply a given selected request directly to the Digital Content Resource.

It should also be noted that although for purposes of the exemplary embodiment depicted in FIG. 39, the Content Transformation Module is shown as a module separate from the server and separate from the Digital Content Resource, it is also possible, in a given embodiment or practice of the invention, to incorporate the Content Transformation Module and its functions, as described herein, within one or more of the server and/or the digital content resource. The functions of the Content Transformation Module could also be distributed in more than one of the server and Digital Content Resource structures shown in the drawing figure.

Referring again to FIG. 39, in the exemplary embodiment depicted therein, the Communications Platform 3900 comprises a Server 3902 comprising a digital processing resource 3907, the digital processing resource comprising one or more digital processor(s) 3908; and a Content Transformation Module 3904, in communication with the Server and interposed between the Server and a Digital Content Resource 3906 operable to store, deliver or forward digital content, the content transformation module being operable to apply selected content transformations to digital content directed to the server from the digital content resource.

More particularly, in exemplary embodiments of the invention, the Content Transformation Module 3904 is controllable by the Server via a communications channel 3912 to selectively request and establish endpoints and users 3920, and to enable selected encryption, on a per-endpoint basis, of content specific to a given digital consumption endpoint (the given digital consumption endpoint being among the established endpoints 3920), responsive to server-based information 3930 representative of endpoint status or endpoint-associated user status.

In exemplary embodiments of the invention, the content transformation module is operable to dynamically change encryption parameters for a given endpoint, responsive to the server-based information representative of endpoint status or endpoint-associated user status.

In exemplary embodiments of the invention, the content transformation module is operable to execute selected redirection of content 3940 or content requests 3950, on a per-endpoint basis, responsive to the server-based information representative of endpoint status or endpoint-associated user status.

In exemplary embodiments of the invention, the content transformation module is operable to provide selected content transformation, encryption and delivery for applications programs (“apps”) 3960 executing on the server.

In exemplary embodiments of the invention, the Content Transformation Module is operable to provide selected content transformation, encryption and delivery for Web-based services that execute on modules of the communications platform or server (e.g., Web-communicating modules 3970) that are in communication with the Web. In the noted drawing, the Web-communicating modules 3970) are depicted within the server, but alternatively, they can be outside the server, and providing the functions called for by the present invention.

Exemplary embodiments of the invention comprise a Communications Platform Environment 3901 supported by the server and the Content Transformation Module, the Communications Platform Environment being functionally organized into three levels (not shown in FIG. 39 but shown and described in greater detail elsewhere herein), comprising a Core Services Level, a Platform Modules Level, and a Platform Applications Level, wherein: (1) the core services level comprises core services usable by platform modules or platform applications; (2) the platform modules level comprises platform-based functional modules operable to utilize selected ones of the core services provided by the core services level; and (3) the platform applications level comprises platform-based application programs operable to utilize selected ones of the platform core services or platform modules.

In exemplary embodiments of the invention, the Communications Platform is operable, as described in greater detail elsewhere herein, to enable a User of the platform to create and maintain a fictional identity (Persona) for use on selected venues served by the platform, wherein Persona information is stored independently from User information, so as to preclude unmasking of a User identity based on corresponding Persona information.

In exemplary embodiments of the invention, the Communications Platform is operable, as described in greater detail elsewhere herein, to enable a given User to create separate, different, respective Personas for use with different, respective venues served by the platform.

In exemplary embodiments of the invention, platform-based logical links between a given User identity and a corresponding Persona are established, maintained and protected by a platform-based Identity Translation Service provided, in the exemplary embodiment of FIG. 39, by the Identity Translation Service Module 3905, depicted in FIG. 39 within the Content Transformation Module. It should be noted that although for purposes of a given exemplary embodiment, the Identity Translation Service Module is shown as within the Content Transformation Module, the Identity Translation Service Module and/or its functions may be, in other exemplary practices and embodiments of the invention separate from the Content Transformation Module. Alternatively, in other exemplary practices or embodiments of the invention, the Identity Translation Service Module and/or its functions may be located in or executed by other structures in the platform configuration of the invention, including, by way of example, the server.

It should also be noted that various other configurations and groupings of elements, other than those shown by way of example in FIG. 39, are possible and are within the scope of the invention. For example, one or both of the Content Transformation Module and/or Digital Content Resource can be within the Server or selected elements of the Server.

It should also be noted that the platform structure depicted and described herein can be utilized for a variety of purposes, which can include providing secure private communications, and/or supporting secure, private transactions.

### PART 5: DIGITAL PROCESSING ENVIRONMENT IN WHICH INVENTION CAN BE IMPLEMENTED

The following is a discussion of digital processing structures and environments in which the invention may be implemented and practiced. It will be understood that the recitations of the claims shall control the scope of the invention, and nothing in the following discussion shall be construed in any manner contrary to or limiting of the claimed invention.

It will be understood by those skilled in the art that the present invention provides methods, systems, devices and computer program products that can be implemented as part of the computer software or computer hardware of a digital communications network, which may include digital processors, computers, “smartphones”, tablet computers, or other computing devices, which may include mobile computing devices, that form part of a computer network or telecommunications network, along with memory, storage, and other conventional computer system or telecommunications system components. While conventional components of such kinds are well known to those skilled in the art, and thus need not be described in great detail herein, the following overview indicates how the present invention can be implemented in conjunction with such components.

It will also be understood by those skilled in the art that aspects of the invention can be implemented in software, hardware, or a combination of software and hardware, using otherwise conventional network architectures and digital processing apparatus including devices such as servers, personal computers (PC), smartphones, tablet computers, or equivalent devices operating in accordance with (or emulating) a conventional operating system such as iOS, Microsoft Windows, Linux, Android, or other, either in a standalone configuration or across a network. The various processing aspects and means described herein may therefore be implemented in the software and/or hardware elements of a properly configured digital processing device or network of devices. Processing may be performed sequentially or in parallel, and may be implemented using special purpose or re-configurable hardware.

Various aspects of the invention can be embodied at least in part in commercially available servers, PC's, tablet computers, smartphones or other mobile computing platform that contains functional elements suitable for implementation of the invention. A commercially available server, for example, suitable for implementation of aspects of the invention can include, for example, one or more processor, memory and mass storage devices, such as disk storage elements, which perform processing and storage operations in connection with digital data provided thereto.

As used herein, the terms “memory”, “storage” and “disk storage devices” and the like can encompass any computer readable medium, such as a computer hard disk, computer floppy disk, computer-readable flash drive, computer-readable RAM or ROM element or any other known means of encoding digital information. The term “applications programs”. “applications”, “apps”, “programs”, “computer program product” or “computer software product” can encompass any computer program product consisting of computer-readable programs instructions encoded and/or stored on a computer readable medium, whether that medium is fixed or removable, permanent or erasable, or otherwise Applications and data can be stored on a disk, in RAM, ROM, on other removable or fixed storage, whether internal or external, and can be downloaded or uploaded, in accordance with practices and techniques well known in the art. As will also be noted in this document, the present invention can take the form of software or a computer program product stored on a computer-readable medium, or it can be in the form of computer program code that can be uploaded or downloaded, or fixed in a ROM or other electronic structure, or it can take the form of a method or a system for carrying out such a method.

In addition, the digital processors, processing modules, servers and other processing structures discussed herein can include one or more network ports connected to communication links or channels which allow communication with, and within, a network, in accordance with known digital network practice, wherein a given processor or module can transmit information, content, data or requests to, and receive information, content, data or requests from, other computer systems and other devices in the network. In a typical network organized according to, for example, a conventional client-server paradigm, certain computer systems in the network may be designated as servers, which store data and programs (generally, “information”) for processing by the other, client computer systems. A client computer system that needs access to information maintained by a particular server can request, enable or cause the server to download the information to it over the network. After processing the data, the client computer system may also return processed data to the server for storage. In addition to computer systems (including the above-described servers and clients), a network may also include, for example, other resources which may be shared among the various computer systems connected in the network. The communication links interconnecting the computer systems in the network may comprise any convenient information-carrying medium, including wires, optical fibers or other media for carrying signals among the computer systems. Computer systems transfer information over the network by means of messages transferred over the communication links, with each message including information and an identifier identifying the device to receive the message.

Systems, devices or software products in accordance with the present invention can operate on any of a wide range of conventional computing devices, systems and architectures, whether standalone, networked, portable or fixed, including conventional PCs, laptop computers, handheld or mobile computers, smartphones, tablets, or across the Worldwide Web (“the Web”), Internet or other networks, which may in turn include servers and storage devices and systems. Alternatively, aspects of the invention can be embodied at least in part in a commercially available smartphone, tablet computer or other mobile device that contains functional elements equivalent to those noted above.

In accord with conventional computer software and hardware practice, software applications configured in accordance with the invention can operate within, e.g., a PC or server, or known forms of handheld computing devices, smartphones or tablet computers, in which program instructions can be read from ROM or CD ROM, magnetic disk or other storage and loaded into RAM for execution by a processor such as a CPU. Data can be input into the system via any known device or means, including a conventional keyboard, mouse, scanner, digitizing tablet, or other elements. Applications and/or data can be located on some or all of fixed or removable storage or ROM, or downloaded.

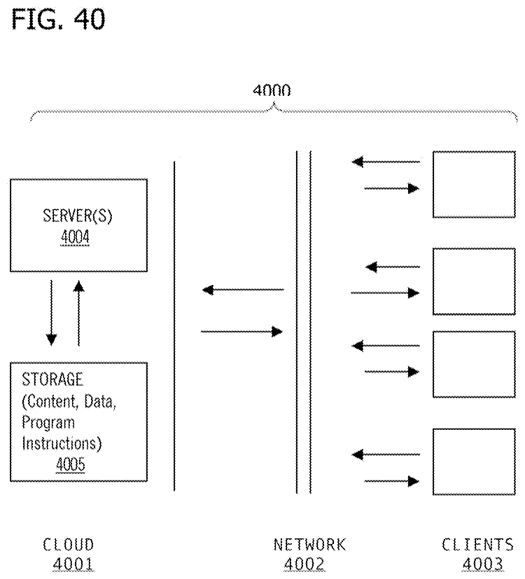

The invention can also be implemented in association with a cloud computing architecture. By way of background and example, FIG. 40 is a diagram of one form (although not the only form) of cloud configuration 4000) in connection with which the invention can be implemented, comprising a cloud layer 4001, a network layer 4002, and a client layer 4003. Program instructions or software applications contained in storage 4005 within the cloud layer 4001 are accessible by servers 4004 that communicate via network 4002 with individual clients in the client layer 4003. It will be understood that the invention can be implemented in connection with configurations and architectures other than cloud configurations, and other than that shown in FIG. 40.

As implementation platforms, client operating systems can include known forms of iOS, MacOS, Android, Windows, and Linux/Unix operating systems; and the server operating systems include known forms of Linux/Unix and MacOS operating systems. Those skilled in the relevant art will understand and appreciate that the invention can be implemented on a wide range of current computing systems.

Those skilled in the art will understand that aspects of the invention described herein can be executed in hardware elements, such as at the server level, or at a microprocessor level, such as within a Field-Programmable Gate Array (FPGA) or an Application-Specific Integrated Circuit (ASIC) constructed specifically to carry out the processes described herein, using ASIC construction techniques known to ASIC manufacturers. The actual semiconductor elements of a conventional ASIC or equivalent integrated circuit are not part of the present invention, and will not be discussed in detail herein. Alternatively, general-purpose processors can be used to execute aspects of the invention.

Those skilled in the art will understand that the above described embodiments, practices and examples of the invention can be implemented using known forms of communications or digital processing networks, computer processors and telecommunications devices, in which the telecommunications devices can include known forms of cellphones, smartphones, and other known forms of mobile devices, tablet computers, desktop and laptop computers, and known forms of digital network components and server/cloud/network/client architectures that enable communications between such devices.

Those skilled in the art will also understand that method aspects of the present invention can be executed within commercially available digital processing devices and systems, such as servers, PC's, laptop computers, tablet computers, personal computers (PCs) and smartphones or other mobile devices, operating under the collective command of the smartphones or computer's operating system, such as iOS, Android or Windows, and a computer program product configured in accordance with the present invention, as well as known forms of digital networks, including architectures comprising server, cloud, network, and client aspects, for communications between such devices.

The terms “computer software,” “computer code product,” and “computer program product” as used herein can encompass any set of computer-readable programs instructions encoded on a non-transitory computer readable medium. A computer readable medium can encompass any form of computer readable element, including, but not limited to, a computer hard disk, computer floppy disk, computer-readable flash drive, computer readable RAM or ROM element, or any other known means of encoding, storing or providing digital information, whether local to or remote from the workstation, PC or other digital processing device or system. Various forms of computer readable elements and media are well known in the computing arts, and their selection is left to the implementer.

In addition, those skilled in the art will understand that the invention can be implemented using computer program modules and digital processing hardware elements, including memory units and other data storage units, including commercially available processing units, memory units, computers, servers, smartphones, tablet computers and other computing and telecommunications devices, including mobile devices. The term “modules”, “program modules”, “components”, and the like include computer program instructions, objects, components, data structures, and the like that can be executed to perform selected tasks or achieve selected outcomes. The various modules shown in the drawings and discussed in the description herein refer to computer-based or digital processor-based elements that can be implemented as software, hardware, firmware and/or other suitable components, taken separately or in combination, that provide the functions described herein, and which may be read from computer storage or memory, loaded into the memory of a digital processor or set of digital processors, connected via a bus, a communications network, or other communications pathways, which, taken together, constitute an embodiment of the present invention.

The terms “data storage module”, “data storage element”, “memory element” and the like, as used herein, can refer to any appropriate memory element usable for storing program instructions, machine readable files, databases, and other data structures. The various digital processing, memory and storage elements described herein can be implemented to operate on a single computing device or system, such as a server or collection of servers, or they can be implemented and inter-operated on various devices across a network, whether in a server-client arrangement, server-cloud-client arrangement, or other configuration in which client devices can communicate with allocated resources, functions or applications programs, or with a server, via a communications network.

It will also be understood that computer program instructions suitable for a practice of the present invention can be written in any of a wide range of computer programming languages, including Java, C++, and the like. It will also be understood that method operations shown in the flowcharts can be executed in different orders, and that not all operations shown need be executed, and that many other combinations of method operations are within the scope of the invention as defined by the attached claims. Moreover, the functions provided by the modules and elements shown in the drawings and described in the foregoing description can be combined or sub-divided in various ways, and still be within the scope of the invention as defined by the attached claims.

### PART 6: FLOWCHARTS OF EXEMPLARY PRACTICES OF THE INVENTION

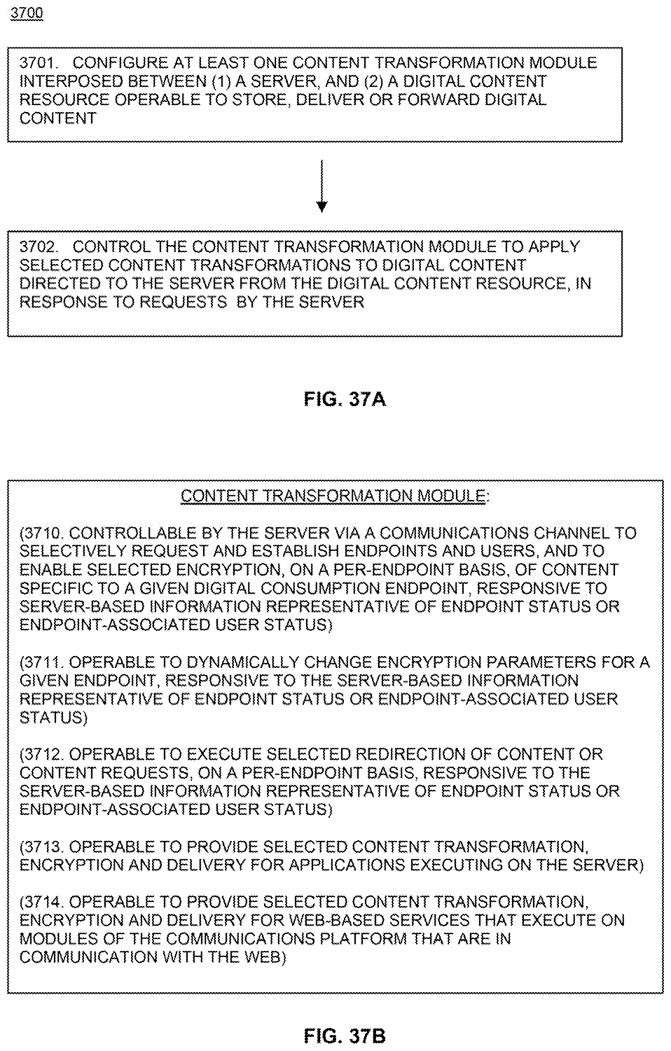

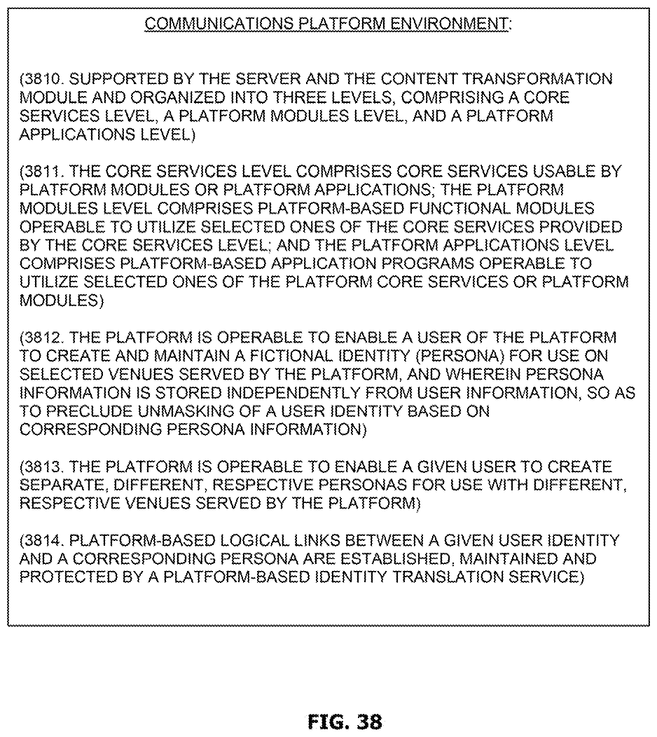

FIGS. 37A, 37B and 38 are flowcharts illustrating exemplary method aspects and practices of the invention. The method aspects depicted in this flowchart are examples only; the organization, order and number of operations in the exemplary practices can be varied; and the exemplary practices and methods can be arranged or ordered differently, and include different functions, whether singly or in combination, while still being within the spirit and scope of the present invention.

Items shown in FIGS. 37A, 37B, and 38 in parentheses, or described below in parentheses, are, among other aspects, optional in a given practice of the invention.

In particular, FIG. 37A shows a method 3700 according to an exemplary practice of the invention, including the following operations:
3701: Configure at least one content transformation module interposed between (1) a server, and (2) a digital content resource operable to store, deliver or forward digital content; and
3702: Control the content transformation module to apply selected content transformations to digital content directed to the server from the digital content resource, in response to requests by the server.

FIG. 37B depicts operations and functionality of the Content Transformation Module according to an exemplary practice of the invention, including the following:

The Content Transformation Module is (noting that items shown in parentheses are, among other aspects, optional in a given practice of the invention):
(3710. controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status);
(3711. operable to dynamically change encryption parameters for a given endpoint, responsive to the server-based information representative of endpoint status or endpoint-associated user status);
(3712. operable to execute selected redirection of content or content requests, on a per-endpoint basis, responsive to the server-based information representative of endpoint status or endpoint-associated user status);
(3713. operable to provide selected content transformation, encryption and delivery for applications executing on the server);
(3714. operable to provide selected content transformation, encryption and delivery for web-based services that execute on modules of the communications platform that are in communication with the web).

FIG. 38 depicts operations and functionality of the Communications Platform Environment and Communications Platform according to an exemplary practice of the invention, including the following:

The Communications Platform Environment and the Communications Platform have the following functionalities (noting that items shown in parentheses are, among other aspects, optional in a given practice of the invention):
(3810. The Communications Platform Environment is supported by the server and the content transformation module and organized into three levels, comprising a core services level, a platform modules level, and a platform applications level);
(3811. The core services level comprises core services usable by platform modules or platform applications; the platform modules level comprises platform-based functional modules operable to utilize selected ones of the core services provided by the core services level; and the platform applications level comprises platform-based application programs operable to utilize selected ones of the platform core services or platform modules);
(3812. The platform is operable to enable a user of the platform to create and maintain a fictional identity (Persona) for use on selected venues served by the platform, and wherein Persona information is stored independently from user information, so as to preclude unmasking of a real-world user identity based on corresponding Persona information);
(3813. The platform is operable to enable a given user to create separate, different, respective Personas for use with different, respective venues served by the platform);
(3814. Platform-based logical links between a given user identity and a corresponding Persona are established, maintained and protected by a platform-based identity translation service).

### PART 7: CONCLUSION

While the foregoing description and the accompanying drawing figures provide details that will enable those skilled in the art to practice aspects of the invention, it should be recognized that the description is illustrative in nature and that many modifications and variations thereof will be apparent to those skilled in the art having the benefit of these teachings. It is accordingly intended that the invention herein be defined solely by any claims that may be appended hereto and that the invention be interpreted as broadly as permitted by the prior art.

We claim:

1. A communications platform for providing secure, private communications, the communications platform comprising:
a server comprising a digital processing resource, the digital processing resource comprising a digital processor; and
a content transformation module, in communication with the server and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

2. The communications platform of claim 1 wherein the content transformation module is operable to dynamically change encryption parameters for a given endpoint, responsive to the server-based information representative of endpoint status or endpoint-associated user status.

3. The communications platform of claim 1 wherein the content transformation module is operable to execute selected redirection of content or content requests, on a per-endpoint basis, responsive to the server-based information representative of endpoint status or endpoint-associated user status.

4. The communications platform of claim 1, 2 or 3 wherein the content transformation module is operable to provide selected content transformation, encryption and delivery for applications executing on the server.

5. The communications platform of claim 1, 2 or 3 wherein the content transformation module is operable to provide selected content transformation, encryption and delivery for Web-based services that execute on modules of the communications platform that are in communication with the Web.

6. The communications platform of claim 1, 2, 3, 4 or 5 further comprising:
a communications platform environment supported by the server and the content transformation module and organized into three levels, comprising a core services level, a platform modules level, and a platform applications level, wherein:
the core services level comprises core services usable by platform modules or platform applications;
the platform modules level comprises platform-based functional modules operable to utilize selected ones of the core services provided by the core services level; and
the platform applications level comprises platform-based application programs operable to utilize selected ones of the platform core services or platform modules.

7. The communications platform of claim 1, 2, 3, 4, 5 or 6 wherein the platform is operable to enable a User of the platform to create and maintain a fictional identity (Persona) for use on selected venues served by the platform, and wherein Persona information is stored independently from User information, so as to preclude unmasking of a User identity based on corresponding Persona information.

8. The communications platform of claim 7 wherein the platform is operable to enable a given User to create separate, different, respective Personas for use with different, respective venues served by the platform.

9. The communications platform of claim 8 wherein platform-based logical links between a given User identity and a corresponding Persona are established, maintained and protected by a platform-based Identity Translation Service.

10. A method of providing a communications platform for enabling secure, private communications, the method comprising:
configuring a server comprising a digital processing resource, the digital processing resource comprising a digital processor; and
configuring a content transformation module, in communication with the server, and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

11. The method of claim 10 wherein the content transformation module is operable to dynamically change encryption parameters for a given endpoint, responsive to the server-based information representative of endpoint status or endpoint-associated user status.

12. The method of claim 10 wherein the content transformation module is operable to execute selected redirection of content or content requests, on a per-endpoint basis, responsive to the server-based information representative of endpoint status or endpoint-associated user status.

13. The method of claim 10, 11 or 12 wherein the content transformation module is operable to provide selected content transformation, encryption and delivery for applications executing on the server.

14. The method of claim 10, 1 or 12 wherein the content transformation module is operable to provide selected content transformation, encryption and delivery for Web-based services that execute on modules of the communications platform that are in communication with the Web.

15. The method of claim 10, 11, 12, 13 or 14 further comprising:
configuring a communications platform environment supported by the server and the content transformation module and organized into three levels, comprising a core services level, a platform modules level, and a platform applications level, wherein:
the core services level comprises core services usable by platform modules or platform applications;
the platform modules level comprises platform-based functional modules operable to utilize selected ones of the core services provided by the core services level; and
the platform applications level comprises platform-based application programs operable to utilize selected ones of the platform core services or platform modules.

16. The method of claim 10, 11, 12, 13, 14 or 15 further comprising: enabling a User of the communications platform to create and maintain a fictional identity (Persona) for use on selected venues served by the platform, and wherein Persona information is stored independently from User information, so as to preclude unmasking of a User identity based on corresponding Persona information.

17. The method of claim 16 further comprising: enabling a given User to create separate, different, respective Personas for use with different, respective venues served by the communications platform.

18. The method of claim 17 wherein platform-based logical links between a given User identity and a corresponding Persona are established, maintained and protected by a platform-based Identity Translation Service.

19. A computer program product for use with a digital processing system, for enabling the digital processing system to provide a communications platform for enabling secure, private communications, the digital processing system comprising at least one digital processor, the computer program product comprising digital processor-executable program instructions stored on a non-transitory digital processor-readable medium, which when executed in the digital processor cause the digital processor to:
configure a server comprising a digital processor; and
configure a content transformation module, in communication with the server, and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.

20. The program product of claim 19 wherein the content transformation module is operable to dynamically change encryption parameters for a given endpoint, responsive to the server-based information representative of endpoint status or endpoint-associated user status.

21. The program product of claim 19 wherein the content transformation module is operable to execute selected redirection of content or content requests, on a per-endpoint basis, responsive to the server-based information representative of endpoint status or endpoint-associated user status.

22. The program product of claim 19, 20 or 21 wherein the content transformation module is operable to provide selected content transformation, encryption and delivery for applications executing on the server.

23. The program product of claim 19, 20 or 21 wherein the content transformation module is operable to provide selected content transformation, encryption and delivery for Web-based services that execute on modules of the communications platform that are in communication with the Web.

24. The program product of claim 19, 20, 21, 22 or 23 further comprising digital processor-executable program instructions stored on a non-transitory digital processor-readable medium, which when executed in the digital processor cause the digital processor to:
configure a communications platform environment supported by the server and the content transformation module and organized into three levels, comprising a core services level, a platform modules level, and a platform applications level, wherein:
the core services level comprises core services usable by platform modules or platform applications;
the platform modules level comprises platform-based functional modules operable to utilize selected ones of the core services provided by the core services level; and
the platform applications level comprises platform-based application programs operable to utilize selected ones of the platform core services or platform modules.

25. The program product of claim 19, 20, 21, 22, 23 or 24 wherein the platform is operable to enable a User of the communications platform to create and maintain a fictional identity (Persona) for use on selected venues served by the platform, and wherein Persona information is stored independently from User information, so as to preclude unmasking of a User identity based on corresponding Persona information.

26. The program product of claim 25 wherein the platform is operable to enable a given User to create separate, different, respective Personas for use with different, respective venues served by the communications platform.

27. The program product of claim 26 wherein platform-based logical links between a given User identity and a corresponding Persona are established, maintained and protected by a platform-based Identity Translation Service.

28. A communications platform for supporting secure, private transactions, the communications platform comprising:
a server comprising a digital processing resource, the digital processing resource comprising a digital processor; and
a content transformation module, in communication with the server and interposed between the server and a digital content resource operable to store, deliver or forward digital content, the content transformation module being operable to apply selected content transformations to digital content directed to the server from the digital content resource, the content transformation module being controllable by the server via a communications channel to selectively request and establish endpoints and users, and to enable selected encryption, on a per-endpoint basis, of content specific to a given digital consumption endpoint, responsive to server-based information representative of endpoint status or endpoint-associated user status.
